(19) United States
(12) Patent Application Publication
(10) Pub. No.: US 2002/0076661 A1
(43) Pub. Date: Jun. 20, 2002

(54) Silver halide light-sensitive photographic material and area-modulation image forming method

(75) Inventors: Tomonori Kawamura, Tokyo (JP); Shigeo Tanaka, Tokyo (JP); Satoshi Nishino, Sayama-shi (JP); Hirohide Ito, Tokyo (JP); Naohito Naraoka, Odawara-shi (JP); Naoyo Suzuki, Tokyo (JP); Shinya Watanabe, Tokyo (JP); Masataka Takimoto, Tokyo (JP); Hideaki Sakata, Tokyo (JP); Junichi Tanabe, Tokyo (JP); Tetsuya Taniguchi, Tokyo (JP); Naoki Nozaki, Tokyo (JP); Yasushi Okubo, Tokyo (JP); Koji Daifuku, Tokyo (JP); Katsuji Kondo, Tokyo (JP); Toshitsugu Suzuki, Tokyo (JP)

Correspondence Address: FRISHAUF, HOLTZ, GOODMAN, LANGER & CHICK, P.C., 25th Floor, 767 Third Avenue, New York, NY, 10017-2023, US

(73) Assignee: KONICA CORPORATION, Tokyo (JP)

(21) Appl. No.: 09/956,974

(22) Filed: Sep. 20, 2001

(30) Foreign Application Priority Data
Sep. 20, 2000 (JP) 285047/2000
Sep. 25, 2000 (JP) 290465/2000
Oct. 24, 2000 (JP) 323901/2000
Nov. 14, 2000 (JP) 346389/2000
Dec. 11, 2000 (JP) 375819/2000
Dec. 27, 2000 (JP) 396640/2000
Jan. 9, 2001 (JP) 001267/2001
Jan. 12, 2001 (JP) 004997/2001
Jan. 24, 2001 (JP) 015800/2001
Jan. 25, 2001 (JP) 017220/2001
Jan. 26, 2001 (JP) 018419/2001
Feb. 1, 2001 (JP) 025356/2001
Mar. 28, 2001 (JP) 054240/2001
May 11, 2001 (JP) 141425/2001
Jun. 13, 2001 (JP) 178370/2001

(51) Int. Cl. G03C 1/09; G03C 1/14; G03C 1/29; G03C 1/38; G03C 1/46; G03C 3/00; G03C 7/32; G03C 7/26; G03C 5/31; G03C 5/30

(52) U.S. Cl. 430/377; 430/501; 430/398; 430/558; 430/583; 430/383; 430/556; 430/557; 430/574; 430/386; 430/388; 430/389; 430/387; 430/442; 430/635

(57) ABSTRACT

The present invention provides a system of a digital color proof in which consistent images are obtained while minimizing density variation in spite of various variations of conditions due to the use of a silver halide light-sensitive color material, specifically, the present invention provides a method for forming proof images similar to printed images in terms of various characteristics such as the paper quality of silver halide light-sensitive materials, the dot gain, and the density.

### FIELD OF THE INVENTION

The present invention relates to a digital color proof employing a silver halide light-sensitive color photographic material, and to a system to obtain consistent images by minimizing the variation of density induced by the variation of various conditions due to the use of said silver halide light-sensitive color photographic material. The present invention relates specifically to a method to form proof images which are equal to printed images with respect to various characteristics such as the color of said silver halide light-sensitive material, the quality of paper, dot gain, and density.

### BACKGROUND OF THE INVENTION

At present, silver halide light-sensitive materials are extensively employed due to their high sensitivity, excellent color reproduction, and adaptability to continuous processing. Due to such features, silver halide light-sensitive materials are employed not only in the photographic field but also in the printing field. Specifically, silver halide light-sensitive materials have been widely employed in the field of the so-called proofing which is utilized to check the state of printing matters during intermediate stages of printing.

In the field of proofing, the suitability of layout and color of the final printed matter has been determined in such a manner that an image, which is edited utilizing a computer, is outputted onto a printing film; each of a yellow (Y) image, a magenta (M) image, and a cyan (C) image is formed by performing color separation exposure while suitably replacing processed films, and subsequently the image of the final printing matter is formed on a color photographic paper.

Recently, a method has been gradually employed, in which images are edited utilizing a computer, and are directly outputted onto a printing plate. In said method, it has been sought to directly obtain color images from a computer without employing said film.

In order to achieve said purpose, the application of various systems such as a sublimation-fusion heat transfer system, an electrophotographic system, and an ink jet system have been attempted. However, systems capable of obtaining high quality images result in disadvantages such as relatively high cost as well as poor productivity, while systems with lower cost as well as sufficient productivity result in disadvantages of poor image quality. In a system employing silver halide light-sensitive materials, it has been possible to carry out the formation of high quality images such as the formation of accurate halftone images due to excellent sharpness. On the other hand, it has been possible to achieve higher productivity due to the fact that as noted above, it is possible to perform continuous processing and also to write images at the same time as the formation of a plurality of color images.

In recent years, so-called digitization has progressed in the printing field. Due to the reasons previously described, the demand to directly obtain images from data in computers has increased. As a result, silver halide light-sensitive materials have been advantageously employed in this field. However, the system, employing silver halide Light-Sensitive color photographic materials, has exhibited the following differences from printing: color reproduction is inevitably different from printing due to the use of different image forming dyes; since special paper supports are employed, color is different from printing paper; a lower density part tends to look darker due to the fact that image forming dyes are dispersed into media such as gelatin having a high refractive index and applied onto a paper support; and impressions result due to of special paper laminated with polyethylene. Under the situations as above, heretofore, in digital color proofs, it has been common that density is determined intending the consistent reproduction for various causes and visual approximation, and dot gain is regulated for the approximation of printed images.

In addition, digital color proofs, employing silver halides, have strongly been demanded to result in consistent reproduction. However, silver halide light-sensitive materials are provided with various variation causes such as: the variation of sensitivity with respect to temperature as well as humidity during exposure, the variation of density due to the variation of factors such as the stirring frequency of a developer as well as the temperature and time of development, the variation of performance (in addition to the variation of sensitivity, temperature variation affects the variation rate of said sensitivity) due to the elapse of time. A way has been sought to decrease these variations by the regulation of characteristics of silver halide photographic materials and the combination of the regulation of exposure amount on the instrumental side.

Further, when exposure is carried out onto the circumferential surface of a drum, it requires accurate positioning. If curling of a silver halide photographic material is not consistent, problems tend to occur in which error tends to result in position during winding of said silver halide photographic material onto said drum.

In the present invention, investigation was diligently performed in order to simultaneously solve these problems. As a result, said problems were solved and the present invention was accomplished.

### SUMMARY OF THE INVENTION

Problems to be solved by the present invention relate to a digital color proof employing a silver halide Light-Sensitive color photographic material, with which it is intended to obtain consistent images in spite of the variation of various conditions which result in the use of silver halide Light-Sensitive color photographic materials and specifically to obtain a method for forming proof images which approach printed images in various characteristics such as the color of silver halide photographic materials, the paper quality, the dot gain, and the density.

The inventors of the present invention diligently performed investigations and discovered that the objective of the present invention was accomplished employing the following embodiments.

1. An area modulation image forming method of a sliver halide light-sensitive material which contains a support having thereon at least one silver halide emulsion layer, comprising the steps of:

(1) exposing the sliver halide light-sensitive material with a light-emitting diode directly modulated based on digital data; and

(2) photographic processing the sliver halide light-sensitive material,

wherein an optical density of dots and a dot gain are independently controlled by exposure in the exposing step.

2. An area modulation image forming method of a sliver halide light-sensitive material which contains a support having thereon at least one silver halide emulsion layer, comprising the steps of:

(1) scanning exposing the sliver halide light-sensitive material according to either a level of an exposure amount of a halftone area or a level of an exposure amount of a minimum density area; and

(2) photographic processing the sliver halide light-sensitive material,

wherein the level of an exposure amount of the minimum density area is to be at least one half the exposure amount which is the threshold of development.

3. An image forming method of a sliver halide light-sensitive material which contains a paper support having thereon at least one silver halide emulsion layer, comprising the steps of:

(1) exposing the sliver halide light-sensitive material wound onto a circumferential surface of a rotating drum; and

(2) photographic processing the sliver halide light-sensitive material,

wherein the light-sensitive material is produced in such a manner that the light-sensitive material is wound in the form of a roll having a diameter of from 80 to 180 mm; a light-shielding flange is provided at both ends of the resulting roll; the light-sensitive material and the flanges are partially packaged employing a light-shielding sheet; and under such a packaged state, the light-sensitive material is subjected to thermal processing under an atmosphere of at least 30° C. for 3 to 10 days.

4. An area modulation image forming method of a silver halide light-sensitive material, comprising the steps of:

(1) exposing the silver halide light-sensitive material with an exposure device having a function of scanning exposing the silver halide light-sensitive material and a function of controlling an exposure amount based on information regarding the silver halide light-sensitive material; and

(2) photographic processing the sliver halide light-sensitive material,

wherein a part of the packaging material of the silver halide light-sensitive material is capable of storing the information regarding the silver halide light-sensitive material and the information is stored in a seal which is capable of re-adhesion.

5. An area modulation image forming method of a silver halide light-sensitive material which contains a support having thereon at least one silver halide emulsion layer, comprising the steps of:

(1) exposing the silver halide light-sensitive material based on digital data; and

(2) photographic processing the sliver halide light-sensitive material with a developer replenisher which is replenished depending on a size of an image area and an amount of the light-sensitive material processed.

wherein the size of the image area is obtained through communication information between an output device and the front side of the output device, and a boundary between the image area and a non-image area is displayed utilizing a line.

6. A silver halide light-sensitive photographic material which comprises a support having thereon at least one silver halide emulsion layer, wherein the silver halide emulsion contains a compound represented by Formula (SP-1), described below,

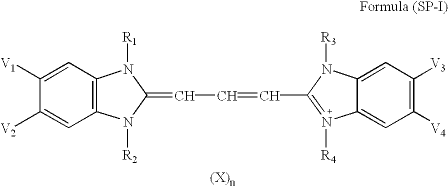

wherein R₁ and R₃ each represent a substituted or unsubstituted alkyl group, R₂ and R₄ each represent a lower alkyl group, either R₂ and R₄ represents an alkyl group of which hydrophilic group is substituted with a hydrophilic group; V₁, V₂, and V₃ each represent a hydrogen atom or a substituent, and at least one of V₂ and V₄ represents a sulfamoyl group; X represents an ion which is necessary to neutralize a charge in a molecule; and n represents the number of ions which are necessary to eliminate charges in a molecule.

7. An area modulation image forming method of a negative-working silver halide light-sensitive material which contains a support having thereon a silver halide emulsion layer, comprising the steps of:

(1) fixing the negative-working silver halide light-sensitive material on a drum;

(2) scanning exposing the negative-working silver halide light-sensitive material based on digital data; and

(3) photographic processing the negative-working silver halide light-sensitive material,

wherein a reflection density of a surface of the drum is from 0.7 to 3.5, and a transmission density of the unexposed part of the developed negative-working silver halide light-sensitive photographic material is from 0.5 to 1.2.

8. A silver halide light-sensitive material which contains a reflective support having thereon a silver halide emulsion layer containing a silver halide emulsion having an average silver chloride content ratio of at least 95 mole percent,

wherein the silver halide emulsion layer comprises a magenta coupler represented by Formula (M) described below and a sensitizing dye represented by Formula (SP-II), also described below,

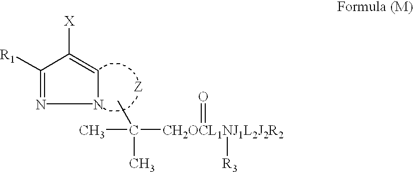

wherein L₁ and L₂ each represent an alkylene group; J₁ represents —(C═O)— or —(O—S═O)—; J₂ represents —(C═O)—, —(C═O)O—, —O—(C═O)—, —O═(C═O)—O—, —(C═O)—NR₄—, —NR₅—(C═O)—, —(O═S═O)—, —(O═S═O)—O—, —O—(O═S═O)—, —O—(O═S═O)—O—, —(O═S═O)—NR₆—, or —NR₇—(O═S═O)—, wherein R₁ through R₇ each represent a hydrogen atom, an alkyl group, a cycloalkyl group, an alkenyl group, an alkynyl group, or an aryl group; X represents a hydrogen atom, a halogen atom, or a releasable group upon reacting with an oxidized product of a color developing agent; and Z represents a non-metallic atom which is necessary for forming a nitrogen-containing heterocyclic ring,

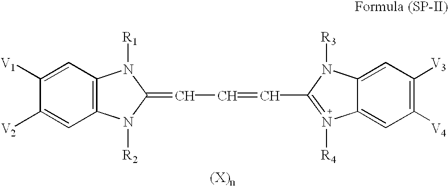

wherein R₁ and R₃ each represent a substituted or unsubstituted alkyl group, at least one of R₁ and R₃ represents a substituent other than an ethyl group; either R₂ or R₄ represents an alkyl group which is substituted with a hydrophilic group; V₁, V₂, V₃, and V₄ each represent a hydrogen atom, a substitutable group that results in a sum of Hammett σp value of no more than 1.7; V₁ through V₄ do not represent a hydrogen atom or a chlorine atom at the same time; X represents an ion which is necessary for neutralizing a charge in a molecule; and n represents the number of ions which are necessary for eliminating a charge in a molecule.

9. An area modulation image forming method of a silver halide light-sensitive material in the form of a rectangular with an at least 400 mm short side, which contains a support having thereon silver halide emulsion layers having an average silver chloride content ratio of at least 95 mole percent, which form yellow, magenta, and cyan images, and a light-insensitive colloidal layer, comprising the steps of:

(1) exposing with an exposure section in which a plurality of modulated light sources which utilizes different signals is arranged in a secondary scanning direction; and

(2) photographic processing the photographic processing the sliver halide light-sensitive material,

wherein at least one of the silver halide emulsion layers comprises a compound represented by Formula (SP-III) and a compound represented by Formula (SP-IV),

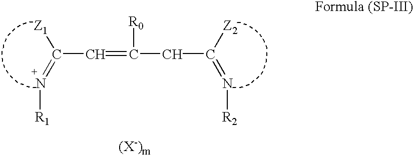

wherein Z₁ and Z₂ each represent a group of atoms which are necessary for forming a thiazole nucleus, a benzothiazole nucleus, or a naphthothiazole nucleus; R₁ and R₂ each represent an alkyl group, an alkenyl group, or an aryl group; R₁ and R₂ each may be substituted; and further the carbon chain may be disconnected through the inclusion of an oxygen atom or a sulfur atom; Ro represents a hydrogen atom, an alkyl group, or an aralkyl group; X⁻ represents a negative ion; and m represents 0 or 1,

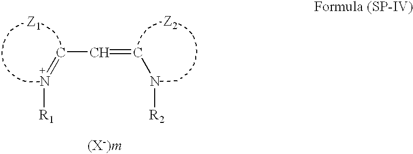

wherein Z₁ and Z₂ each represent a group of atoms which are necessary for forming an oxazole nucleus, a benzoxazole nucleus, or a naphthoxazole nucleus; R₁ and R₂ each represent an alkyl group, an alkenyl group, or an aryl group; X⁻ represents a negative ion; and m represents 0 or 1.

10. A silver halide light-sensitive material containing an 80 to 150 μm thick white support having a spectral reflection density of no more than 0.06 in the wavelength region of from 450 to 700 nm and a spectral reflection density difference ΔD (the maximum density−the minimum density) in the wavelength region of from 450 to 600 nm of no more than 0.01, having thereon a plurality of silver halide light-sensitive color emulsion layers having different spectral sensitivities, and further after photographic processing, having an opacity specified by JIS P 8138 of at least 90 percent.

11. An area modulation image forming method of a silver halide light-sensitive material which contains a support having thereon at least one silver halide emulsion layer, comprising the steps of:

(1) fixing the silver halide light-sensitive material on a drum;

(2) exposing the silver halide light-sensitive material with an exposure device having a function of scanning exposing the silver halide light-sensitive material based on digital data as well as a function of controlling an exposure amount based on a surface temperature information upon direct measurement of the surface temperature of the silver halide light-sensitive material, or upon indirect determination of the surface temperature based on a temperature in a inside part of the exposure section or a surface temperature of the exposure drum; and

(3) photographic processing the silver halide light-sensitive material,

wherein at least one of the silver halide light-sensitive layers comprises a compound represented by Formula (I) or Formula (II), described below,

R₁—(S)ₘ—R₂ Formula (I)

wherein R₁ and R₂ each represent an aliphatic group, an aromatic group, or a heterocyclic group; either R₁ or R₂ represents a group of atoms capable of combining with said S to form a ring; and m represents an integer from 2 to 6,

R—SO₂S—M Formula (II)

wherein R represents an aliphatic group, an aromatic group, or a heterocyclic group, and M represents a hydrogen atom or an univalent cation.

12. An area modulation image forming method of a silver halide light-sensitive material which contains a support having thereon a yellow forming layer, a magenta forming layer, and a cyan forming layer each of which comprises a silver halide having an average silver chloride content ratio of at least 95 mole percent, comprising the steps of:

(1) exposing the silver halide light-sensitive material; and

(2) photographic processing the sliver halide light-sensitive material,

wherein a locus of the resulting absorption of a yellow dye form a yellow forming coupler passes through the interior of a CIELAB color space sphere with a diameter of 10, having a center at L*=85, a*=−5, and b*=85 when a maximum yellow density (Dₘₐₓ) of the yellow forming layer is at least 1.5 and the density is varied, and the yellow forming coupler being a compound represented by Formula (Y) described below; and the yellow forming coupler layer being the farthest color forming layer from the support,

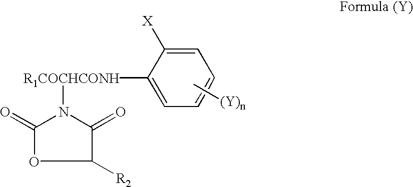

wherein R₁ represents an alkyl group, a cycloalkyl group, an amino group, a heterocylic group, or an aryl group; R₂ represents a straight-chained or branched-chained unsubstituted alkyl group having at least two carbon atoms; X represents a chlorine atom, an alkoxy group, or an aryloxy group; when R₁ represents an alkyl group, a cycloalkyl group, an amino group, or a heterocyclic group, Y represents an acylamino group or a chlorine atom, and when R₁ represents an aryl group, Y represents a sulfonylamino group, a chlorine atom, or an oxycarbonyl group; and n represents an integer of 0 to 4, when n is 2 or more, a plurality of Y may be the same or different.

13. An area modulation image forming method of a silver halide light-sensitive material which contains a support having thereon at least one silver halide emulsion layer, comprising the steps of:

(1) fixing the silver halide light-sensitive material on a drum;

(2) exposing the silver halide light-sensitive material with an exposure device having a function of scanning exposing the silver halide light-sensitive material based on digital data as well as a function of controlling an exposure amount based on a surface temperature information upon direct measurement of the surface temperature of the silver halide light-sensitive material, or upon indirect determination of the surface temperature based on a temperature in the interior of the exposure section or a surface temperature of said exposure drum; and

(3) photographic processing the silver halide light-sensitive material,

wherein at least one of the silver halide light-sensitive layers comprises a silver halide having an average silver chloride content ratio of at least 95 mole percent, a compound represented by Formula (SP-V), and a compound represented by Formula (SP-VI), which are described below,

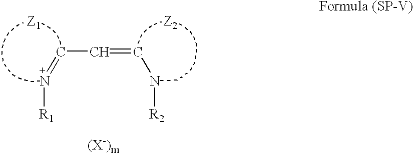

wherein Z₁ and Z₂ each represent a group of atoms which are necessary for forming a thiazole nucleus, a benzothiazole nucleus, or a naphthothiazole nucleus; R₁ and R₂ each represent an alkyl group, an alkenyl group, or an aryl group; X⁻ represents an anion; m represents 0 or 1,

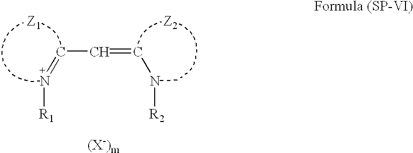

wherein Z₁ represents a group of atoms which are necessary for forming a benzoxazole nucleus or a naphthoxazole nucleus; Z₂ represents a group of atoms which are necessary for forming a thiazole nucleus, a benzothiazole nucleus, or a naphthothiazole nucleus; R₁ and R₂ each represent an alkyl group, an alkenyl group, or an aryl group; and X⁻ represents an anion; m represents 0 or 1.

14. An area modulation image forming method of a silver halide light-sensitive material which contains a support having thereon a silver halide emulsion layer comprising a silver halide emulsion having an average silver chloride content ratio of at least 95 mole percent and a gold compound, comprising the steps of:

(1) exposing the silver halide light-sensitive material; and

(2) photographic processing the silver halide light-sensitive material,

wherein at least one of the silver halide emulsion layer comprises at least one of the compounds represented by Formulas (III), (IV), and (V), described below,

Rf1—(L1)m1—(Y1)n1—X1 Formula (III)

wherein Rf1 represents a perfluoroalkyl group; L1 represent a divalent bonding group; Y1 represents an alkyleneoxide group or an alkylene group, each of which may have a substituent; X1 represents a hydrogen atom, a hydroxyl group, an anionic group, or a cationic group; m1 represents 0 or an integer of from 1 to 5; and n1 represents an integer of 0 to 40,

Rf2—(O—Rf3)n2—L2—(X2)m2 Formula (IV)

wherein Rf2 represents an aliphatic group having at least one fluorine atom; Rf3 represents an alkylene group having at least one fluorine atom; n2 and m2 each represent an integer of 1 or more; L2 represents a bonding atom or a bonding group; and X2 represents a hydroxyl group, an anionic group, or an cationic group,

[(Rf4O)n3—(PFC)—CO—Y3]—L3—(X3)m3 Formula (V)

wherein Rf4 represents a perfluoroalkyl group having from 1 to 4 carbon atoms; PFC represents a perfluorocycloalkylene group; Y3 represents a bonding group comprising an oxygen atom or a nitrogen atom; L3 represents a bonding atom or a bonding group; X3 represents a water solubilizing polar group comprising an anionic group, a cationic group, a nonionic group, or an amphoteric group; n3 represent an integer of 1 to 5; k represents an integer of 1 to 3; and m3 represents an integer of 1 to 5.

15. An area modulation image forming method of a silver halide light-sensitive material which contains a support having thereon at least one silver halide emulsion layer, comprising the steps of:

(1) exposing the silver halide light-sensitive material utilizing a plurality of light elements whose light output power is less than that required for forming an image; and

(2) photographic processing the sliver halide light-sensitive material,

wherein the silver halide emulsion layers contains negative-working silver halide grains having an average silver chloride content ratio of at least 95 mole percent, and a grain surface phase whose silver bromide content is higher than other regions of the grain surface.

16. A photographic processing method of a silver halide light-sensitive material which contains a support having thereon a silver halide emulsion layer having an average silver chloride content ratio of at least 95 mole percent, employing an automatic processor having at least three stabilization processing tanks utilizing a cascaded counter-current system,

wherein (1) at least one tank besides a first processing thank and a final processing tank of the stabilization processing tanks has a heating device, (2) a content ratio of an optical brightening agent and a chelating agent incorporated into a stabilizer of the final process is no more than 50 percent of that of the optical brightening agent of the first processing tank, (3) a stabilizing agent replenisher is replenished only to the final processing tank, and (4) the content of the chelating agent and the optical brightening agent in the stabilizing agent replenisher is two times higher than the initial concentration of the stabilizer in the final processing tank.

17. An area modulation image forming method of a silver halide light-sensitive material which contains a support having thereon a silver halide emulsion having an average silver chloride content ratio of at least 95 mole percent, comprising the steps of:

(1) scanning exposing the silver halide light-sensitive material; and

(2) photographic processing the silver halide light-sensitive material with processing solutions which include

(i) a color developing solution comprises a developing agent represented by Formula (VI) described below in an amount of at least 55 mole percent of total developing agents, and

(ii) a starter comprises at least one type of nitrogen-containing heterocyclic compound,

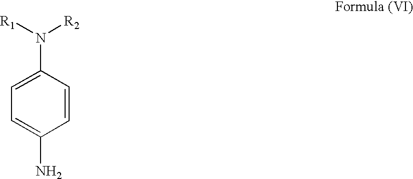

wherein R₁ and R₂ each represent a substituted or an unsubstituted alkyl group, and R₁ and R₂ may combine to form a ring.

18. An area modulation image forming method of a silver halide light-sensitive material containing a support having thereon at least one yellow image forming silver halide emulsion layer, at least one magenta image forming silver halide emulsion layer, and at least one cyan image forming silver halide emulsion layer, is subjected to image exposure based on digital data, comprising the steps of:

(1) exposing the silver halide light-sensitive material based on digital data; and

(2) continuously processing while replenishing a replenisher,

wherein exposure is carried out employing an exposure amount obtained from a relationship between the exposure amount and a color density in which a previously determined relationship has been corrected utilizing the relationship of two optional points of the silver halide light-sensitive material employed.

### BRIEF DESCRIPTION OF THE DRAWINGS

In FIG. 1, the upper drawing shows a state prior to assembly. Light shielding sheet 3 was fixed face to face on the edge of rolled photosensitive material 1, employing adhesive tape; subsequently, light shielding flange 2 was inserted into both edges of said roll; while pulling light shielding sheet 3, it is wound onto said roll; and assembly is carried out so that said light-sensitive material and said light shielding flange are covered with said light shielding sheet. The lower drawing shows the rolled light-sensitive material after the assembly.

1: light-sensitive material

2: light shielding flange

3: light shielding sheet

4: adhesive tape

FIG. 2 shows a drawing of a label adhered onto a corrugated cardboard box into which light-sensitive materials are placed. By peeling releasing paper 6, labels 1 and 2 were adhered onto said light-sensitive material-placed corrugated cardboard box, employing a permanent adhesion adhesive layer. However, label 2, on which light-sensitive material information is described, is separated from label 1 together with pressure sensitive adhesive layer 3 capable of being used for repeated adhesion, utilizing cut line 7, and further separated from releasing paper 4 so as to result in a state for re-adhesion onto another place.

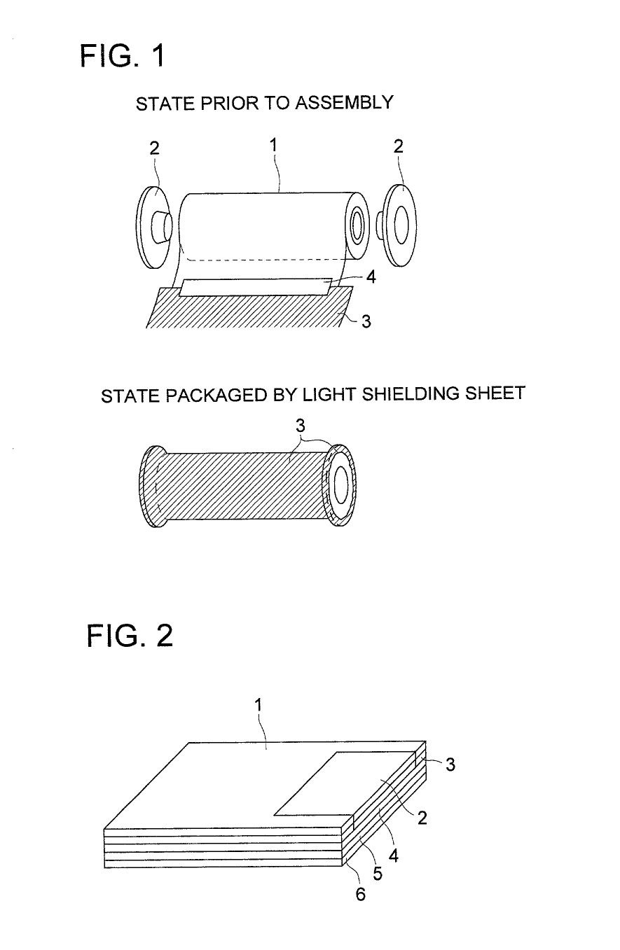

1: label

2: label (on which Light-Sensitive information is descried: it is possible to separate from 1)

3: pressure sensitive adhesive layer capable of being used for repeated adhesion

4: releasing paper

5: permanent adhesion adhesive layer

6: releasing paper

FIG. 3 shows a method for correcting a standard condition table utilizing 2 points of a light-sensitive material which exhibits different performance from standard conditions.

1: characteristic curve of standard light-sensitive material

2: characteristic curve of Light-Sensitive martial resulting in deviated performance

Dh: standard density in the high density range

Dl: standard density in the low density range

Eh: necessary exposure amount to result in density Dh for a standard light-sensitive material

El: necessary exposure amount to result in density Dl for a standard light-sensitive material

eh: necessary exposure amount to result in density Dh for a light-sensitive material exhibiting deviated performance

el: necessary exposure amount to result in density Dl for a light-sensitive material exhibiting deviated performance

x: necessary exposure amount to result in Density D for a light-sensitive material, exhibiting deviated performance.

### DETAILED DESCRIPTION OF THE INVENTION

One of the features of this invention, described in item 1, is that light-emitting diodes (hereinafter referred to as LED) are used as the exposure light source; the variation of exposure is carried out utilizing direct modulation in which the electric current value running through each element is varied; and modulation elements such as AOM, are not employed. When exposure is carried out employing an optical system using a modulation element such as AOM, though the reason has not been clarified, it was discovered that color variation occurred during continuous image formation. It is assumed that the resulting variation occurs due to only the problems of the characteristics of elements such as AOM, but results due to the results of accumulated phenomena such as the deviation of optical axes of various members due to expansion caused by temperature. However, as noted above, the reason has not yet been clarified.

One of the features of the present invention is to independently control density and dot gain. Employed as spectral conditions of the density according to claim 1 may be any of Status T, Status A, and others. However, Status T is preferred since it is employed in the printing field. Employed as geometrical conditions may be any of 0-45, 45-0 or d-0, D-0 (specified in JIS Z 8722-1982 4.3.1 Geometrical Conditions of Illumination and Light Acceptance), but in the invention described in claim 12, said spectral conditions are to be Status T, while said geometrical conditions are to be 0-45 or 45-0.

Japanese Patent Publication Open to Public Inspection No. 5-66557 discloses a color image proofing device utilizing Light-Sensitive color materials in which formed color density is adjusted by adjusting the transmitted light amount while adjusting the ON and OFF voltage value which is applied to AOM (Acoustic Optical Modulator), and further discloses that by utilizing said device, it is possible to render said formed color density and the density of the minimum density area variable so as to make it possible to form images similar to printed images, and it becomes possible to carry out proofing of special color printing.

However, when the optical system, in which laser and AOM are combined, were used, problems occurred in which, during continuous image output, color variation resulted. However, nothing is being described regarding said problems and no suggestion is offered to overcome said problems is presented.

One of the features of the present invention, described in item 2, is that in area modulation image formation, exposure in a specified amount is carried out onto said minimum density areas. An area modulation image is a so-called halftone image which is comprised of color formed areas and non-color formed areas. Therefore, when a negative emulsion is employed, said minimum density area may not need to be exposed. However, one of the features of the present invention is that said minimum density areas are exposed employing an exposure amount which is at least one half of the threshold value which initiates the development of the minimum density area.

The threshold value to initiate development is readily determined by preparing a so-called characteristic curve in such a manner that a silver halide Light-Sensitive martial is subjected to exposure while varying the exposure amount and subsequently subjected to photographic processing. As said exposure amount increases, preferred effects increase. However, when said exposure amount exceeds the development threshold value, naturally color formation results. Therefore, in accordance with the intended purposes, it may be necessary to adjust the exposure amount as desired.

One feature of the invention described in item 3 is that said light-sensitive material is wound in the form of a roll having a diameter of from 80 mm to 180 mm; a light-shielding flange is provided at both ends of the resulting roll; said light-sensitive material and said flanges are partially packaged employing a light-shielding sheet; and in such a packaged state, said light-sensitive material is subjected to thermal processing under an atmosphere of at least 30° C. for 3 to 10 days. By so doing, it is possible to consistently obtain the suitable magnitude of curling. As a result, when exposure is carried out utilizing an external surface drum system, the desires enhancement of the accuracy of image location is achieved.

One feature of the invention described in items 11 and 13 is that a silver halide light-sensitive material is fixed on an exposure drum, and subsequently is subjected to exposure employing an exposure device which exhibits a function to perform imagewise exposure through scanning exposure based on digital data, as well as a function to control an exposure amount based on surface temperature information upon directly determining said surface temperature of said silver halide light-sensitive material fixed on said drum, or indirectly determining said surface temperature based on the temperature in the interior of said exposure device or the surface temperature of said exposure drum.

Preferably employed as methods for determining the ambient temperature in said exposure device as well as the surface temperature of said drum may be any of several temperature determining means suitably used at near room temperature, which are described in “Shin Zikken Kagaku Koza I (New Experimental Chemistry Lectures I), Kihon Sosa I (Basic Operations I), edited by Nihon Kagaku Kai (Japan Chemical Society), pages 84 through 97 (1975), Maruzen, Tokyo. Of these, a platinum resistance thermometer, a thermister, and an optical thermometer are preferably employed.

One feature of the invention described in items 8 through 10 and 12 through 17 is that a silver halide emulsion, having an average silver chloride content ratio of at least 95 percent, is employed, and said silver halide emulsion is employed which has optional halogen compositions such as silver chloride, silver chlorobromide, silver iodobromide, and silver chloroiodide. Of these, silver chlorobromide, containing silver chloride in an amount of at least 95 mole percent, is preferably employed.

Further, one feature of the invention, described in item 15, is that the silver chloride content ratio is at least 95 percent, and negative-working silver halide grains in which on the grain surface there is a phase having a higher silver bromide content than other regions, are incorporated. The portion containing silver bromide at a higher concentration in the silver halide emulsion having a portion containing silver bromide at higher concentration may be comprised of a so-called core/shell emulsion. A so-called epitaxy joint region may be formed in which there are regions having a locally different composition region, without forming a perfect layer. It is particularly preferred that the portion containing silver bromide at a higher concentration be formed at the top of the crystal grain on the surface of silver halide grains. Further, said composition may or may not continuously vary. For example, Japanese Patent Publication Open to Public Inspection No. 1-183674 discloses that a silver halide Light-Sensitive photographic material, which is comprised of silver chloride in an amount of at least 70 mole percent of the total grains, has a silver halide localized phase in a silver bromide in a ratio of at least 70 mole percent on the surface or in the interior of said particles, and contains iron ions in said particles, results in higher sensitivity, and a minimization of variation of photographic performance due to temperature and humidity during exposure. However, no description is made regarding problems which are caused by including the specific area modulation image forming method as for the present invention.

Specifically, in the invention in which silver halide compositions are not limited, it is possible to employ silver halide having any composition. However, the chlorobromide emulsion, containing silver chloride in a content ratio of at least 95 mole percent, is preferably employed. Still further, preferably employed is negative-working silver halide containing silver chloride in a content ratio of at least 95 mole percent and further containing a phase having a higher silver bromide content than other region, and silver chloroiodide containing silver iodide near the grain surface in an amount of from 0.05 to 0.50 mole percent.

It is advantageous that heavy metal ions be incorporated into the negative-working silver halide emulsion employed in the present invention. Consequently, it is expected that so-called reciprocity law failure be improved so that desensitization at high intensity exposure is minimized and contrast reduction on the shadow side is also minimized. Listed as heavy metal ions to achieve such purposes may be each ion of the metals in Groups 8 through 10, such as iron, iridium, platinum, palladium, nickel, rhodium, osmium, ruthenium, and cobalt; transition metals, in Group 12, such as cadmium, zinc, and mercury; lead, rhenium, molybdenum, tungsten, gallium and chromium. Of these, metal ions of iron, iridium, platinum, ruthenium, gallium, and osmium are preferred. It is possible to incorporate these metal ions into a silver halide emulsion in the form of salts and complex salts. When said heavy metal ions form complex salts, listed as ligands may be cyanide ions, thiocyanate ions, cyanate ions, chloride ions, bromide ions, iodide ions, ammonia, carbonyl, and 1,2,4-triazole. Of these, cyanide ions, thiocyanate ions, isothiocyanate ions, chloride ions, and bromide ions, are preferred. In order to incorporate heavy metal ions into a silver halide emulsion, said heavy metal compounds may be added at the optional stage of each process prior to formation of silver halide grains, during formation of silver halide grains, during physical ripening after formation of silver halide grains. In order to obtain the silver halide emulsion which satisfies said conditions, heavy metal compounds are dissolved along with halide salts, and the resulting solution may be added continuously during the entire or part of the grain forming process. Further, minute silver halide grains comprising any of these heavy metal compounds are previously formed, and the desired emulsion may be prepared by adding said minute silver halide grains. The added amount of said heavy metal ions into said silver halide emulsion is preferably from 1×10⁻⁹ to 1×10⁻² mole per mole of silver halide, and is more preferably from 1×10⁻⁸ to 5×10⁻⁵ mole.

The shape of grains employed in the present invention is optional. One of the preferred examples is a cube having a (100) plane as the crystal surface. Further, grains having the shape of an octahedron, a dodecahedron, and a tetrahedron, may be prepared and employed. Grains having twin planes may also be employed.

Preferably employed as grains used in the present invention are those having an identical shape. However, it is particularly preferable that at least two types of monodispersed silver halide emulsions be added to the same layer.

The diameter of grains employed in the present invention is not particularly limited. However, when other photographic performance such as quick processing properties, and sensitivity is taken into account, said diameter is preferably in the range of from 0.1 to 1.2 μm, and is more preferably in the range of from 0.2 to 1.0 μm.

It is possible to determine said grain diameter utilizing the projection area of grains or diameter approximate values. When grains are substantially uniform in shape, it is possible to fairly accurately express a grain size distribution either as diameter or projection area.

The grain size distribution of silver halide grains, employed in the present invention, preferably has a variation coefficient of no more than 0.22, and is more preferably no more than 0.15, which is obtained by a monodispersed emulsion. It is particularly preferable that at least two types of monodispersed emulsions having a variation coefficient no more than 0.15 be added to the same layer. The variation coefficient as described herein is the coefficient which expresses the broadness of said grain size distribution, and is defined by the formula described below.

Variation coefficient=S/R

wherein S represents the standard deviation of the grain size distribution, and R represents the average grain diameter.

Employed as apparatus and methods for preparing silver halide emulsions are the various ones known in the art in this industry.

The emulsions employed in the present invention may be those prepared employing any of an acid method, a neutral method, and an ammonia method. Said grains may be grown one stage or grown after preparing seed grains. The method for preparing seed grains and the method for growing the same may be the same or different.

Further, employed as types to allow soluble silver salts to react with soluble halides may be any of a normal mixing method, a reverse mixing method, a double jet mixing method, and combinations thereof. However, emulsions, which are obtained by employing the double jet method, are preferred. Further, employed as one type of said double jet mixing method may be a pAg controlled double jet method described in Japanese Patent Publication Open to Public Inspection No. 54-48521.

Further, it may use the following devices: a device described in Japanese Patent Publication Open to Public Inspection Nos. 57-92523, 57-92524, and others, in which an aqueous water-soluble silver salt and water-soluble halide salt solution is supplied from a supply unit disposed in a reaction mother liquid; a device described in German OLS Patent No. 2921164 and others, in which an aqueous water-soluble silver salt and water-soluble halide salt solution is added while continuously varying its concentration; a device described in Japanese Patent Publication No. 56-501776 and others, in which a reaction mother liquid is removed from a reaction vessel, and by concentrating the removed liquid utilizing ultrafiltration, grains are formed while the distance between silver halide grains is kept constant.

Still further, if desired, silver halide solvents such as thioether may be employed. In addition, compounds such as mercapto group-containing compounds, nitrogen-containing heterocyclic compounds, or sensitizing dyes may be employed while adding any of them during the formation of silver halide grains or after the formation of grains.

A sensitization method employing gold compounds and a sensitization method employing chalcogen may be combined and applied to the negative-working silver halide emulsion employed in the present invention. Employed as chalcogen sensitizers may be sulfur sensitizers, selenium sensitizers, and tellurium sensitizers. Of these, sulfur sensitizers are preferred. Listed as sulfur sensitizers are thiosulfate salts, triethylthiourea, allylthiocarbamidothiourea, allyl isothiocyanate, cystine, p-toluenesulfonate, rhodanine, and inorganic sulfur.

The added amount of said sulfur sensitizers is preferably varied depending on the types of silver halide emulsions to which said sensitizers are added, and on the desired magnitude of the resulting effects. However, said added amount is generally in the range of from 5×10⁻¹⁰ to 5×10⁻⁵ mole per mole of silver halide, and is preferably in the range of from 5×10⁻⁸ to 3×10⁻⁵ mole.

One feature of the invention described in item 14 is to comprise gold compounds. Gold compounds include chloroauric acid, and gold sulfide, and in addition, various gold complexes, which may be added as gold sensitizers. Listed as ligand compounds may be dimethylrhodanine, thiocyanic acid, mercaptotetrazole, mercaptotetrazole, and mercaptotriazole. In this case, it is not always necessary to utilize these compounds as sensitizers, and they may be added during the preparation of coating compositions. The employed amount of gold compounds varies depending on the types of silver halide emulsions, the types of employed compounds, and the ripening conditions. However, said employed amount is generally from 1×10⁻⁴ to 1×10⁻⁸ mole per mole of silver halide, and is preferably from 1×10⁻⁵ to 1×10⁻⁸ mole.

Employed as chemical sensitization methods for negative-working silver halide emulsions may be a reduction sensitization method.

One of the features of this invention described in item 11 is to comprise compounds represented by Formula (I).

In Formula (I), R₁ and R₂ each are preferably a phenyl group, a pyridinyl group, and a morpholine group, and may be combined with each other to form a ring.

Preferred specific examples of compounds represented by Formula (I) are shown below. However, the present invention is not limited to these examples.

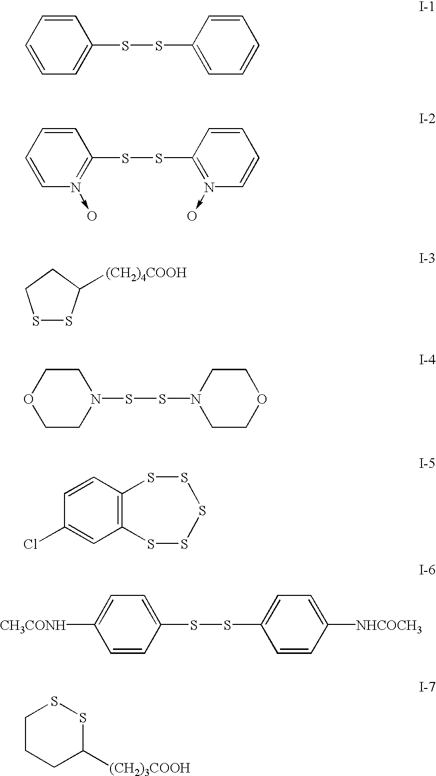

One of the features of this invention described in item 11 is to comprise compounds represented by Formula (II).

In said Formula (II), R is preferably a lower alkyl group and a phenyl group. Said phenyl group substituted with a methyl group, a methoxy group, an acetoamide group, or a chlorine atom is also preferred.

Preferred specific examples of compounds represented by Formula (II) are shown below. However, the present invention is not limited to these examples. 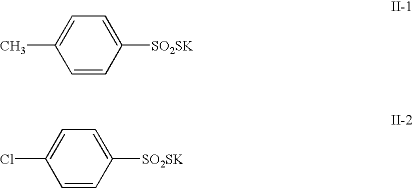 C₄H₉SO₂SK II-3

KSO₂S—(CH₂)₄—SO₂SK II-4

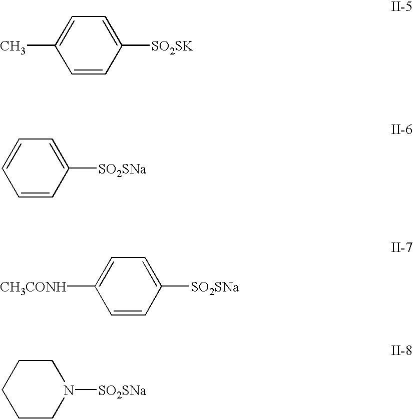

For the purpose of minimizing fog which results during the preparation processes of silver halide light-sensitive materials, performance variation during storage, and fog which results during development, antifoggants as well as stabilizers, known in the art, may be incorporated into the silver halide emulsion employed in the present invention. Listed as examples of compounds, which may be employed to achieve such purposes, may be compounds described in the lower column on page 7 of Japanese Patent Publication Open to Public Inspection No. 2-146036. Listed as specific compounds, which are more preferable, may be compounds (IIa-1) through (IIa-8) and (IIb-1) through (IIb-7), as well as compounds described in lines 32 through 36 of the right column on page 8 of Japanese Patent Publication Open to Public Inspection No. 2000-267235. In accordance with said purposes, any of these compounds is added during processes such as the preparation process of silver halide emulsion grains, chemical sensitization process, the end of the chemical sensitization process, and the preparation of coating compositions. When the chemical sensitization is carried out in the presence of these compounds, the employed amount is preferably from about 1×10⁻⁵ to about 5×10⁻⁴ mole per mole of silver halide. When added after the completion of chemical sensitization, the added amount is preferably from about 1×10⁻⁶ to about 1×10⁻² mole per mole of silver halide, and is more preferably from 1×10⁻⁵ to 5×10⁻³ mole. When added to silver halide emulsion layers during the preparation process of coating compositions, the added amount is preferably from about 1×10⁻⁶ to about 1×10⁻¹ mole per mole of silver halide, and is more preferably from 1×10⁻⁵ to 1×10⁻² mole. Further, when added to layers other than silver halide emulsion layers, the amount in the coated layer is preferably from about 1×10⁻⁹ to about 1×10⁻³ mole per m².

In the Light-Sensitive photographic materials employed in the present invention, dyes, which exhibit absorption in various wavelength regions, may be employed for the purpose of minimizing irradiation as well as halation. For said purposes, any compounds known in the art may be employed. Preferably employed as dyes which exhibit absorption in the visible region are dyes AI-1 through AI-11 described on page 308 of Japanese Patent Publication Open to Public Inspection No. 3-251840 as well as dyes described in Japanese Patent Publication Open to Public Inspection No. 6-3770.

The silver halide light-sensitive material according to the present invention preferably comprises at least one hydrophilic colloidal layer tinted with diffusion resistant compounds, on the side nearer the support than the silver halide emulsion layer which is nearest to said support among the silver halide emulsion layers on the said support. Employed as colorants may be dyes and other organic and inorganic colorants.

The silver halide light-sensitive material employed in the present invention preferably comprises at least one tinted hydrophilic colloidal layer on the side nearer the support than the silver halide emulsion layer which is nearest said support among silver halide emulsion layers on the said support. Said layer may comprise white pigments. For example, it is possible to employ rutile type titanium dioxide, anatase type titanium dioxide, barium sulfate, barium stearate, silica, alumina, zirconium oxide, or kaolin. However, of these, due to various reasons, titanium oxide is preferred. White pigments are dispersed into hydrophilic colloid aqueous solution binders such as gelatin. The coated amount of said white pigments is preferably in the range of from 0.1 to 50 g/m², and is more preferably in the range of from 0.2 to 5 g/m².

Between the support and the silver halide emulsion layer nearest the support, other than the white pigment containing layer, it is possible, if desired, to arrange a subbing layer, or light-insensitive hydrophilic colloidal layers such as interlayers at optional positions.

By adding optical brightening agents to the silver halide light-sensitive material according to the present invention, the whiteness of any white background is preferably improved. Said optical brightening agents are not particularly limited as long as they are compounds capable of absorbing ultraviolet rays and emitting fluorescence. Preferred optical brightening agents include diaminostilbene based compounds having at least one sulfonic acid group in the molecule, which exhibit effects promoting the dissolving-out of sensitizing dyes to the exterior of said light-sensitive material. One preferred type includes minute solid particle compounds which exhibit fluorescent whitening effects.

The silver halide light-sensitive material according to the present invention comprises a layer comprised of a silver halide emulsion which is spectrally sensitized in the specified wavelength region of from 400 to 900 nm. Said silver halide emulsion layer comprises one type of sensitizing dye or combination of at least two types of sensitizing dyes.

One feature of the invention described in item 6 is to comprise compounds represented by Formula (SP-1).

In Formula (SP-I), preferred as groups represented by each of R₁ and R₃ are lower alkyl groups such as a methyl group, and an ethyl group, and preferred as groups represented by each of R₂ and R₄ are lower alkyl groups substituted with a hydrophilic group such as a sulfobutyl group, a sulfoethyl group, and a carboxymethyl group. Each group represented by V₁ through V₄ may be an optional substituent. However, at least one of them represents a sulfamoyl group. Those having an N-sulfonyl structure, in which the nitrogen atom of the sulfamoyl group forms a part of a saturated nitrogen-containing heterocyclic ring, are preferred.

Preferred specific examples represented by Formula (SP-I) are shown below. However, the present invention is not limited to these examples.

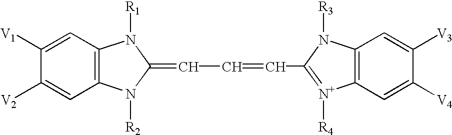

| No. | R₁ | R₂ | R₃ | R₄ | X | V₁ | V₂ | V₃ | V₄ |
|---|---|---|---|---|---|---|---|---|---|
| SP-I-1 | —C₂H₅ | —(CH₂)₃SO₃⁻ | —CH₃ | —(CH₂)₃SO₃⁻ | Na⁺ | —H | 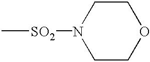 | —Cl | —CF₃ |
| SP-I-2 | —C₂H₅ | —(CH₂)₃SO₃⁻ | —C₂H₅ | —(CH₂)₃SO₃⁻ | Na⁺ | —H | 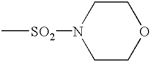 | —Cl | —CO₂CH₃ |
| SP-I-3 | —C₂H₅ | —(CH₂)₃SO₃⁻ | —C₂H₅ | —(CH₂)₃SO₃⁻ | Na⁺ | —Cl | 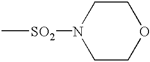 | —Cl | 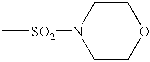 |
| SP-I-4 | —C₂H₅ | —(CH₂)₃SO₃⁻ | —CH₃ | —(CH₂)₃SO₃⁻ | Na⁺ | —Cl | 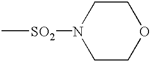 | —Cl | —Cl |
| SP-I-5 | —C₂H₅ | —C₂H₅ | —CH₃ | —(CH₂)₃SO₃⁻ | — | —H | 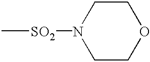 | —Cl | —CF₃ |
| SP-I-6 | —C₂H₅ | —C₂H₅ | —CH₃ | —(CH₂)₃SO₃⁻ | — | —H | 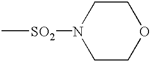 | —Cl | —Cl |
| SP-I-7 | —C₂H₅ | —CH₂CH₂F | —CH₃ | —(CH₂)₃SO₃⁻ | — | —Cl | 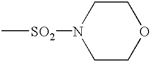 | —Cl | —Cl |

One feature of the invention described in item 8 is to comprise sensitizing dyes represented by the aforementioned Formula (SP-II).

In Formula (SP-II), preferred as groups represented by each of R₁ and R₃ are lower alkyl groups such as a methyl group, and an ethyl group, and preferred as groups represented by each of R₂ and R₄ are lower alkyl groups substituted with an acid group such as a sulfobutyl group, a sulfoethyl group, and a carboxymethyl group. Each group represented by V₁ through V₄ may be an optional substituent in which the total sum of the Hammett σp value is in the range of no more than 1.7. However, it is preferable that any combination of a hydrogen atom, a trifluoromethyl group and a substituted or unsubstituted sulfamoyl group be made and employed.

Preferred specific examples represented by Formula (SP-II) are shown below. However, the present invention is not limited to these examples.

| No. | R₁ | R₂ | R₃ | R₄ | X | V₁ | V₂ | V₃ | V₄ |
|---|---|---|---|---|---|---|---|---|---|
| SP-II-1 | —CH₃ | —(CH₂)₃SO₃⁻ | —CH₃ | —(CH₂)₃SO₃⁻ | Na⁺ | —Cl | —H | —Cl | —H |
| SP-II-2 | —CH₃ | —(CH₂)₂SO₃⁻ | —CH₃ | —(CH₂)₂SO₃⁻ | K⁺ | —H | —F | —H | —F |
| SP-II-3 | —C₂H₅ | —(CH₂)₃SO₃⁻ | —CH₃ | —C₂H₅ | — | —H | —CF₃ | —CH₃ | —CH₃ |
| SP-II-4 | —CH₃ | —(CH₂)₃SO₃H | —CH₃ | —(CH₂)₃SO₃ | K⁺ | —H | —CF₃ | —H | —CF₃ |
| SP-II-5 | —CH₃ | —(CH₂)₃SO₃⁻ | —CH₃ | —(CH₂)₃SO₃⁻ | Na⁺ | —H | 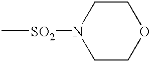 | —H | —CF₃ |
| SP-II-6 | —C₂H₅ | —(CH₂)₃SO₃⁻ | —CH₃ | —(CH₂)₃SO₃⁻ | Na⁺ | —H | 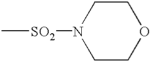 | —H | —CF₃ |

One feature of the invention described in item 9 is to comprise sensitizing dyes represented by the aforementioned Formula (SP-III).

In Formula (SP-III), heterocyclic groups represented by Z₁ and Z₂ may be substituted, and preferred as substituents are a methyl group, a methoxy group, a phenyl group, and a chlorine atom. R₁ and R₂ are preferably straight or branched lower alkyl groups, and are more preferably lower alkyl groups substituted with hydrophilic groups such as a sulfo group, and a carboxyl group.

Preferred specific examples represented by Formula (SP-III) are shown below. However, the present invention is not limited to these examples.

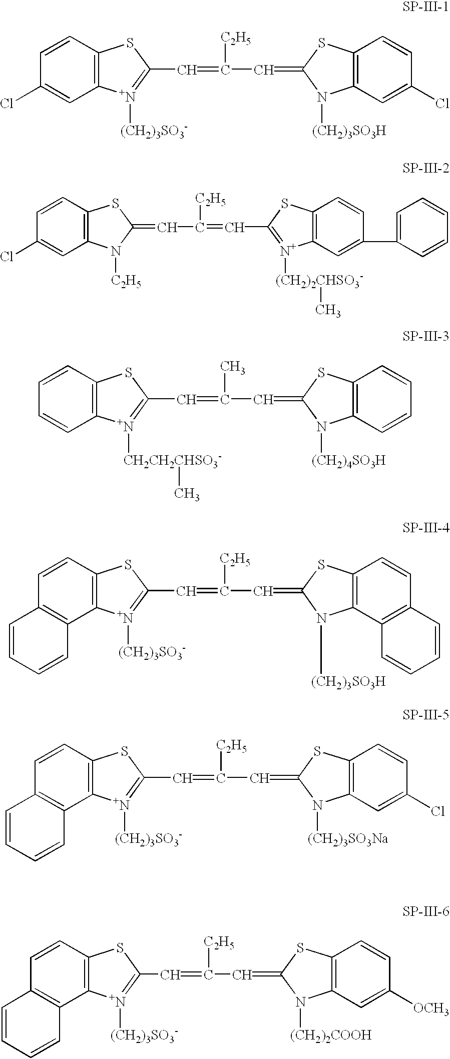

One of the features of this invention described in item 9 is to comprise sensitizing dyes represented by the aforementioned Formula (SP-IV).

In Formula (SP-IV), heterocyclic groups represented by Z₁ and Z₂ may be substituted, and preferred as substituents are a methyl group, a methoxy group, a phenyl group, a chlorine atom, a pyrrole ring, and a thiophene ring. R₁ and R₂ are preferably straight or branched lower alkyl groups, and are more preferably lower alkyl groups substituted with hydrophilic groups such as a sulfo group, and a carboxyl group.

Preferred specific examples represented by Formula (SP-IV) are shown below. However, the present invention is not limited to these examples.

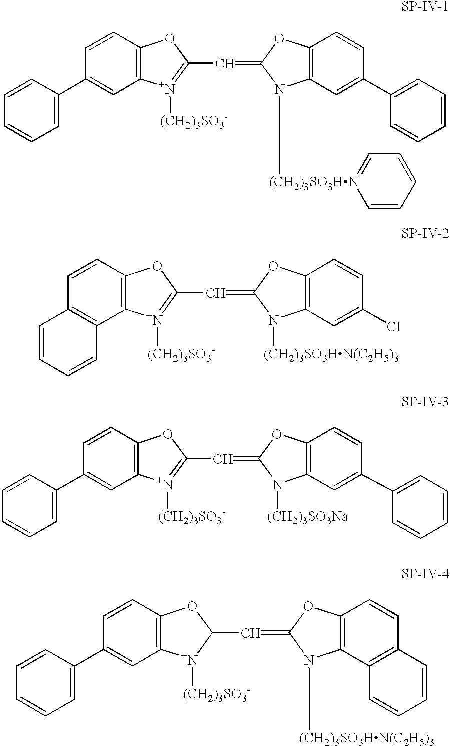

One of the features of this invention described in item 13 is to comprise sensitizing dyes represented by the aforementioned Formula (SP-V).

In Formula (SP-V), heterocyclic groups represented by Z₁ and Z₂ may be substituted, and preferred as substituents are a methyl group, a methoxy group, a phenyl group, a chlorine atom, a pyrrole ring, and a thiophene ring. R₁ and R₂ are preferably straight or branched lower alkyl groups, and are more preferably lower alkyl groups substituted with hydrophilic groups such as a sulfo group and a carboxyl group.

Preferred specific examples represented by Formula (SP-V) are shown below. However, the present invention is not limited to these examples.

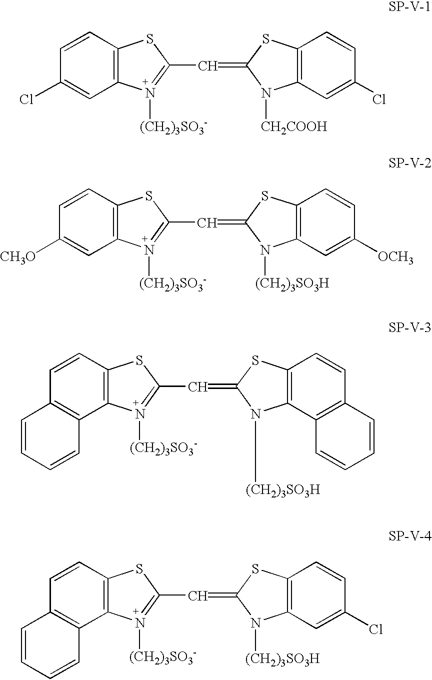

One of the features of this invention described in item 9 is to comprise sensitizing dyes represented by the aforementioned Formula (SP-VI).

In Formula (SP-VI), preferred as the heterocyclic group represented by Z₁ is a benzoxazole ring, and preferred as the heterocyclic group represented by Z₂ is a benzothiazole ring. Heterocyclic groups represented by Z₁ and Z₂ may be substituted, and preferred as substituents are a methyl group, a methoxy group, a phenyl group, and a chlorine atom. R₁ and R₂ are preferably straight or branched lower alkyl groups, and are more preferably lower alkyl groups substituted with hydrophilic groups such as a sulfo group and a carboxyl group.

Preferred specific examples represented by Formula (SP-VI) are shown below. However, the present invention is not limited to these examples.

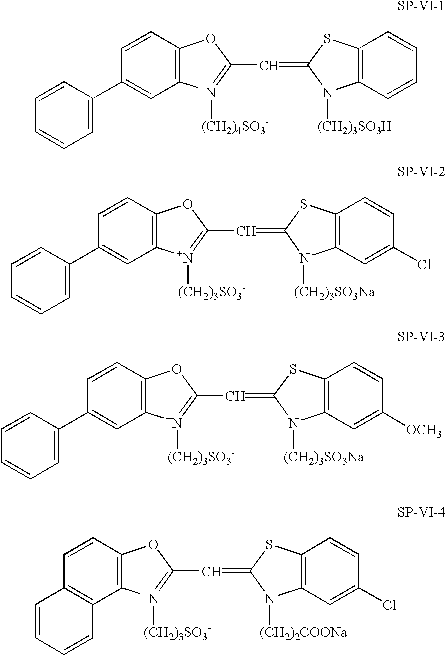

In the present invention, sensitizing dyes are not particularly limited, and compounds, known in the art, may be preferably employed.

Said sensitizing dyes may be added at any time from the formation of silver halide grains to the completion of chemical sensitization. Further, employed as methods for adding these dyes may be those in which dyes are dissolved in water or organic solvents such as methanol, ethanol, fluorinated alcohols, acetone, and dimethylformamide which are compatible with water and the resulting solution is added; dyes are dissolved in water-compatible solvents at a density of at least 1.0 g/ml and the resulting solution is added; dyes are emulsified and the resulting emulsion is added; or dyes are dispersed and the resulting dispersion is added.

Employed as method for dispersing said sensitizing dyes may be those in which dyes are mechanically pulvelizer-dispersed into minute particles at a size of no more than 1 μm into a water-based medium, employing a high speed stirring type homogenizer; in addition, as described in Japanese Patent Publication Open to Public Inspection No. 58-105141, dyes are mechanically pulverized into fine particles at a size of no more than 1 μm in a water-based medium under conditions of a pH of from 6 to 8 and a temperature of from 60 to 80° C.; dyes are dispersed in the presence of surface active agents which limit the increase in surface tension to no more than 3.8×10⁻² N/m, as described in Japanese Patent Publication No. 60-6496; and as described in Japanese Patent Publication Open to Public Inspection No. 50-80826, dyes are dissolved in acid which comprises substantially no water and of which pKa does not exceed 5, the resulting solution is added to and dispersed into a water based composition, and the resulting dispersion is added to a silver halide emulsion.

Water is preferred as the dispersion medium which is employed for dispersion. However, it is possible to adjust solubility by incorporating a small amount of organic solvents into media and to enhance the stability of the dispersion by adding hydrophilic colloid such as gelatin.

Listed as homogenizers which can be employed to prepare dispersion compositions may be, for example, ball mills, sand mills, and ultrasonic homogenizers, in addition to the high speed stirring type homogenizer described in FIG. 1 of Japanese Patent Publication Open to Public Inspection No. 4-125631.

Further, when any of these homogenizers is employed, a method may be used in which, as described in Japanese Patent Publication Open to Public Inspection No. 4-125632, pre-treatments such as dry type pulverization are previously carried out, and subsequently, wet type dispersion is carried out.

Sensitizing dyes may be incorporated individually or in combination of at least two types into the silver halide emulsion employed in the present invention.

Utilized as couplers employed in the silver halide light-sensitive material according to the present invention may be any compounds capable of forming coupling products having a maximum spectral absorption at 340 nm or a longer wavelength region upon a coupling reaction with oxidized color developing agents. Specifically, representative couplers include those which form yellow dyes having a maximum spectral absorption in the wavelength region of from 350 to 500 nm; those which form magenta dyes having a maximum spectral absorption in the wavelength region of from 500 to 600 nm; and those which form cyan dyes having a maximum spectral absorption in the wavelength region of from 600 to 750 nm.

One feature of the invention described in item 8 is that a magenta forming layer comprises magenta couplers represented by Formula (M).

In Formula (M), preferred as R₁ is an alkyl group, and most preferred as R₁ is a t-butyl group. Preferred as R₂ is an alkyl group. Preferred as R₃ through R₇ is a hydrogen atom. Preferred as L₁ and L₂ is an ethylene groups; preferred as J₁ are a carbonyl group, and a sulfonyl group; and preferred as J₂ are a carbonyloxy group, and a carbonylamino group. Preferred as X are a halogen atom, and especially a chlorine atom. Preferred as a nitrogen-containing heterocyclic group which is formed employing Z is a pyrazolotriazole ring.

Specific examples of preferred compounds represented by Formula (M) are shown below. However, the present invention is not limited to those examples.

Formula (M)

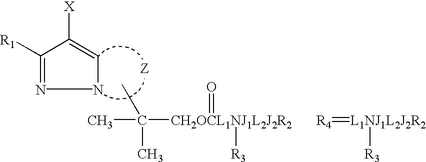

| Formula | X | R₄ |
|---|---|---|
| MC-1 | —Cl | —CH₂CH₂—NH—CO—CH₂CH₂—CO—O—C₁₈H₃₇ |
| MC-2 | —Cl | —(CH₂)₃—NH—CO—(CH₂)₁₀—O—CO—C₄H₉ |
| MC-3 | —Cl | —CH₂CH₂—NH—SO₂—(CH₂)₆—CO —C₈H₁₇ |
| MC-4 | —Cl | —CH₂CH₂—NH—CO—CH₂CH₂—CO—O—C₁₀H₂₁ |
| MC-5 | —Cl | 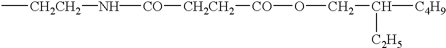 |

It is possible to synthesize compounds represented by Formula (M) according to the present invention with reference to the Journal of Chemical Society, Perkin I (1977), 2047 to 2052; U.S. Pat. No. 3,725,067; Japanese Patent Publication Open to Public Inspection Nos. 59-99437 and 58-42045.

Specifically, in the invention which does not specify the structures of magenta couplers, compounds, known in the art, other than magenta couplers, represented by the aforementioned Formula (M), may preferably be employed.

Said magenta couplers may be employed in combination with other types of magenta couplers generally in an amount ranging from 1×10⁻³ to 1 mole per mole of silver halide and preferably in an amount ranging from 1×10⁻² to 8×10⁻¹ mole.

The λmax of the spectral absorption of magenta images formed in the light-sensitive material according to the present invention is preferably from 530 to 560 nm, while λL0.2 is preferably from 580 to 635 nm. λL0.2, as described herein, refers to the wavelength at an absorbance of 0.2 which is longer than the wavelength at the maximum absorbance of 1.0 on the spectral absorption curve of magenta images.

Into the magenta image forming layer of the silver halide light-sensitive material according to the present invention, yellow couplers are preferably incorporated in addition to magenta couplers. The difference in pKa between these couplers is preferably within 2, and is more preferably within 1.5. Preferred yellow couplers, which are incorporated into the magenta forming layer of the present invention, are couplers represented by Formula [Y-1a] in the right column on page 12 of Japanese Patent Publication Open to Public Inspection No. 6-95283. Particularly preferred couplers represented by Formula [Y-1] of said patent, when combined with the magenta couplers represented by Formula [M-1], are those at a pKa which is not at least 3 lower and at least 3 higher than the pKa of combined couplers represented by Formula [M-1].

Specific examples of compounds as said yellow couplers, which may preferably be employed, are compounds Y-1 and Y-2 described on pages 12 and 13 of Japanese Patent Publication Open to Public Inspection No. 6-95283, and in addition, compounds (Y-1) through (Y-58) described on pages 13 through 17 of Japanese Patent Publication Open to Public Inspection No. 2-139542. However, the present invention is not limited to these compounds.

Employed as cyan couplers employed in the present invention may be phenol based, naphthol based, imidazole based, or azole based couplers known in the art. For example, representative couplers include phenol based couplers substituted with an alkyl group, an acylamino group, or a ureido group; naphthol based couplers formed utilizing a 5-aminonaphtol skeleton, two-equivalent type naphthol based couplers into which an oxygen atom is introduced as the leaving group. Of these, listed as preferred compounds are those represented by Formulas [C-1] and [C-2] described on page 13 of Japanese Patent Publication Open to Public Inspection No. 6-95283.

Said cyan couplers may be employed in a silver halide emulsion layer in an amount ranging generally from 1×10⁻³ to 1 mole per mole of silver halide, and preferably from 1×10⁻² to 8×10⁻¹.

One of the features of this invention described in item 12 is that a yellow forming layer comprises yellow couplers represented by the aforementioned Formula (Y); said yellow coupler-containing layer is the farthest color forming layer from the support; and the maximum yellow density (Dₘₐₓ) of said yellow forming layer is at least 1.5; and when said density is varied, the locus of the resulting absorption of a yellow forming coupler in the CIE LAB space passes through the interior of a sphere with diameter 10, having the center at L*=85, a*=−5, and b*=85.

In Formula (Y), R₁ is preferably an alkyl group and particularly a t-butyl group; R₂ is preferably a straight chain unsubstituted alkyl group and particularly a straight chain unsubstituted alkyl group, having at least 4 carbon atoms; preferred as groups represented by X are an alkyl group, a methoxy group, a decyloxy group, a dodecyloxy group; and preferred as the atom represented by Y is an chlorine atom.

Specific examples of preferred compounds represented by Formula (Y) are shown below. However, the present invention is not limited to those examples.

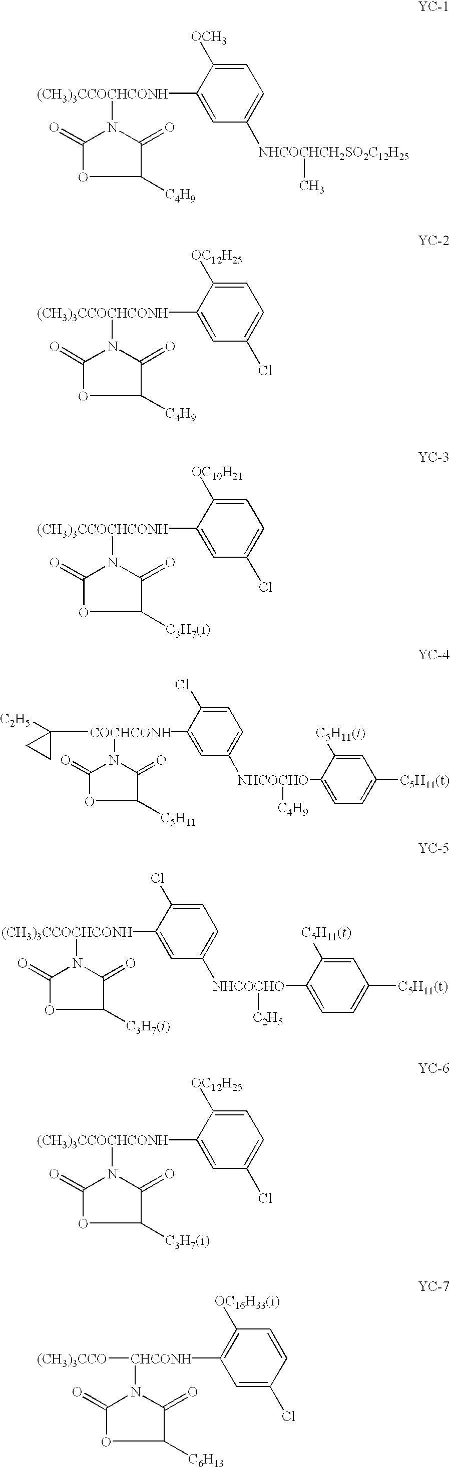

Specifically, in the invention which does not specify the structures of yellow couplers, acylacetoanilide based couplers, known in the art, other than yellow couplers, represented by the aforementioned Formula (Y), may preferably be employed.

The λmax of the spectral absorption of yellow images formed by employing the light-sensitive material according to the present invention is preferably at least 425 nm, while λL0.2 is preferably no more than 515 nm.

The λL0.2 of said yellow images, as described herein, is the value defined in lines 1 through 24 in the right column on page 21 of Japanese Patent Publication Open to Public Inspection No. 6-95283, and shows the magnitude of unnecessary absorption on the long wavelength side of the spectral absorption characteristics of yellow dye images.

Said yellow couples may be employed in a silver halide emulsion layer in an amount ranging generally from 1×10⁻³ to 1 mole per mole of silver halide, and preferably from 1×10⁻² to 8×10⁻¹ mole.

In order to adjust the spectral absorption characteristics of said magenta, cyan, and yellow images, preferably added are compounds exhibiting an image color control function. Compounds to achieve this purpose are preferably phosphoric acid ester based compounds, as well as phosphine oxide based compounds represented by Formula [HBS-I] described on page 22 of Japanese Patent Publication Open to Public Inspection No. 6-95283, and more preferably compounds represented by Formula [HBS-II] described on page 22 of the same. Further, listed may be higher alcohol based compounds represented by (a-i) through (a-x) described on page 5 of Japanese Patent Publication Open to Public Inspection No. 4-265975.

Light-sensitive materials according to the present invention comprise a support and silver emulsion layers are coated thereon in the form of a multilayer. However, the order of said emulsion layers is not limited. In addition to these layers, if desired, interlayers, filter layers and a protective layer may be disposed.

In order to minimize the fading of formed dye images due to light, heat, and moisture, anti-fading additives may be employed together with each of said magenta, cyan, and yellow couplers. Preferred compounds include phenyl ether based compounds represented by Formulas I and II described on page 3 of Japanese Patent Publication Open to Public Inspection No. 2-66541; phenol based compounds represented by Formula IIB described in Japanese Patent Publication Open to Public Inspection No. 3-174150; amine based compounds represented by Formula A described in Japanese Patent Publication Open to Public Inspection No. 64-90445; metal complexes represented by Formulas XII, XIII, XIV, and XV described in Japanese Patent Publication Open to Public Inspection No. 62-182741, which are particularly preferable for magenta dyes. Further, compounds represented by Formula I, described in Japanese Patent Publication Open to Public Inspection No. 1-196049 as well as compounds represented by Formula II described in Japanese Patent Publication Open to Public Inspection No. 5-11417 are preferable for yellow and cyan dyes.

When antistaining agents and other organic compounds, employed in silver halide light-sensitive materials according to the present invention, are added utilizing an oil-in-water droplet type dispersion method, said agents and compounds are commonly dissolved in water-insoluble high boiling point organic solvents exhibiting a boiling point of at least 150° C., if desired, together with a low boiling point and/or water-soluble organic solvents, and the resulting solution is emulsion-dispersed into hydrophilic binders such as an aqueous gelatin solution, utilizing surface active agents. Employed as dispersion means are stirrers, homogenizers, colloid mills, flow jet mixers, and ultrasound homogenizers. After dispersion or at the same time of dispersion, a process for removing low boiling point solvents may be arranged. Preferably employed as high boiling solvents which can be employed to dissolve and disperse said antistaining agents are phosphoric acid esters such as tricresyl phosphate, and trioctyl phosphate, and phophine oxides such as trioctylphosphine oxide. Further, at least two types of high boiling point organic solvents may be employed in combination.

One feature of the invention described in item 14 is to comprise at least one of the compounds selected from the aforementioned Formulas (III), (IV), and (V). These compounds are generally known as the fluorine based surface active agents.

Specific examples of compounds represented by Formulas (III) through (V) are shown below. However, the present invention is not limited to those examples. Incidentally, in the specific examples of compounds represented by Formula (V), (PFC′) represents a perfluotocyclohexylene group. The substitution position of (CF30) is as follows: the position of the carbonyl group is termed the 1-position, and the case of (CF₃O)₃ refers to the 3-, 4-, and 5-positions, the case of (CF₃O)₂ refers to the 3- and 4-positions, and the case of (CF₃O) refers to 4-position. 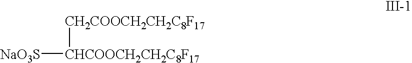 C₂F₅(CH₂)₆SO₃NH₄ III-2

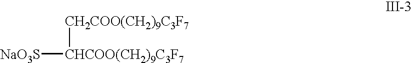

It is possible to synthesize compounds represented by Formula (III), employing common methods, and also possible to purchase those as commercially available products. It is possible to synthesize compounds represented by Formula (IV) with reference to Japanese Patent Publication Open to Public Inspection (under PCT application) Nos. 10-500950 and 11-504360. Further, it is possible to synthesize compounds represented by Formula (V) with reference to Japanese Patent Publication Open to Public Inspection No. 10-158218, and Japanese Patent Publication Open to Public Inspection (under PCT application) No. 2000-505803.

Specifically, in the invention which does not specify surface active agents, in addition to these, it is possible to preferably employ surface active agents known in the art. Listed as preferable compounds as the surface active agents are those which comprise a hydrophobic group having from 8 to 30 carbon atoms and a sulfonic acid or salts thereof in one molecule. Specifically, listed are A-1 through A-1 described in Japanese Patent Publication Open to Public Inspection No. 64-26854. These dispersions are generally added to coating compositions comprising a silver halide emulsion. In that case, the time from the dispersion to the addition to the coating composition and the time from the addition to the coating composition to the coating are preferably shortened. Each time is preferably within 10 hours, is more preferably within 3 hours, and is still more preferably within 20 minutes.

To minimize color contamination, compounds, which react with oxidized developing agents are preferably incorporated into the layer between Light-Sensitive layers of silver halide light-sensitive materials according to the present invention or said compounds are preferably incorporated into the silver halide emulsion layers to reduce fogging. Compounds for this purpose are preferably hydroquinone derivatives, and are more preferably dilakylhydroquinones such as 2,5-di-t-octylhydroquinone. Listed as particularly preferable compounds are those represented by Formula II described in Japanese Patent Publication Open to Public Inspection No. 4-133056, as well as compounds II-1 to II-14 described on pages 13 and 14 of said patent, and compound 1 described on page 17 of said patent.

UV absorbers are preferably incorporated into the light-sensitive materials according to the present invention to minimize static fog, as well as to improve the light fastness of dye images. Listed as preferable UV absorbers are benzotriazoles. Listed as particularly preferable compounds are those represented by Formula III described in Japanese Patent Publication Open to Public Inspection No.64-66646, UV-1L through UV-27L described in Japanese Patent Publication Open to Public Inspection No. 63-187240, compounds represented by Formula I described in Japanese Patent Publication Open to Public Inspection No. 4-1633, and compounds represented by Formulas (I) and (II) described in Japanese Patent Publication Open to Public Inspection No. 5-165144.

Oil-soluble dyes and pigments are preferably incorporated into light-sensitive materials according to the present invention to improve background whiteness. Listed as specific representative examples are compounds 1 through 27 described on pages 8 and 9 of Japanese Patent Publication Open to Public Inspection No. 2-842.

Gelatin is advantageously employed as the binders in the silver halide light-sensitive materials according to the present invention. If desired, however, employed may be other gelatin, gelatin derivatives, graft copolymers of gelatin with other polymers, proteins other than gelatin, sugar derivatives, cellulose derivatives, hydrophilic colloid of synthesized hydrophilic polymers such as homopolymers and copolymers.

Vinylsulfone type hardeners and chlorotriazine type hardeners are preferably employed individually or in combination as hardeners of these binders. Compounds, described in Japanese Patent Publication Open to Public Inspection Nos. 61-249054 and 61-245153, are preferably employed. Further, in order to hinder the growth of mildew and bacteria which adversely affect photographic performance as well as image retaining properties, antiseptics and mildewcides, as described in Japanese Patent Publication Open to Public Inspection No. 3-157646, are preferably incorporated into colloidal layers. Further, in order to improve physical properties of the surface of light-sensitive materials or processed samples, slipping agents and matting agents, described in Japanese Patent Publication Open to Public Inspection Nos. 6-118543 and 2-73250, are preferably incorporated into protective layers.

One of the features of this invention described in item 7 is that the transmission density of the unexposed part of processed light-sensitive materials is from 0.5 to 1.2.

The feature of the invention described in item 10 is a white support having a thickness of from 80 to 150 μm, a spectral reflection density, in the wavelength region of from 450 to 700 nm, of no more than 0.06, and a spectral reflection density difference ΔD (the maximum density−the minimum density), in the wavelength region of from 450 to 600 nm, of no more than 0.01. Another feature is that opacity after photographic processing, specified by JIS P 8138, is at least 90 percent. By so doing, when samples, which have been subjected to photographic processing, are observed, drawbacks are overcome in which the resulting images do not results in sufficient gradation.

Further, when supports are not particularly specified, supports employed in the light-sensitive materials according to the present invention may be comprised of any of several materials. It is possible to employ paper laminated with polyethylene or polyethylene terephthalate, paper supports comprised of natural pulp or synthesized pulp, vinyl chloride sheets, polypropylene or polyethylene terephthalate supports which may contain white pigments and baryta paper. Of these, preferred are supports comprising a base paper having thereon a water resistant resin coated layer on both sides. Preferred as water resistant resins are polyethylene and polyethylene terephthalate, or copolymers thereof.

Employed as supports comprising paper, having thereon a water resistant resin coated layer, are surface smoothed supports commonly at a weight of from 50 to 300 g/m². For the purpose of obtaining proof images, in order to approach a sense of handling to that of printing paper, base paper at a weight of no more than 130 g/m² is preferably employed, and said base paper at a weight of from 70 to 120 g/m² is more preferably employed. In the light-sensitive material described in claim 7, it is possible to vary the transmission density of the unexposed area after photographic processing by adjusting the thickness of the support itself or the amount of white pigments described below. However, obtaining a density of 1.2 or higher becomes disadvantageous from the viewpoint of cost.

Preferably employed as supports used in the present invention may be those having either a randomly irregular surface or a smoothened surface.

Employed as white pigments used in said supports may be white inorganic and/or white organic pigments. White inorganic white pigments are preferably employed. For example, listed are alkaline earth metal sulfates such as barium sulfate, alkaline earth metal carbonates such as calcium carbonate, fine silicic acid powder, silicas such as synthetic silicates, calcium silicate, alumina, alumina hydrate, titanium oxide, zinc oxide, talc, and clay. White pigments are preferably barium sulfate and titanium oxide.

For the enhancement of sharpness, the content ratio of white pigments in the water resistant resinous layer on the support surface is preferably at least 13 percent by weight, and is more preferably at least 15 percent by weight.

It is possible to determine the degree of dispersion of white pigments in the water resistant resinous layer of the paper support according to the present invention by employing the method described in Japanese Patent Publication Open to Public Inspection No. 2-28640. When determined employing said method, the degree of dispersion of said white pigments is no more than 0.20 in terms of the variation coefficient described in the aforementioned patent publication, and is more preferably no more than 0.15.

The resinous layer of the paper support having a water resistant resinous layer on both sides, employed in the present invention, may be comprised of either one layer or a plurality of layers. It is preferable that a plurality of said layers is utilized and said white pigments are incorporated into the layer adjacent to the emulsion layer at a higher concentration than the other layer(s), so as to achieve marked improvement of sharpness for forming proof images.

Further, the value of central surface average roughness (SRa) is preferably no more than 0.15 μm, and is more preferably no more than 0.12 am, since effects are obtained which result in excellent glossiness.

In the Light-Sensitive photographic materials employed in the present invention, if desired, the surface of the support is subjected to corona discharge, UV radiation, or a flame treatment, and subsequently, coating may be carried out directly or via a sublayer (at least one sublayer for the improvement of the adhesion properties of the support surface, antistatic properties, dimensional stability, friction resistance, hardness, halation minimizing properties, friction characteristics and/or other characteristics).

In order to enhance coating properties, thickening agents may be employed during the coating of Light-Sensitive photographic materials employing silver halide emulsions. Extrusion coating and curtain coating, which make it possible to simultaneously coat at least two layers, are particularly useful as the coating methods.

In an invention in which exposure sources are not particularly specified, it is possible to preferably employ any of exposure sources of exposure devices, known in the art. However, lasers or light emitting diodes (hereinafter referred to as LED) are more preferably employed.

Preferably employed as lasers are semiconductor lasers (hereinafter referred to as LD) due to their small size as well as the long life of the light source. LD is applied to DVD, optical pickups of musical CD, and bar-code scanners for the POS system, and also to optical communication. Said LD exhibits advantages capable of being less expensive and of resulting in relatively high output. Listed as specific examples of LD may include aluminum-gallium-indium-arsine (650 nm), indium-gallium-phosphorus (longer than 700 nm), gallium-arsine-phosphorus (from 610 to 900 nm), and gallium-aluminum-arsine (from 760 to 850 nm). Recently, though lasers emitting blue light have been developed, it is advantageous to utilize LD as the light source having a wavelength of no shorter than 610 nm.

Laser beam sources, comprising SHG elements, shorten the wavelength of beams emitted from LD and YAG lasers to one half and emits the resulting beam. Therefore, since it is possible to obtain visible light, those are employed as the light source in the region of green to blue in which suitable light sources are unavailable. Listed as examples of such types of light source are those (532 nm) obtained by combining said YAG laser with said SHG element.

Listed as gas lasers are a helium-cadmium laser (about 442 nm), an argon ion laser (about 514 nm), and a helium-neon laser (about 544 nm and 633 nm).

Known as LED are those having the same composition as LD, and various types ranging from blue to infrared are put into practical use.

As exposure light sources employed in the present invention, lasers may be used individually or in combination as a multi-beam. One of the features of the invention described in item 9 is to employ an exposure section in which a plurality of light sources, being modulated utilizing different signals, is arranged in the secondary scanning direction. In the case of LD, by arranging 10 LDs, it is possible to obtain a beam comprised of 10-luminous flux. On the other hand, in the case of the helium-neon laser, the beam emitted from the laser is divided into, for example, 10-luminous flux, employing a beam separator. By so ding, it is possible to preferably write an image for 10 scanning lines at the same time. However, when such light sources are employed, problems occur in which density unevenness tends to result due to the stability of latent images immediately after exposure.

In the case of LD, and LED, it is possible to vary the intensity of the exposure light source by carrying out direct modulation in which the value of electric current, which flows through each element, is varied. In the case of LD, said intensity may be varied employing elements such as AOM (an acoustic optical modulator). In the case of gas lasers, it is common that devices such as AOM, and EOM (electric optical modulator) are employed.

One of the features of this invention described in item 15 is that a silver halide light-sensitive material, comprising a silver halide emulsion layer, is subjected to exposure with light output which is less than that necessary for forming an image, utilizing a plurality of elements. The surface of said light-sensitive material may be exposed employing a reduction optical system having an exposure head in which said LED is arranged and an optical lens. The use of a plurality of exposure elements results in advantages such that fluctuation in characteristics of elements are averaged and it is possible utilize elements at small output. On the other hand, specifically, when light-sensitive materials comprised of negative-working silver halide emulsions, having a silver chloride content ratio of as least 95 percent, are exposed after storage, it has been discovered that problems occur in which by continuous image output, the resulting density is not uniform, but varies.

In the present invention, the term area modulation image is used. Said term does not refer to the low or high density of an image in terms of low or high density of the color of each pixel, but refers to the small or large area in which the specified density of color is formed. Accordingly, it may be considered that said term refers to halftone dots.

When common area modulation exposure is employed, it is possible to achieve the desired purposes by forming Y, M, C, and black color. In order to identify the formation of each color such as M, C, in addition to black, it is preferable that exposure be carried out while separately using the exposure amount of at least three values. In printing, special color prints are occasionally employed. However, in order to reproduce this, it is preferable that exposure be carried out while separately using the exposure amount of at least 4 values.

One of the features of this invention described in item 18 is that exposure is carried out employing an exposure amount obtained from the relationship between the exposure amount and the color density, in which the previously determined relationship has been corrected utilizing the relationship of two optional points of the employed silver halide light-sensitive material.

If specifically described, a silver halide digital color proof system stores exposure amounts to obtain required density as data, and then determines the exposure amount based on said data. Practically, however, due to fluctuation in performance depending on batch to batch production, variation of performance due to the running state of processing solutions, previously stored data do not occasionally match the performance of the silver halide light-sensitive materials employed in practice. Then, said system is subjected to exposure, utilizing the previously known exposure amount. Employing data of formed color density, the previously determined exposure amount-formed color density relationship is replaced with a new one. As a result, it is possible to reflect the characteristics of practically employed silver halide light-sensitive material. This method is preferred since it is possible to more correctly reflect the characteristics of said silver halide light-sensitive material. However, it is necessary to collect a large amount of data. The present invention is that this is carried out in such a manner that correction is performed utilizing two randomly selected points of said exposure-formed color density relationship. Due to this, by utilizing a simple operation, it is possible to achieve the precise reproduction of density as well as color.

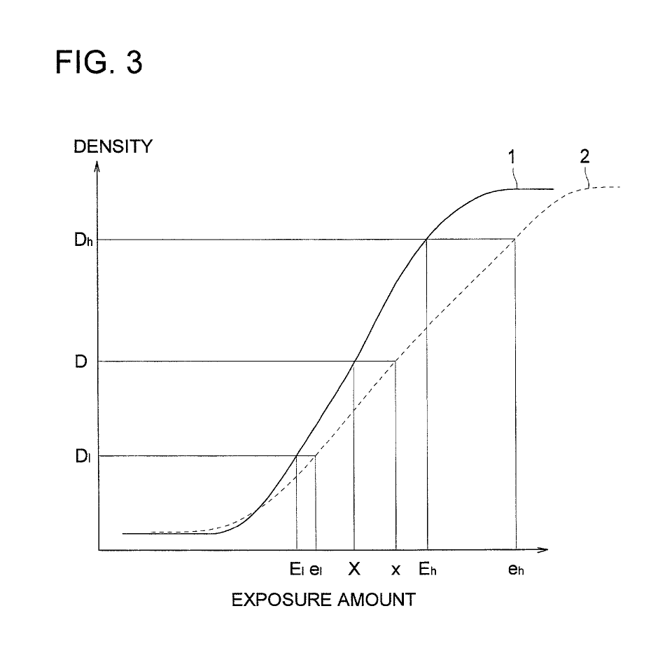

The above will be briefly described with reference to FIG. 3. FIG. 3 illustrates characteristic curves in which the ordinate shows the optical density while the abscissa shows the exposure amount.

Numeral 1 shows a characteristic curve of a light-sensitive material used as the standard. Said characteristic curve is obtained as follows: said light-sensitive material is subjected to exposure at a plurality of exposure levels and subsequently is subjected to photographic processing, and said characteristic curve is drawn utilizing the obtained density and the corresponding exposure amount. The higher the number of exposure levels is, the better. However, taking into account the data acquiring procedure and the complexity of the following procedure, the number of levels to obtain data is generally from 10 to 50, and is more preferably from 15 to 25. Commonly, said data are employed in the form of a table comprising a pair of numerals at one to one correspondence.

(Exposure Amount) H1 H2 H3 . . . Hn

(Density) D1 D2 D3 . . . Dn

Numeral 2 is a characteristic curve showing the characteristics of the light-sensitive material of which performance falls beyond the standard due to various factors.

Dh represents the density value which becomes the standard on the high density side and varies depending on color and the shape of the characteristic curve. However, the density near the upper limit of the straight line portion of the characteristic curve is preferably used, and as a density value, the numerical value of from 1.0 to 2.2 is preferably employed.

Dl represents the density value which becomes the standard on the low density side and varies depending on color and the shape of the characteristic curve. However, the density near the lower limit of the straight line portion of the characteristic curve is preferably used, and as said density value, the numerical value of from 0.1 to 0.5 is preferably employed.

Eh represents the necessary exposure amount to obtain density Dh in the light-sensitive material used as the standard.

E1 represents the necessary exposure amount to obtain density D1 in the light-sensitive material used as the standard.

X represents the necessary exposure amount to obtain density D in the light-sensitive material used as the standard.

eh represents the necessary exposure to obtain density Dh in the light-sensitive material of which performance falls beyond the standard.

e1 represents the necessary exposure to obtain density D1 in the light-sensitive material of which performance falls beyond out of the standard.

x represents the necessary exposure amount to obtain density D in the light-sensitive material of which performance falls beyond the standard.

The specific description of one of the features of this invention described in the aforementioned item 18 is specifically described in such a manner that a table showing the previously obtained characteristics of the standard light-sensitive material is corrected based on two optional points of the exposure, versus the formed color density relationship. A plurality of specific steps is considered. Herein, however, a simple method will be described.

It is assumed that the light-sensitive material, of which performance falls beyond the standard, is subjected to exposure employing the previously determined exposure amounts eh and e1 and subsequently is subjected to photographic processing, whereby densities Dh and D1 are obtained. Then, it is possible to obtain the necessary exposure amounts based on said table. Namely, Eh and E1 become known values. When the exposure amount is controlled so that the resulting densities Dh and D1 are positioned not markedly beyond the straight line portion of the characteristic curve, based on the proportional relationship, it is expected that the following formula is held.

(Eh−E1)/(eh−e1)=(X−E1)/(x−e1)

When this formula is solved for x, the following formula is obtained.

x=(eh−e1)×(X−E1)/(Eh−E1)+e1

Herein, hi through hn, which are obtained by successively substituting H1 through Hn in said table for X of said formula correspond to necessary exposure amounts to obtain densities D1 through Dn of said light-sensitive material of which performance is beyond the standard. By so doing, said table for the standard light-sensitive material is to be revised for the light-sensitive material of which performance is beyond the standard.

(Exposure Amount) h1 h2 h3 . . . hn

(Density) D1 D2 D3 . . . Dn

By utilizing said table, it is possible to suitably determine the exposure amount which results in optional density.

The non-linearity of the characteristic curve may be approximated utilizing either an equation of the first degree or a polynomial expression. Further, it is also possible to approximate the characteristic curve while dividing it into a plurality of parts. These are included in one of the embodiments of the present invention.

The exposure amount is commonly expressed utilizing common logarithms, and may be expressed utilizing natural logarithms. It may also be expressed utilizing the amount itself (antilogarithms). In order to enhance approximation accuracy, it is preferably expressed utilizing logarithms.

When a laser beam source is employed, the diameter of the beam is preferably no more than 25 μm, and is more preferably from 6 to 22 μm. When said beam diameter is no more than 6 μm, preferable image quality is obtained, while resulting in difficult adjustment, a decrease in processing speed. On the other hand, when said beam diameter is at least 25 μm, unevenness is enhanced and image sharpness is degraded. By optimizing said beam diameter, it is possible to write highly fine images without unevenness at a high speed.

One of the features of this invention, described in items 3, 7, and 13, is that a silver halide light-sensitive material is wound onto a rotating drum and is subjected to exposure. This means, for example, a cylinder exterior surface scanning system in which a light-sensitive material is wound onto a cylindrical drum, and during high speed rotation of said drum, a light flux is orthogonally to the rotation direction.

In an invention in which scanning systems are not particularly specified, it is also possible to employ a cylinder interior surface scanning system in which a silver halide light-sensitive material is brought into contact with a cylindrical indentation and is then subjected to exposure. It may employ a plane scanning system in which a moving silver halide light-sensitive material is subjected to exposure by moving a light flux orthogonal to the conveying direction of said silver halide light-sensitive material, while rotating a polygonal mirror at high speed. In order to obtain high image quality as well as large images, said exterior cylindrical surface scanning system is more preferably employed.

In order to carry out exposure employing said exterior cylindrical surface scanning system, said silver halide light-sensitive material should be accurately brought into close contact with said cylindrical drum. In order to appropriately carry out the foregoing, it is necessary that said silver halide light-sensitive material be subjected to accurate registration and then conveyed. The silver halide light-sensitive material, employed in the present invention, is more preferably employed when the exposed surface of said silver halide light-sensitive material is wound to be on the exterior side, because it is possible to more suitably carry out registration. From the same viewpoint, supports of silver halide light-sensitive material, employed in the present invention, exhibit appropriate stiffness and preferably have a Taper stiffness of from 0.8 to 4.0.

It is possible to optionally determine the drum diameter while matching the size of silver halide light-sensitive materials to be exposed. It is also possible to optionally set the rotation frequency of said drum. However, it is possible to select the appropriate rotation frequency depending on the diameter of the laser beam, energy intensity, writing patterns, or the sensitivity of light-sensitive materials. From the viewpoint of productivity, it is preferable to be able to carry out scanning exposure at a high speed of rotation. Specifically, 200 to 3,000 rotations per minute are preferably employed.

Methods to fix said silver halide light-sensitive material onto said drum are as follows: said material may be fixed utilizing mechanical means, and a number of tiny holes capable of sucking said light-sensitive material are formed on the drum surface depending on the size of said light-sensitive material and said light-sensitive material comes into close contact with said drum while being sucked. In order to minimize problems such as uneven images, it is essential that said light-sensitive material comes into contact with said drum as close as possible.

One of the features of this invention described in item 7 is that the reflection density of the surface of said drum is from 0.7 to 3.5, and the transmission density of the unexposed part of said negative-working silver halide Light-Sensitive photographic material, which has been subjected to photographic processing, is from 0.5 to 1.2. It is therefore possible to minimize uneven images due to the reflection light from said drum. It is also possible to adjust the reflection density of the drum surface, employing surface paining, or plating. However, it is technically difficult to exceed 3.5.

One of the features of this invention described in item 4 is that it is possible to separately store information regarding said silver halide light-sensitive material in a part of the packaging material of said silver halide light-sensitive material, and said information is stored in the form of re-adhesion. The packaging material as described herein refers to members which shield light-sensitive materials, and protect the same from pressure as well as shock, accompanied printing, and adhered labels. Heretofore, sensitivity information has been recorded on one part of the packaging materials of light-sensitive materials, or information recorded paper strips have been packaged together with light-sensitive materials. However, when light-sensitive materials are not subjected to suitable treatment during their replacement, problems have occurred in which in many cases, it is impossible to take effective action due to the disposal of packaging materials, the state in which it is impossible to discriminate information from the formation of other light-sensitive materials. When sensitivity information is not effectively utilized for exposure, it becomes very difficult to obtain consistent reproduction required for the digital color proofs.

One of the features of this invention described in item 17 is that a color developer comprises developing agents represented by Formula (IV) in an amount of at least 55 mole percent of all developing agents.

Either R₁ or R₂ in Formula (IV) preferably has a water-solubilizing group. It is particularly preferable that R₁ represents an unsubstituted alkyl group, and R₂ represents a hydroxylalkyl group.

Preferred specific examples of compounds represented by Formula (IV) are shown below. However, the present invention is not limited to these examples.

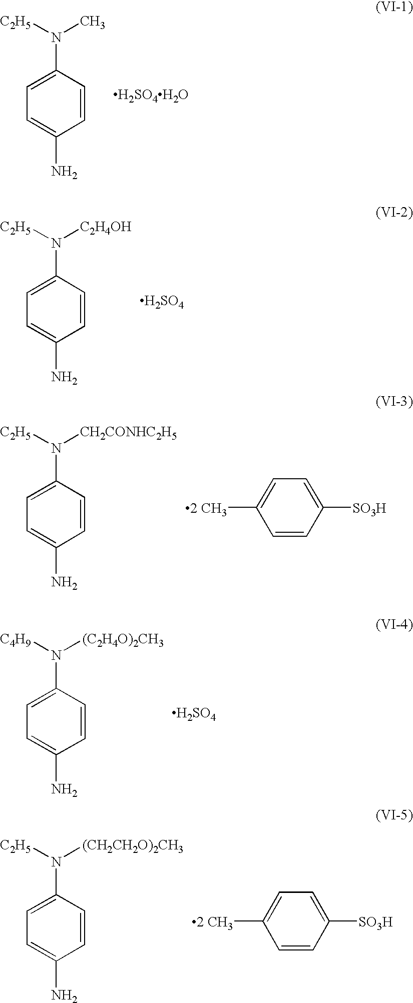

One of the features of this invention described in item 17 is that at least one of nitrogen-containing heterocyclic ring compounds is incorporated into a starter. Listed as preferable nitrogen-containing heterocyclic ring compounds may be those having a benzimidazole ring, a benzotriazole ring, a tetrazole ring, or a tetraazaindene ring, a purine ring. These compounds may also have a mercapto group. The added amount of nitrogen-containing heterocyclic ring compounds to said color developer is generally from 1×10⁻⁷ to 1×10⁻⁴ mole per liter of the color developer, and is preferably in the range of from 5×10⁻⁷ to 5×10⁻⁵ mole per liter.

In an invention which does not specify developing agents, it is possible to preferably employ various compounds known in the art. Listed as examples of said compounds may be those described below:

CD-1) 2-amino-5-diethylaminotoluene

CD-2) 2-methyl-4-[N-ethyl-N-(β-hydroxyethyl)amino]aniline

CD-3) 4-amino-3-methyl-N-ethyl-N-[β-(methanesulfonamido)ethyl]-aniline

CD-4) 4-amino-3-methyl-N-ethyl-N-methoxyethylaniline

CD-5) 4-amino-3-methyl-N-ethyl-N-(β-ethoxyethyl)aniline

CD-6) 4-amino-3-methyl-N-ethyl-N-(γ-hydroxypropyl) aniline

In the present invention, it is possible to employ said compounds in color developers in the optional pH range. However, from the viewpoint of quick processing, the pH is preferably from 9.5 to 13.0, and is more preferably from 9.8 to 12.0.

The processing temperature of the color development according to the present invention is preferably from 35 to 70° C. As the temperature increases, the processing time is preferably shortened. However, from the viewpoint of the stability of processing solutions, the temperature is preferably not too high, and processing is preferably carried out in the range of from 37 to 60° C.

Color development time has commonly been about 3 minutes 30 seconds. However, in the present invention, said color development time is preferably in the range of no more than 40 seconds, and is more preferably in the range of no more than 25 seconds.

In addition to said color developing agents, it is possible to add known developer constituting compounds into said color developers. Commonly employed are alkalis having a buffering action, development retarders such as chloride ions, or benzotriazole, preserving agents, and chelating agents.

One of the features of this invention described in item 16 is that the content ratio of optical brightening agents and chelating agents incorporated into a stabilizer of the final process is no more than 50 percent of that of said optical brightening agents and said chelating agents incorporated into the stabilizer in the first tank. Another feature is that a replenisher, at a concentration which is two times higher than the initial concentration of said optical brightening agents and chelating agents contained in the final processing tank, is added only to the final processing tank. In a system in which replenishment is carried out to replenish the consumed solution during photographic processing, it is frequently noted that the performance during processing deviates from the initial. By employing said method, it becomes possible to obtain consistent white background while the variation of said white background is minimized.

In the present invention, silver halide light-sensitive materials are subjected to color development, and subsequently are subjected to bleach and fixing processes. Said bleach process may be carried out at the same time as said fixing process. After said fixing process, water washing is commonly carried out. Further, instead of water washing, a stabilization process may be employed. Employed as photographic processors for the photographic processing of silver halide light-sensitive materials of the present invention may be a roller transport type in which said light-sensitive material is introduced between rollers arranged in a processing tank and is conveyed, or an endless belt system in which said light-sensitive material is fixed on a belt and conveyed. Further, it is possible to employ a system in which a processing tank is formed in the slit shape, and a processing solution is supplied to said processing tank while conveying said light-sensitive material, a spray system in which processing solutions are sprayed onto said light-sensitive materials, a web system in which said light-sensitive material comes to contact with a support impregnated with a processing solution, a system utilizing viscous processing solutions.

When a large amount of light-sensitive materials is to be processed, it is common that said light-sensitive materials are subjected to a running process, employing an automatic processor. One of the features of this invention described in claim 5 is that a developer replenisher is replenished in accordance with the image area as well as the amount of processed light-sensitive material. Another feature of the present invention is that in the area modulation image forming method, said image area is obtained through communicated information between an output device and the front side of said output device, and the boundary between the image area and the non-image area is displayed utilizing a line. Said line, as described herein, may be a straight line or a curved line, and a broken line or an alternate long and short dashed line so as to readily discriminate the image from the non-image areas. Further, it is preferable that the replenishment rate of said developer is not markedly affected.

European Patent Publication Open to Public Inspection No. 0500278, Japanese Patent Publication Open to Public Inspection No. 8-304986, and others, disclose methods in which the amount of developed silver is calculated utilizing exposure amount data in the pixel unit of digital data of images, and a replenishment rate is determined. However, said methods are not practical because it takes a long time for the calculation to satisfy the degree of fine accuracy (2,400 dpi, that is 2,400 dots per inch) required for printed matter. In addition, since only a part due to the developed silver amount is noted, sufficient effects have not been obtained.

From the viewpoint of ease of handling as well as the adaptability for environmental protection, the lower the amount of replenisher is, the better. The method described in Kokai Giho (Technical Disclosure) 94-16935 is most preferred.

One of the features of this invention described in item 16 is that processing is carried out employing an automatic processor having at least three stabilization processing tanks utilizing a cascaded counter-current system, in which at least one tank, besides the first thank and the final tank of said stabilization processing tanks, is provided with a heating means. Silver halide light-sensitive materials have on the surface a medium such as gelatin having a high refractive index. As a result, the highlight areas inherently become dark. However, the method of the present invention makes it possible to maintain the high lightness of the white background.

### EXAMPLES

The present invention will now be detailed employing examples, described below. However, the embodiments of the present invention are not limited to these examples.

### Example 1

Applied onto the surface of a titanium oxide containing layer of a 115 g/m² weight reflective support (having a Taper stiffness of 3.6, a PY value of 2.7 μm, and a paper base weight of 85 g/m²) comprised of polyethylene laminated paper, prepared by laminating one side with high density polyethylene and the other side with melt polyethylene comprising dispersed anatase type titanium oxide in an amount of 15 percent by weight, was each layer of the layer configurations shown in Tables 1 and 2 below. Further, the back surface of said support was coated with 6.00 g/m² of gelatin and 0.65 g/m² of a silica matting agent. Thus, Multilayer Silver Halide Light-Sensitive Material Sample No. 101 was prepared.

Each of the couplers was dissolved in high boiling point solvents, subsequently subjected to ultrasonic dispersion, and added as the dispersion. At that time, (SU-1) was employed as the surface active agent. In addition, (H-1) as well as (H-2) was added as hardeners. Surface active agents (SU-2) and (SU-3) were added as the coating aid, and the surface tension was adjusted. Further, (F-1) was added to each layer so that the total amount reached 0.04 g/m².

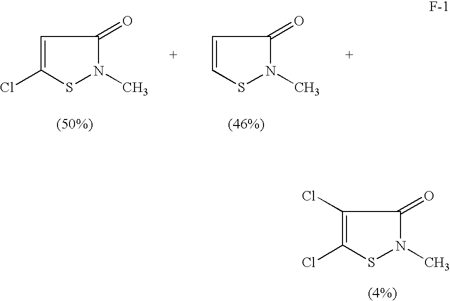

TABLE 1

| | | Added |
|---|---|---|
| | | Amount |
| Layer | Constitution | (in g/m²) |
| Eighth Layer | gelatin | 1.20 |
| (UV Absorbing | UV absorber (UV-3) | 0.20 |
| Layer) | silica matting agent | 0.01 |
| Seventh Layer | gelatin | 1.20 |
| (Blue | blue sensitive silver halide | 0.35 |
| Sensitive | emulsion | |
| Layer) | yellow coupler (YC-2) | 0.51 |
| | yellow coupler (Y-2) | 0.13 |
| | antistaining agent (HQ-1) | 0.02 |
| | high-boiling point organic | 0.51 |
| | solvent (SO-1) | |
| Sixth Layer | gelatin | 1.50 |
| (Interlayer) | antistaining agent | 0.45 |
| | (HQ-2, 3: equal weight) | |
| | high-boiling point organic | 0.15 |
| | solvent (SO-2) | |
| | PVP | 0.03 |
| | antirradiation dye (AI-1) | 0.03 |
| Fifth Layer | gelatin | 1.60 |
| (Green | green sensitive silver halide | 0.30 |
| Sensitive | emulsion | |
| Layer) | cyan coupler (C-1) | 0.35 |
| | high-boiling point organic | 0.45 |
| | solvent (SO-4) | |
| | high-boiling point organic | 0.45 |
| | solvent (SO-5) | |
| Fourth Layer | gelatin | 1.00 |
| (Interlayer) | antistaining agent | 0.30 |
| | (HQ-2, 3: equal weight) | |
| | high-boiling point organic solvent | 0.10 |
| | (SO-2) | |
| | antirradiation dye (AI-2) | 0.03 |
| Third Layer | gelatin | 1.20 |
| (Red | red sensitive silver halide emulsion | 0.40 |
| Sensitive | magenta coupler (MC-4) | 0.50 |
| Layer | yellow coupler (Y-2) | 0.09 |
| | antistaining agent (HQ-1) | 0.01 |
| | high-boiling point organic | 0.27 |
| | solvent (SO-1) | |
| | high-boiling point organic | 0.50 |
| | solvent (SO-3) | |

TABLE 2

| | | Added |
|---|---|---|
| | | Amount |
| Layer | Constitution | (in g/m²) |
| Second Layer | gelatin | 0.50 |
| (Interlayer) | antistaining agent (HQ-2, 3: | 0.02 |
| | equalweight) | |
| | antirradiation dye (AI-3) | 0.40 |
| First Layer | gelatin | 0.70 |
| (Colored | black colloidal silver antihalation | 0.05 |
| Layer) | dye (AI-4) | |
| | titanium dioxide (average primary | 0.05 |
| | particle diameter of 0.25 μm) | |
| | styrene/n-butyl methacrylate/sodium | 0.5 |
| | 2-sulfoethyl methacrylate | 0.35 |
| Support | polyethylene laminated paper (containing a | |
| | minute amount of colorants) | |

SU-1: sodium tri-i-propylnaphthalenesulfonate

SU-2: sodium di(2-ethylhexyl)sulfosuccinate

SU-3: sodium di(2,2,3,3,4,4,5,5-octafluoropentyl)sulfosuccinate

H-1: tetrakis(vinylsulfonylmethyl)methane

H-2: 2,4-dichloro-6-hydroxy-s-triazine Sodium

HQ-1: 2,5-di-t-octylhhydroquinone

HQ-2: 2,5-di[(1,1-dimethyl-4-hexyloxycarbonyl)butyl]hydroquinone

HQ-3: mixture of 2,5-di-sec-docecylhydroquinone, 2,5-di-sec-tetradecylhydroquinone, and 2-sec-docecyl-5-sec-tetradecylhydroquinone at a weight ratio of 1:1:2

SO-1: trioctylphosphine oxide

SO-2: di(i-decyl)phthalate

SO-3: oleyl alcohol

SO-4: tricresyl phosphate

PVP: polyvinylpyrrolidone

(Preparation of a Blue Sensitive Silver Halide Emulsion)

Added to 1 liter of 2 percent aqueous gelatin solution were (Solution A) and (Solution B), described below, employing a double-jet method while controlling the pAg at 7.3 and the pH at 3.0, and subsequently, added to the resulting mixture were (Solution C) and (Solution D), also described below, employing a double-jet method while controlling the pAg at 8.0 and the pH at 5.5. At the same time, the pAg was controlled employing a method described in Japanese Patent Publication Open to Public Inspection No. 59-45437, and the pH was controlled employing sulfuric acid or an aqueous sodium hydroxide solution.

| (Solution A) | | |
|---|---|---|
| Sodium chloride | 3.42 | g |
| Potassium bromide | 0.03 | g |
| Water to make | 200 | ml |
| (Solution B) | | |
| Silver nitrate | 10 | g |
| Water to make | 200 | ml |
| (Solution C) | | |
| Sodium chloride | 102.7 | g |
| Potassium hexachloroiridate (IV) | 4 × 10⁻⁸ | mole |
| Potassium hexacyanoferrate (II) | 2 × 10⁻⁵ | mole |
| Potassium bromide | 1.0 | g |
| Water to make | 600 | ml |
| (Solution D) | | |
| Silver nitrate | 300 | g |
| Water to make | 600 | ml |

After the completion of said addition, the resulting mixture was subjected to desalting employing a 5 percent aqueous solution of Demol N, manufactured by Kao-Atlas Co., and a 20 percent aqueous magnesium sulfate solution. Thereafter, the desalted composition was mixed with an aqueous gelatin solution whereby monodispersed cubic grain emulsion EMP-101 at an average grain diameter of 0.71 μm, a variation coefficient of grain diameter distribution of 0.07, and a silver chloride content ratio of 99.5 mole percent was prepared.

Said (EMP-101) underwent optimal chemical sensitization at 60° C., employing compounds described below, whereby Blue Sensitive Silver Halide Emulsion (EM-B101) was prepared.

| | | | |
|---|---|---|---|
| Sodium thiosulfate | | 0.8 | mg/mole of AgX |
| Chloroauric acid | | 0.5 | mg/mole of AgX |
| Stabilizer | STAB-1 | 3 × 10⁻⁴ | mol/mole of AgX |
| Stabilizer | STAB-2 | 3 × 10⁻⁴ | mol/mole of AgX |
| Stabilizer | STAB-3 | 3 × 10⁻⁴ | mol/mole of AgX |
| Sensitizing dye | SP-V-1 | 4 × 10⁻⁴ | mol/mole of AgX |
| Sensitizing dye | SP-V-3 | 1 × 10⁻⁴ | mol/mole of AgX |
| Potassium bromide | | 0.2 | g/mole of AgX |

Subsequently, a monodispersed cubic grain emulsion EMP-102 at an average grain diameter of 0.64 μm, a variation coefficient of grain diameter distribution of 0.07, and a content ratio of silver chloride of 99.5 mole percent was prepared in the same manner as EMP-101, except that the addition time of (Solution A) and (Solution B), and the addition time of (Solution C) and (Solution D) were varied. Em-B102 was prepared in the same manner as Em-B101, except that EMP-101 was replaced with EMP-102. A mixture of Em-B101 and Em-B102 at a ratio of 1:1 was employed as the blue sensitive emulsion.

(Preparation of a Green Sensitive Silver Halide Emulsion)

Monodispersed cubic grain emulsion (EMP-103) at an average grain diameter of 0.40 μm, a variation coefficient of grain diameter distribution of 0.08, and a content ratio of silver chloride of 99.5 mole percent was produced in the same manner as EMP-101, except that the addition time of (Solution A) and (Solution B), and the addition time of (Solution C) and (Solution D) were varied.

Said EMP-102 underwent optimal chemical sensitization at 60° C., employing compounds described below, whereby Green Sensitive Silver Halide Emulsion (Em-G101) was prepared.

| | | | |
|---|---|---|---|
| Sodium thiosulfate | | 1.5 | mg/mole of AgX |
| Chloroauric acid | | 1.0 | mg/mole of AgX |
| Stabilizer | STAB-1 | 3 × 10⁻⁴ | mol/mole of AgX |
| Stabilizer | STAB-2 | 3 × 10⁻⁴ | mol/mole of AgX |
| Stabilizer | STAB-3 | 3 × 10⁻⁴ | mol/mole of AgX |
| Sensitizing dye | GS-1 | 2 × 10⁻⁴ | mol/mole of AgX |
| Sensitizing dye | SP-II-6 | 2 × 10⁻⁴ | mol/mole of AgX |
| Sodium chloride | | 0.5 | g/mole of AgX |

Subsequently, a monodispersed cubic grain emulsion EMP-104 at an average grain diameter of 0.50 μm, a variation coefficient of grain diameter distribution of 0.08, and a content ratio of silver chloride of 99.5 mole percent was produced in the same manner as in EMP-103, except that the addition time of (Solution A) and (Solution B), and the addition time of (Solution C) and (Solution D) were varied. Em-G102 was obtained in the same manner as in Em-G101, except that EMP-103 was replaced with EMP-104. The mixture of Em-G101 and Em-G102 at a ratio of 1:1 was employed as the green sensitive emulsion.

(Preparation of a Red Sensitive Silver Halide Emulsion)

Said EMP-103 underwent optimal chemical sensitization at 60° C., employing compounds described below, whereby Red Sensitive Silver Halide Emulsion (Em-R101) was prepared.

| | | | |
|---|---|---|---|
| Sodium thiosulfate | | 1.8 | mg/mole of AgX |
| Chloroauric acid | | 2.0 | mg/mole of AgX |
| Stabilizer | STAB-1 | 2 × 10⁻⁴ | mol/mole of AgX |
| Stabilizer | STAB-2 | 2 × 10⁻⁴ | mol/mole of AgX |
| Stabilizer | STAB-3 | 2 × 10⁻⁴ | mol/mole of AgX |
| Stabilizer Compound | II-1 | 1 × 10⁻⁴ | mol/mole of AgX |
| Sensitizing Dye | SP-III-1 | 1 × 10⁻⁴ | mol/mole of AgX |
| Sensitizing Dye | SP-III-4 | 1 × 10⁻⁴ | mol/mole of AgX |
| Supersensitizer | SP-IV-1 | 2 × 10⁻⁴ | mol/mole of AgX |

Subsequently, in the preparation of (Em-R101), chemical sensitization was optimally carried out at 60° C., employing the compounds described below, whereby Red Sensitive Silver Haloed Emulsion (Em-R102) was prepared.

| | | | |
|---|---|---|---|
| Sodium thiosulfate | | 1.8 | mg/mole of AgX |
| Chloroauric acid | | 2.0 | mg/mole of AgX |
| Stabilizer | STAB-1 | 2 × 10⁻⁴ | mol/mole of AgX |
| Stabilizer | STAB-2 | 2 × 10⁻⁴ | mol/mole of AgX |
| Stabilizer | STAB-3 | 2 × 10⁻⁴ | mol/mole of AgX |
| Stabilizer Compound | II-1 | 1 × 10⁻⁴ | mol/mole of AgX |
| Sensitizing Dye | SP-III-1 | 2 × 10⁻⁴ | mol/mole of AgX |
| Sensitizing Dye | SP-III-4 | 2 × 10⁻⁴ | mol/mole of AgX |
| Supersensitizer | SP-IV-1 | 2 × 10⁻⁴ | mol/mole of AgX |

STAB-1: 1-phenyl-5-mercaptotetrazole

STAB-2: 1-(4-ethoxyphenyl)-5-mercaptotetrazole

STAB-3: 1-(3-acetoamidophenyl)-5-mercaptotetrazole

A mixture of Em-R101 and Em-R102 at a ratio of 1:1 was employed as the red sensitive emulsion.

In order to expose these samples, two types of exposure devices described below were prepared.

(Exposure Device A)

As a light source, 10 LED (about 460 nm) of B were arranged in the primary scanning direction, and adjustment was carried out so that one area can be exposed by said 10 LED while delaying exposure timing incrementally. Further, 10 LEDs were also arranged in the secondary scanning direction, and an exposure head capable of simultaneously carrying out exposure corresponding to 10 pixels adjacent was prepared. The diameter of each beam was approximately 10 μm. At said interval, beams were arranged and the secondary scanning pitch was set at approximately 100 μm. Circuits were combined so that each LED directly changed the exposure amount by varying the driving electric current. Thus, the exposure device was assembled.

(Exposure Device B)

An exposure system was prepared which was capable of simultaneously carrying out exposure corresponding to 10 pixels, employing 10-light flux, upon combining a helium-cadmium laser (approximately 442 nm), a helium-neon laser (approximately 514 nm), and a helium-neon laser (approximately 633 nm), as the light source, with AOM and a beam splitter. The diameter of each beam was approximately 10 μm. Said beam was arranged at said interval, and the secondary scanning pitch was set at approximately 100 μm.

Image data were prepared so as to output images comprised of each patch (solid having a dot percentage of 100 percent) of Y, M, C, and K (black) patches, patch having a monochromatic dot percentage of 50 percent of Y, M, and C, a three-color superimposed patch (being three-color black patch), and images comprised of a portrait portion.

Printed matter was prepared upon adjusting conditions so that dot gain became 12 percent based on said image. On the other hand, exposure conditions were determined so that dot gain became 12 percent based on the same image data, and Sample No.101 was subjected to image exposure and was subjected to photographic processing employing the steps described below.

| Processing | Processing | | Replenisher |
|---|---|---|---|
| Step | Temperature | Time | Amount |
| Color Development | 33.0 ± 0.3° C. | 120 seconds | 80 ml |
| Bleach-fix | 33.0 ± 0.5° C. | 90 seconds | 120 ml |
| Stabilization | 30 to 34° C. | 60 seconds | 150 ml |
| Drying | 60 to 80° C. | 30 seconds | |

Color Developer Tank Solution and Replenisher

| | Tank Solution | | Replenisher | |
|---|---|---|---|---|
| Pure water | 800 | ml | 800 | ml |
| Triethylenediamine | 2 | g | 3 | g |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N-(β-hydroxyethyl)- | 2.9 | g | 4.8 | g |
| 4-aminoanilne sulfate salt | | | | |
| N,N-diethylhydroxylamine | 6.8 | g | 6.0 | g |
| Triethanolamine | 10.0 | g | 10.0 | g |
| Sodium diethylenetriaminepentaacetate | 2.0 | g | 2.0 | g |
| Optical brightening agent (4,4′- | 2.0 | g | 2.5 | g |
| diaminostilbenedisulfinonic | | | | |
| acid derivative) | | | | |
| Potassium carbonate | 30 | g | 30 | g |
| Water to make | 1 | liter | 1 | liter |

The pH of Tank Solution was adjusted to 10.0 while the pH of
Replenisher was adjusted 10.6.

| | | |
|---|---|---|
| Bleach-Fix Tank Solution and Replenisher | | |
| Ferric ammonium diethylenetriaminepentaacetate | 65 | g |
| dihydrate | | |
| Diethylenetriaminetetraacetic acid | 3 | g |
| Ammonium thiosulfate (70 percent aqueous | 100 | ml |
| solution) | | |
| 2-Amino-5-mercapto-1,3,4-thiadiazole | 2.0 | g |
| Ammonium sulfite (aqueous 40 percent solution) | 27.5 | ml |
| Water to make | 1 | liter |

The pH was adjusted to 5.0 by employing potassium carbonate
or glacial acetic acid.

| | | |
|---|---|---|
| +UZ,3/20Stabilizer Tank Solution and Replenisher | | |
| o-Phenylphenol | 1.0 | g |
| 5-Chloro-2-methyl-4-isothizoline-3-one | 0.02 | g |
| 2-Merthyl-4-isothazoline-3-one | 0.02 | g |
| Diethylene glycol | 1.0 | g |
| Optical brightening agent (Tinopearl SEP) | 2.0 | g |
| 1-Hydroxyethylidene-1,1-disulfonc acid | 1.8 | g |
| Bismuth chloride (45 percent aqueous solution) | 0.65 | g |
| Magnesium sulfate heptahydrate | 0.2 | g |
| PVP (polyvinylpyrrolidone) | 1.0 | g |
| Ammonia water (25 percent aqueous ammonium | 2.5 | g |
| hydroxide solution) | | |
| Trisodium nitrilotriacetate | 1.5 | g |
| Water to make | 1 | liter |

The pH was adjusted to 7.5 by adding sulfuric acid or ammonia
water.

B, G, and R densities (under Status A as spectral characteristics) of a solid color patch, which was obtained by being subjected to exposure, employing said Exposure Devices A and B, and subsequently being subjected to photographic processing, were determined by employing a 508 type densitometer, manufactured by X-Rite Inc. Furthermore, the density of a patch at a dot percentage of 50 percent was also determined, and the dot percentage was obtained utilizing the Maurray Davies formula. The exposure amount was varied in accordance with the density of the patch at a dot percentage of 100 percent, and the dot percentage was varied in accordance with the value of said dot percentage. Subsequently, image output was again carried out. This cycle was repeated, and conditions to obtain the following image were sought: yellow (Y) density to be 1.11 at a dot percentage of 50 percent, and dot gain to be 12 percent (at a dot percentage of 50 percent); magenta (M) density to be 1.67, and dot gain to be 12 percent (at a dot percentage of 50 percent); and cyan density to be 1.57, and dot gain was 12 percent (at a dot percentage of 50 percent).

Subsequently, exposure was carried out under the obtained conditions, employing said Exposure Devices A and B. While determining L*a*b* of 50 percent three-color black patch of every 5th sheet, 50 sheets were continuously outputted, and color difference from the patch of the first sheet was obtained. Subsequently, the standard deviation of said color difference was obtained. The color of the 50 percent three-color black patch was determined under geometrical condition d-0 of illumination and light acceptance, employing spectral calorimeter CM-2022, manufactured by Minolta Co. Ltd., while utilizing a xenon pulsed light source, and an L*a*b* value was obtained utilizing a 2-degree visual field supplementary standard light D50. Table 3 below shows the results.

TABLE 3

| | Color Difference of | |
|---|---|---|
| | Three-Color | |
| Exposure Device | Standard Deviation | Remarks |
| Exposure Device A | 1.8 | Present Invention |
| Exposure Device B | 3.6 | Comparative Example |

In Comparative Example in which Exposure Device B was employed, the color difference was 3.6. Further, it was clearly noted that color variation occurred based on the obtained portrait image. On the other hand, in images obtained by employing the image forming method according to the present invention employing Exposure Device A, color variation was small and consistent reproduction was observed.

Further, it was confirmed that the portrait images, outputted employing Exposure Device A, resulted in minimal difference in image color, compared to the corresponding printed matter, and similar images were obtained.

### Example 2

Exposure Device A, described in Example 1, was prepared. Further, prepared as images were a pattern at a dot percentage of 50 percent called three-color black in which halftone dots of Y, M, and C were combined, a minimum density area, and a portrait image. Subsequently, Sample No. 101 of Example 1 was subjected to processing employing said Exposure Device under exposure and photographic processing conditions A through E (in which the compositions of the developer, which were not specified, were the same as those described in photographic processing conditions of Example 1), described below. The color difference of the resulting three-color black pattern was determined under geometrical condition d-0 of illumination and light reception, employing spectral calorimeter CM-2022, manufactured by Minolta Co. Ltd., while utilizing a xenon pulsed light source, and an L*a*b* value was obtained utilizing a 2-degree visual field supplementary standard light D50, whereby said color difference was calculated.

| | (Exposure and | (Exposure and |
|---|---|---|
| | Development | Development |
| | Condition A) | Condition B) |
| Temperature and | 25° C. and 30% RH | 35° C. and 30% RH |
| Humidity of Exposed | | |
| Area | | |
| Aging of Light- | — | 55° C. and 40% RH |
| Sensitive Material | | for 1 week |
| Development | 35° C. | 36° C. |
| Temperature | | |
| Development Time | 45 seconds | 50 seconds |
| Exposure Level at | Exposure Level 1 | Exposure Level 1 |
| Halftone Area | | |
| Exposure Level at | Exposure Level 2 | Exposure Level 3 |
| Minimum Density | | |
| Area | | |

Images were formed in the same manner as under Exposure and Development Condition B, except that Exposure and Development Conditions C through E were subjected to variation only at Exposure Levels 3 through 6.

Exposure Level 1: at the temperature and humidity of exposed areas, the development temperature, and the development time described in Exposure and Development Conditions A, an exposure amount to result in a yellow density of 0.99, a magenta density of 1.49, and a cyan density of 1.53

Exposure Level 2: at the temperature and humidity of exposed areas, the development temperature, and the development time described in Exposure and Development Conditions A, an exposure amount to result in a development threshold value of 30 percent

Exposure Level 3: at the temperature and humidity of exposed areas, the development temperature, and the development time described in Exposure and Development Condition B, an exposure amount to result in a development threshold value of 30 percent

Exposure Level 4: at said Exposure Level 3, an exposure amount to result in a development threshold value of 30 percent

Exposure Level 5: at said Exposure Level 3, an exposure amount to result in a development threshold value of 60 percent

Exposure Level 6: at said Exposure Level 3, an exposure amount to result in a development threshold value of 90 percent.

Table 4 below shows the results

TABLE 4

| | ΔE | Remarks |
|---|---|---|
| Exposure-Development | — | Standard Sample |
| Condition A | | |
| Exposure-Development | 5.3 | Comparative Example |
| Condition B | | |
| Exposure-Development | 5.6 | Comparative Example |
| Condition C | | |
| Exposure-Development | 4.1 | present Invention |
| Condition D | | |
| Exposure-Development | 3.9 | present Invention |
| Condition E | | |

As can be seen from Table 4, color variation was observed under Condition B in which the aging of the light-sensitive material, the exposure ambience, and processing conditions were varied, with respect to Exposure and Development Condition A being used as the standard. However, it was found that Condition C resulted in almost no variation, while Conditions D and E resulted in improvement. It is natural that color varies due to the aging of light-sensitive materials as well as development conditions. However, it was unexpected to observe that said color variation was improved by varying the exposure level of the minimum density areas. It is preferable that the exposure amount is large. However, it was found that when said development threshold value is at least one half, effects of the present invention are obtained.

### Example 3

A light-sensitive material, which was the same as Light-Sensitive Material No. 101 of Example 1, was prepared. The prepared light-sensitive material was wound onto a 75 mm diameter core, and rolled light-sensitive material samples, having a diameter of 77 mm, 85 mm, 100 mm, 120 mm, 150 mm, 170 mm, 190 mm, and 200 mm, were obtained. Light-shielding flanges were fixed at both ends of each of said roll samples, and subsequently, both leading edges of said light-sensitive material and a light-shielding sheet were brought into contact with each other and were adhered employing adhesive tape. Subsequently, while pulling said light-shielding sheet, it was wound onto the roll for a length corresponding to about three rotations.

The resulting samples were placed into a corrugated cardboard box. After external packing, the resulting box was set aside at 36° C. and 55 percent relative humidity for 2, 5, 8, and 15 days. Thereafter, each of the resulting samples was subjected to external surface drum exposure, employing Exposure Device A of Example 1. During said exposure, temperature and humidity were maintained at 25° C. and 20 percent, respectively. After automatically and continuously winding 10 sheets onto said exposure drum, the wound sheets were fixed by being sucked from the interior of said drum, were subjected to exposure, and developed. Three images were selected from the obtained images, and a standard deviation of displacement was obtained. Table 5, below, shows the results. Two levels of exposure were carried out at a rotation frequency of said exposure drum of 350 rpm and 700 rpm.

TABLE 5

| | | | | Number of | | |
|---|---|---|---|---|---|---|
| | | Displacement | | Peeled Sheets | | |
| Heating | | 350 rpm | 700 rpm | 350 rpm | 700 rpm | Remarks |
| 2 Days | 77 mm | 5.5 mm | 6.2 mm | 0 | 1 | Comp. |
| | 85 mm | 3.5 mm | 3.5 mm | 0 | 1 | Comp. |
| | 120 mm | 2.0 mm | 2.7 mm | 0 | 1 | Comp. |
| | 150 mm | 2.6 mm | 2.8 mm | 0 | 0 | Comp. |
| | 170 mm | 3.8 mm | 3.7 mm | 0 | 2 | Comp. |
| | 200 mm | 4.8 mm | 7.8 mm | 6 | 8 | Comp. |
| 5 Days | 77 mm | 8.3 mm | 8.7 mm | 0 | 1 | Comp. |
| | 85 mm | 2.1 mm | 2.3 mm | 0 | 0 | Inv. |
| | 120 mm | 1.0 mm | 0.9 mm | 0 | 0 | Inv. |
| | 150 mm | 0.8 mm | 0.8 mm | 0 | 0 | Inv. |
| | 170 mm | 1.2 mm | 1.5 mm | 0 | 0 | Inv. |
| | 200 mm | 5.8 mm | 3.8 mm | 3 | 7 | Comp. |
| 8 Days | 77 mm | 9.3 mm | 9.5 mm | 0 | 2 | Comp. |
| | 85 mm | 2.3 mm | 2.1 mm | 0 | 0 | Inv. |
| | 120 mm | 1.1 mm | 1.3 mm | 0 | 0 | Inv. |
| | 150 mm | 0.9 mm | 1.2 mm | 0 | 0 | Inv. |
| | 170 mm | 1.5 mm | 1.7 mm | 0 | 0 | Inv. |
| | 200 mm | 6.3 mm | 5.8 mm | 2 | 5 | Comp. |
| 15 Days | 77 mm | 8.2 mm | 9.0 mm | 1 | 3 | Comp. |
| | 85 mm | 2.2 mm | 2.5 mm | 0 | 2 | Comp. |
| | 120 mm | 2.6 mm | 2.4 mm | 0 | 1 | Comp. |
| | 150 mm | 2.0 mm | 2.5 mm | 0 | 0 | Comp. |
| | 170 mm | 2.8 mm | 2.5 mm | 0 | 0 | Comp. |
| | 200 mm | 3.4 mm | 5.8 mm | 3 | 5 | Comp. |

Inv.; Present Invention, Comp.; Comparative Example

When the sample, which had been subjected to said heat treatment for 5 days, was noted, in the diameter 77 mm roll, one sheet was peeled from said exposure drum during exposure at 700 rpm, whereby it was impossible to obtain the image. Further, the standard deviation of the displacement resulted in markedly large values, such as 8.7 mm. On the other hand, samples of the 85 through 150 mm diameter rolls resulted in preferable results in that peeling did not occur during exposure and displacement was also minimal. However, in the diameter 170 mm through 200 mm, as the diameter increased, peeling tended to occur during exposure, even though the increase in displacement was not extremely great. As a result, the case, in which images were not obtained, increased. Further, even though the standard deviation of the displacement did not increase extremely, the samples occasionally resulted in a large displacement. Thus it was found that relatively large values resulted without depending on factors such as rotation frequency.

When the number of days of said heated treatment was reduced, cases of peeling from said exposure drum increased. On the other hand, when the number of days of said heat treatment was increased, the resulting displacement tended to be somewhat greater.

In addition to the above problems due to displacement, it was not preferable to increase the number of days of said heat treatment from the viewpoint of productivity as well as the retaining properties of silver halide emulsions.

Packaging, employing light shielding flanges and light shielding sheets, has become common practice. Such packaging, exhibiting ease of handling, is one of the preferable embodiments of the present invention.

### Example 4

Two Exposure Devices A of Example 1 were prepared, and were set up so that it was possible to carry out exposure and development under processing conditions of Example 1. Samples, at different sensitivities, were prepared by suitably varying the amount of antirradiation dyes in Sample No. 101 of Example 1. The obtained samples were subjected to light shielding and were put into corrugated cardboard boxes. Thereafter, a sample was prepared which was adhered with a non-peelable label on which sensitivity information was described and another sample was also prepared which was adhered with a peelable and a repeatedly re-adherable label, on which sensitivity information was described. A total of 50 rolls of light-sensitive materials were prepared of which 15, 15, 10, 5, 3, and 2 rolls had the same sensitivity. Further, said rolls were arranged so that light-sensitive materials, of said different sensitivities, were employed in random order.

Image data were prepared which were comprised of Y, M, C three-color black, a patch in which black dot percentage was varied, a portrait image, an image combined with a landscape. Conditions of said two exposure devices were set based on the same sensitivity information. Subsequently, the same light-sensitive material was subjected to exposure employing each exposure device and was subjected to development. The chromaticity of the patch of 50 percent of the obtained three-color black was determined, and the color difference was obtained whereby ΔE was 0.6. It was found that each device resulted in almost the same image.

Subsequently, a group employing said non-peelable label having sensitivity information was designated as Group A, while a group employing said peelable and re-adherable label having sensitivity information was designated as Group B, and exposure devices were allocated to each. Then, running was carried out for one month under the condition in which exposure conditions were adjusted based on the sensitivity information after renewing the light-sensitive material.

When said A Group was employed, at the renewal of the light-sensitive material, new conditions were set with reference to the label, while said B Group was employed, the sensitivity information label was decided to adhere to the device, utilizing the re-adherable characteristics of the label, and at renewal, new conditions were set. At that time, the chromaticity of the patch of 50 percent of the three-color black was determined, and the standard deviation of the color difference of the first sample after the renewal of the light-sensitive material was obtained.

After completion of the experiments, the same light-sensitive material was repeatedly used, and based on the same sensitivity information, new conditions were set. Images were outputted employing two devices, and the chromaticity of the patch of 50 percent of the obtained three-color black was determined. Then the color difference was obtained whereby ΔE was 0.7. It was found that it was possible to consider that both were nearly the same.

Table 6 shows the standard deviation of the color difference of images obtained during one month running.

TABLE 6

| | ΔE | Remarks |
|---|---|---|
| Group A | 2.45 | Comparative Example |
| Group B | 1.35 | Present Invention |

When sensitivity information is correctly reflected, both are to exhibit nearly the same magnitude of fluctuation. However, as can clearly be seen from the results of Table 6, Group B is superior. This is considered to express the frequency of errors in setting conditions or of forgetting said settings. It is found that the method of the present invention carries out settings without error, or in other words, it effectively fulfils the function to form images upon correctly reflecting said sensitivity information.

### Example 5

Sample 101 of Example 1 was subjected to running experiment, employing the same exposure device, as well as image data, as Example 4. At that time, each of Group A and Group B was subjected to photograph processing under the same conditions as Example 1, except that each replenishment amount was varied as described below.

Group A: 80 ml per m² of a light-sensitive material

Group B: 100 ml per m² of the area of an image section 60 ml per m² of the area of the non-image section

It was arranged that the size of the image section was transmitted from the front side of an output device as attribute data, and the boundary between the image section and the non-image section was displayed employing a 7-point straight line.

The chromaticity of the patch of 50 percent three-color black was determined, and the color difference was obtained, whereby ΔE was 0.7. Thus, it was confirmed that nearly the same images were obtained. Subsequently, said running experiments were continued until the amount of the processed light-sensitive material reached 100 m². Whenever 5 m² running was completed, samples were removed, and then chromaticity of the patch of three-color 50 percent was determined. Subsequently, the color difference from the image of the first sheet was obtained, and finally, the average as well as the standard deviation was obtained. Difference ΔE of the average of the color difference of Group A and also of Group B was 1.3. When viewed over a long period, it was confirmed that the difference in images produced by said running was not so large.

TABLE 7

| | ΔE | Remarks |
|---|---|---|
| Group A | 3.25 | Comparative Example |
| Group B | 1.32 | Present Invention |

As can be seen from Table 7, the standard deviation of Group A was 3.25, while that of Group B was 1.35. Thus, it was noted that it was possible to obtain consistent images with less fluctuation upon being properly replenished according to the present invention. In silver salt digital color proofs in which minimal color difference is noted, it was found that the present invention provided a very useful replenishment method.

### Example 6

Applied onto the surface of a titanium oxide containing layer, of a 115 g/m² weight reflective support (having a Taper stiffness of 3.5, and a PY value of 2.7 μm), comprised of polyethylene laminated paper, prepared by laminating one side with high density polyethylene and the other side with melted polyethylene comprising dispersed anatase type titanium oxide in an amount of 15 percent by weight, was a layer of the configuration shown in Tables 8 and 9 below. Further, the back surface of said support was coated with 6.00 g/m² of gelatin and 0.65 g/m² of a silica matting agent. Thus, Multilayer Silver Halide Light-Sensitive Material Sample No. 601 was prepared.

TABLE 8

| | | Added |
|---|---|---|
| | | Amount |
| Layer | Constitution | (in g/m²) |
| Eighth | gelatin | 1.20 |
| Layer | UV absorber (UV-1) | 0.075 |
| (UV | UV absorber (UV-2) | 0.025 |
| Absorbing | UV absorber (UV-3) | 0.100 |
| Layer) | silica matting agent | 0.01 |
| Seventh | gelatin | 1.20 |
| Layer | red sensitive silver halide emulsion | 0.25 |
| (Red | cyan coupler (C-1) | 0.35 |
| Sensitive | high-boiling point organic solvent (SO-4) | 0.33 |
| Layer) | high-boiling point organic solvent (SO-5) | 0.33 |
| Sixth Layer | gelatin | 1.50 |
| (Inter- | antistaining agent | 0.45 |
| layer) | (HQ-2, 3: equal weight) | |
| | PVP | 0.03 |
| | antirradiation dye (AI-5) | 0.03 |
| Fifth Layer | gelatin | 1.60 |
| (Green | green sensitive silver halide emulsion | 0.40 |
| Sensitive | magenta coupler (M-1) | 0.35 |
| Layer) | yellow coupler (Y-3) | 0.09 |
| | antistaining agent (HQ-1) | 0.05 |
| | high-boiling point organic solvent (SO-1) | 0.13 |
| Fourth | gelatin | 1.00 |
| Layer | antistaining agent | 0.30 |
| (Inter- | (HQ-2, 3: equal weight) | |
| layer) | antirradiation dye (AI-2) | 0.03 |
| Third Layer | gelatin | 1.20 |
| (Blue | blue sensitive silver halide emulsion | 0.48 |
| Sensitive | yellow coupler (Y-1) | 0.30 |
| Layer) | yellow coupler (Y-2) | 0.30 |
| | antistaining agent (HQ-1) | 0.06 |
| | high-boiling point organic solvent (SO-1) | 0.45 |
| Second | gelatin | 0.50 |
| Layer | antistaining agent | 0.02 |
| (Inter- | (HQ-2, 3: equalweight) | |
| layer) | antirradiation dye (AI-1) | 0.40 |
| First | gelatin | 0.70 |
| Layer | black colloidal silver | 0.05 |
| (Colored | titanium dioxide (average primary | 0.5 |
| Layer) | particle diameter of 0.25 μm) | |
| | styrene/n-butyl methacrylate/sodium | |
| | 2-sulfoethyl methacrylate | 0.35 |

| | |
|---|---|
| Support | polyethylene laminated paper |
| | (containing a minute amount of colorants) |

TABLE 9

| | | Added |
|---|---|---|
| | | Amount |
| Layer | Constitution | (in g/m²) |
| Second | gelatin | 0.50 |
| Layer | antistaining agent | 0.02 |
| (Inter- | (HQ-2, 3: equalweight) | |
| layer) | antirradiation dye (AI-1) | 0.40 |
| First | gelatin | 0.70 |
| Layer | black colloidal silver | 0.05 |
| (Colored | titanium dioxide (average primary | 0.5 |
| Layer) | particle diameter of 0.25 μm) | |
| | styrene/n-butyl methacrylate/sodium | |
| | 2-sulfoethyl methacrylate | 0.35 |

| | |
|---|---|
| Support | polyethylene laminated paper |
| | (containing a minute amount of colorants) |

(Preparation of a Blue Sensitive Silver Halide Emulsion)

EMP-101 of Example 1 underwent optimal chemical sensitization at 60° C., employing compounds described below, whereby Blue Sensitive Silver Halide Emulsion EM-B601) was obtained.

| | | | |
|---|---|---|---|
| Sodium | | 0.8 | mg/mole of AgX |
| thiosulfate | | | |
| Chloroauric acid | | 0.5 | mg/mole of AgX |
| Stabilizer | STAB-1 | 3 × 10⁻⁴ | mol/mole of AgX |
| Stabilizer | STAB-2 | 3 × 10⁻⁴ | mol/mole of AgX |
| Stabilizer | STAB-3 | 3 × 10⁻⁴ | mol/mole of AgX |
| Sensitizing Dye | SP-V-1 | 4 × 10⁻⁴ | mol/mole of AgX |
| Sensitizing Dye | SP-V-3 | 1 × 10⁻⁴ | mol/mole of AgX |

Subsequently, Em-B602 was obtained in the same manner as Em-B601, except that EMP-102 of Example 1 was employed. The mixture of Em-B601 and Em-B602 at a ratio of 1:1 was employed as the blue sensitive emulsion.

(Preparation of a Green Sensitive Silver Halide Emulsion)

EMP-103 of Example 1 underwent optimal chemical sensitization at 55° C., employing compounds described below, whereby Green Sensitive Silver Halide Emulsion (Em-G601) was obtained.

| | | | |
|---|---|---|---|
| Sodium | | 1.5 | mg/mole of AgX |
| thiosulfate | | | |
| Chloroauric acid | | 1.0 | mg/mole of AgX |
| Stabilizer | STAB-1 | 3 × 10⁻⁴ | mol/mole of AgX |
| Stabilizer | STAB-2 | 3 × 10⁻⁴ | mol/mole of AgX |
| Stabilizer | STAB-3 | 3 × 10⁻⁴ | mol/mole of AgX |
| Sensitizing Dye | GS-1 | 4 × 10⁻⁴ | mol/mole of AgX |

At that time, immediately after the beginning of said chemical sensitization upon adding sodium thiosulfate and chloroauric acid, sensitizing dye (GS-1) was added, and at the completion of chemical sensitization, stabilizers STAB-1, -2, and -3 were added. Subsequently, Em-G602 was obtained in the same manner as Em-G601, except that EMP-104 of Example 1 was employed. The mixture of Em-G601 and Em-G602 at a ratio of 1:1 was employed as the green sensitive emulsion.

(Preparation of a Red Sensitive Silver Halide Emulsion)

EMP-103 underwent optimal chemical sensitization at 60° C., employing compounds described below, whereby Red Sensitive Silver Halide Emulsion (Em-R601) was obtained.

| | | | |
|---|---|---|---|
| Sodium | | 1.8 | mg/mole of AgX |
| thiosulfate | | | |
| Chloroauric acid | | 2.0 | mg/mole of AgX |
| Stabilizer | STAB-1 | 3 × 10⁻⁴ | mol/mole of AgX |
| Stabilizer | STAB-2 | 3 × 10⁻⁴ | mol/mole of AgX |
| Stabilizer | STAB-3 | 3 × 10⁻⁴ | mol/mole of AgX |
| Sensitizing Dye | SP-III-1 | 1 × 10⁻⁴ | mol/mole of AgX |
| Sensitizing Dye | SP-III-4 | 1 × 10⁻⁴ | mol/mole of AgX |

Subsequently, Em-R602 was prepared in the same manner as Em-R601, except that EMP-103 was replaced with EMP-105 of Example 1. A mixture of Em-R601 and Em-R602 at a ratio of 1:1 was employed as the red sensitive emulsion.

Subsequently, Green Sensitive Emulsions EM-G603 and Em-G604 were prepared in the same manner as Em-G601 and Em-G602, except that sensitizing dye (GS-1) was replaced with (SP-1-1), without changing the total amount of said dyes. These emulsions were mixed at a ratio of 1:1, whereby Light-Sensitive Material Sample 602 was prepared. A green sensitive emulsion was prepared in the same manner as above, except that the sensitizing dye was varied to (SP-1-1), and Light-Sensitive Material Sample 603 was prepared employing the resulting emulsion.

(Evaluation of Light-sensitive Materials)

These samples were divided into two groups, and one group was stored for five days under conditions of 50° C. and 40 percent relative humidity.

As a light source, 10 LED of B, G, and R were arranged in the primary scanning direction, and adjustment was carried out so that one area was capable of being exposed by said 10 LED, while delaying exposure timing slightly. Further, 10 additional LED were also arranged in the secondary scanning direction, and an exposure head capable of simultaneously carrying out exposure corresponding to 10 adjacent pixels was prepared.

The level of exposure amount was adjusted for each sample so that the density of formed black was 1.80 under Status T. The exposed pattern was such that one halftone dot was expressed utilizing 10×10 dots and 50 percent dots were exposed. In said pattern, combined were black (Y, M, and C three-color black), four-color patch of yellow (Y), magenta (M), and cyan (C), and a portrait image.

Image samples were obtained in such a manner that 10 sheets were continuously subjected to image exposure, followed by being subjected to the photographic processing described below.

The same photographic processing, and each of the same processing solutions of Example 1, were employed.

The color of the obtained black patch was determined under geometrical condition d-0 of illumination and light reception, employing a spectral calorimeter CM-2022, manufactured by Minolta Co. Ltd., while utilizing a xenon pulsed light source, and the L*a*b* value was obtained utilizing a 2-degree visual field supplementary standard light D50, whereby the standard deviation of the color difference was calculated utilizing the average of the obtained chromaticity.

Table 10 shows the above results.

TABLE 10

ΔE

| Light- | | | High |
|---|---|---|---|
| Sensitive | Sensitizing | Refrigerated | Temperature |
| Material No. | Dye | Storage | Storage |
| 601 | (GS-1) | 1.7 | 3.2 |
| (Comparative | | | |
| Example) | | | |
| 602 | (SP-I-1) | 1.4 | 1.2 |
| (Present | | | |
| Invention) | | | |
| 603 | (SP-I-2) | 1.4 | 1.4 |
| (Present | | | |
| Invention) | | | |

As can be seen from Table 10, Sample 601, in which (GS-1) was individually used, resulted in variation of the color difference of only from 1.6 to 1.7 under refrigerated storage, while Sample 601 under high temperature storage resulted in a large variation of the color difference such as about 3. On the other hand, Samples 602 and 603, in which the sensitizing dye, represented by Formula (SP-I) according to the present invention, was individually used, resulted in no appreciable increase in color variation.

### Example 7

Sample No. 701 was prepared in the same manner as Sample No. 601 of Example 6, except that cyan coupler C-1 in the seventh layer was replaced with C-2 and antirradiation dye (AI-5) was replaced with (AI-3).

Evaluation was carried out employing a full color test system, Konsensus 570, manufactured by Konica Corp. in which only the drum shape was modified, as described below.

As a light source, 10 LED of B were arranged in the primary scanning direction, and adjustment was carried out so that one area was capable of being exposed by said 10 LED while delaying exposure timing slightly. Further, 10 additional LED were also arranged in the secondary scanning direction, and an exposure head capable of simultaneously carrying out exposure corresponding to 10 adjacent pixels was prepared.

Further, as the light source, a G He—Ne laser was combined with a multi-AOM to form 10 beams so that the intensity was independently varied. Then, assembly was carried out so that said 10 beams were arranged in the secondary scanning direction. As the R light source, 10 LD were arranged so that beams were parallel to the secondary scanning direction, and assembled so that the intensity could be independently modulated.

An exposed image resulted in formation of yellow, magenta, and cyan, and exposure amount was adjusted so that black was obtained which had a visual density of 1.8, measured by employing X-Rite. Under such conditions, a 40 percent halftone image was subjected to complete exposure, and was subjected to photographic processing employing the same steps as Example 1.

<Structure of Example Samples>

The silver halide light-sensitive material, prepared as above, was cut into a 570 mm×45 m sheet, which was wound onto a paper core with an inner diameter of 3 inches. The resulting roll was placed into the specified cartridge and was employed.

<Shape of Drum>

In a 29 cm diameter aluminum drum, suction grooves and suction holes as described below were provided, and the drum surface including grooves was tinted with paint comprising carbon black so as to result in the reflection density as shown in Table 11.

Suction groove: a total 21 grooves having a width of 1.6 mm, a depth of 1.2 mm, a length of 844 mm, at an interval of 27 mm, and

suction hole: 63 circular holes having a diameter of 1.4 mm and an interval of 9 mm, located at the edges of the drum

The content of anatase type titanium oxide on one surface of the light-sensitive material was adjusted so that the transmission density resulted in values shown in Table 11. Densities which did not reach the specified value were slightly adjusted by the addition of carbon black into the gelatin layer on another surface.

Samples having an effective image area of 570×850 mm, which corresponded to B2 size, were conveyed, exposed, and subjected to photographic processing, and image unevenness (hereinafter occasionally referred simply to as unevenness) was evaluated.

Evaluation Criteria

A: no unevenness was visually noted in the area corresponding to suction grooves

B: no unevenness was visually noted in the area corresponding to the suction grooves, but when observed employing a magnifying lens 40 power, deformation of halftone dots was noted

C: unevenness was visually noted in the area corresponding to suction grooves.

TABLE 11

| | | Drum | Sample | Suction |
|---|---|---|---|---|
| | | Reflection | Transmission | Groove |
| | | Density | Density | Unevenness |
| 701-1 | Comparative | 0.52 | 0.35 | C |
| | Example | | | |
| 701-2 | Comparative | 0.52 | 0.42 | C |
| | Example | | | |
| 701-3 | Comparative | 0.52 | 0.50 | C |
| | Example | | | |
| 701-4 | Comparative | 0.52 | 0.63 | C |
| | Example | | | |
| 701-5 | Comparative | 0.52 | 0.71 | C |
| | Example | | | |
| 701-6 | Comparative | 0.59 | 0.35 | C |
| | Example | | | |
| 701-7 | Comparative | 0.59 | 0.42 | C |
| | Example | | | |
| 701-8 | Comparative | 0.59 | 0.50 | C |
| | Example | | | |
| 701-9 | Comparative | 0.59 | 0.63 | C |
| | Example | | | |
| 701-10 | Comparative | 0.59 | 0.71 | C |
| | Example | | | |
| 701-11 | Comparative | 0.70 | 1.25 | C |
| | Example | | | |
| 701-12 | Comparative | 0.70 | 0.42 | C |
| | Example | | | |
| 701-13 | Present | 0.70 | 0.50 | A |
| | Invention | | | |
| 701-14 | Present | 0.70 | 0.63 | A |
| | Invention | | | |
| 701-15 | Present | 0.70 | 0.71 | A |
| | Invention | | | |
| 701-16 | Comparative | 1.25 | 0.35 | C |
| | Example | | | |
| 701-17 | Comparative | 1.25 | 0.42 | B |
| | Example | | | |
| 701-18 | Present | 1.25 | 0.50 | A |
| | Invention | | | |
| 701-19 | Present | 1.25 | 0.63 | A |
| | Invention | | | |
| 701-20 | Present | 1.25 | 0.71 | A |
| | Invention | | | |
| 701-21 | Comparative | 1.84 | 0.35 | C |
| | Example | | | |
| 701-22 | Comparative | 1.84 | 0.42 | B |
| | Example | | | |
| 701-23 | Present | 1.84 | 0.50 | A |
| | Invention | | | |
| 701-24 | Present | 1.84 | 0.63 | A |
| | Invention | | | |
| 701-25 | Present | 1.84 | 0.71 | A |
| | Invention | | | |

### Example 8

<<Preparation of Each Light-sensitive Silver Halide Emulsion>>

(Preparation of a Green Sensitive Silver Halide Emulsions Em-G801 through Em-G807)

EMP-104 of Example 1 was subjected to chemical sensitization employing compounds described below and sensitizing dyes described in Table 14 so that the relationship between the sensitivity and the fog became optimal, whereby Green Sensitive Silver Halide Emulsions Em-G801 through Em-G807 were prepared.

| | | | |
|---|---|---|---|
| Sodium thiosulfate | | 1.5 | mg/mole of AgX |
| Chloroauric acid | | 1.0 | mg/mole of AgX |
| Stabilizer | STAB-1 | 3 × 10⁻⁴ | mol/mole of AgX |
| Stabilizer | STAB-2 | 3 × 10⁻⁴ | mol/mole of AgX |
| Stabilizer | STAB-3 | 3 × 10⁻⁴ | mol/mole of AgX |
| Sensitizing Dye (described | | 4 × 10⁻⁴ | mol/mole of AgX |
| in Table 14) | | | |

(Preparation of a Blue Sensitive Silver Halide Emulsions Em-B801 and Em-B802)

Optimal chemical sensitization was carried out in the same manner as for Example 6 and Blue Sensitive Emulsions Em-B801 and Em-B802. A mixture of Em-B801 and Em-B802 at a ratio of 1:1 was employed as the blue sensitive emulsion.

(Preparation of Red Sensitive Silver Halide Emulsions Em-R801 and Em-R802)

Optimal chemical sensitization was carried out in the same manner as for Example 6 and Red Sensitive Emulsions Em-R801 and Em-R802. A mixture of Em-R801 and Em-R802 at a ratio of 1:1 was employed as the red sensitive emulsion.

<<Preparation of Silver Halide Light-sensitive Material Samples>>

(Preparation of Silver Halide Light-sensitive Material Sample No. 801)

Sample No. 801 was prepared in the same manner as Sample 601 of Example 6, except that each layer, which was constituted as described in Tables 12 and 13 below, was applied onto the surface of the titanium oxide containing polyethylene layer. Incidentally, the added amount of each additive in Tables 12 and 13 is expressed in grams per m². Further, the amount of silver halides and colloidal silver is expressed in grams converted to silver.

TABLE 12

| | | Added |
|---|---|---|
| | | Amount |
| Layer | Constitution | (in g/m²) |
| Eighth | gelatin | 1.00 |
| Layer | UV absorber (UV-3) | 0.15 |
| (UV | silica matting agent | 0.01 |
| Absorbing | | |
| Layer) | | |
| Seventh | gelatin | 1.20 |
| Layer | blue sensitive silver halide | 0.40 |
| (Blue | emulsion | |
| Sensitive | cyan coupler (C-3) | 0.30 |
| Layer) | antistaining agent (HQ-1) | 0.05 |
| | high-boiling point organic | 0.33 |
| | solvent (SO-4) | |
| | high-boiling point organic | 0.33 |
| | solvent (SO-5) | |
| Sixth Layer | gelatin | 1.50 |
| (Inter- | antistaining agent | 0.45 |
| layer) | (HQ-2, 3: equal weight) | |
| | PVP | 0.03 |
| | antirradiation dye (AI-5) | 0.03 |
| Fifth Layer | gelatin | 1.60 |
| (Green | green sensitive silver halide | 0.40 |
| Sensitive | emulsion | |
| Layer) | magenta coupler (M-1) | 0.40 |
| | yellow coupler (Y-1) | 0.11 |
| | antistaining agent (HQ-1) | 0.10 |
| | high-boiling point organic | 0.35 |
| | solvent (SO-3) | |
| | high-boiling point organic solvent | 0.35 |
| | (trioctyl phosphate) | |
| Fourth | gelatin | 1.00 |
| Layer | antistaining agent | 0.30 |
| (Inter- | (HQ-2, 3: equal weight) | |
| layer) | antirradiation dye (AI-2) | 0.03 |
| Third Layer | gelatin | 1.50 |
| (Red | red sensitive silver halide emulsion | 0.40 |
| Sensitive | yellow coupler (Y-1) | 0.30 |
| Layer) | yellow coupler (Y-2) | 0.30 |
| | antistaining agent (HQ-1) | 0.06 |
| | high-boiling point organic | 0.60 |
| | solvent (SO-2) | |

TABLE 13

| | | Added |
|---|---|---|
| | | Amount |
| Layer | Constitution | (in g/m²) |
| Second | gelatin | 0.50 |
| Layer | antistaining agent | 0.02 |
| (Inter- | (HQ-2, 3: equal weight) | |
| layer) | antirradiation dye (AI-1) | 0.04 |
| First Layer | gelatin | 0.70 |
| (Colored | titanium dioxide (an average | 0.50 |
| Layer) | primary particle diameter | |
| | of 0.25 μm) | |
| | styrene/n-butyl methacrylate/ | 0.35 |
| | sodium 2-sulfoethyl methacrylate | |

| | |
|---|---|
| Support | polyethylene laminated paper (containing a |
| | minute amount of colorants) |

(Preparation of Silver Halide Light-sensitive Material Sample Nos. 802 through No. 814)

Silver Halide Light-Sensitive Material Sample Nos. 802 through No. 814 were prepared in the same manner as said Sample 801, except that Green Sensitive Silver Halide Emulsion Em-G801 and Magenta Coupler M-1, employed in the fifth layer, were varied as described in Table 14.

<<Evaluation of Silver Halide Light-sensitive Material Samples>>

Two of each of Sample Nos. 801 through 814, as prepared above, were prepared. One was designated as a non-aged sample, and the other was stored at 50° C. for 5 days, as a treatment representing accelerated aging, and was designated as the aged sample. Both samples were subjected to exposure and photographic processing under the conditions described below.

(Exposure Conditions)

As the exposure light source, LED light source of B, G, and R, described in Example 6, was prepared. Each sample was subjected to exposure utilizing a G LED. Exposure amount was determined so that after photographic processing described below, G density, which was measured under the Status T, employing a densitometer, manufactured by Macbeth Corp., was 1.6.

Each of the non-aged samples as well as aged samples prepared as above was subjected to solid exposure and scanning exposure employing an exposure pattern in which every 10 patches at 240 dpi and halftone dot 50 percent were alternately arranged. Subsequently, each of exposed samples was subjected to photographic processing shown in Example 1. Incidentally, dpi, as described in the present invention, refers to the number of dots per inch (2.54 cm).

Subsequently, Sample No. 801 was subjected to continuous running processing until the total replenishment amount of the color developer replenisher in the color developer tank reached 1 liter, and a color developer, which had been subjected to running processing, was obtained.

In said photographic processing, the color developer in the tank was replaced with said color developer which had been subjected to running processing, and each of the non-aged samples and aged samples was subjected to exposure and photographic processing in the same manner. The resulting samples were designated as running processed samples.

(Measurement of Variation of Color Difference)

The color of 50 percent halftone dot area of the magenta images of standard photographic processed samples and running processed samples was measured under geometrical condition d-0 of illumination and light reception, employing a spectral colorimeter CM-2022, manufactured by Minolta Co. Ltd., while utilizing a xenon pulsed light source, and 10 L*a*b* values were measured utilizing a 2-degree visual field supplementary standard light D50. The average was then obtained. Subsequently, color difference ΔE1 between the non-aged samples which had been subjected to the standard photographic processing and the running processed photographic processing, and color difference ΔE2 between the aged samples which had been subjected to the standard photographic processing and the running processed photographic processing, were obtained.

Table 14 shows the obtained results.

TABLE 14

| | Green | | Color Difference | | |
|---|---|---|---|---|---|
| | Sensitizing | M | during Running | | |
| No. | Dye | Coupler | ΔE1 | ΔE2 | Remarks |
| 801 | GS-1 | M-1 | 1.6 | 4.6 | Comparative |
| | | | | | Example |
| 802 | SP-II-2 | M-1 | 1.2 | 3.0 | Comparative |
| | | | | | Example |
| 803 | SP-II-3 | M-1 | 1.1 | 3.3 | Comparative |
| | | | | | Example |
| 804 | SP-II-5 | M-1 | 1.1 | 3.3 | Comparative |
| | | | | | Example |
| 805 | GS-1/SP-II-2 | M-1 | 0.8 | 2.6 | Comparative |
| | | | | | Example |
| 806 | GS-1/SP-II-3 | M-1 | 0.9 | 2.8 | Comparative |
| | | | | | Example |
| 807 | GS-1/SP-II-5 | M-1 | 1.3 | 2.7 | Comparative |
| | | | | | Example |
| 808 | GS-1 | MC-4 | 1.6 | 2.1 | Comparative |
| | | | | | Example |
| 809 | SP-II-2 | MC-4 | 1.2 | 1.3 | Present |
| | | | | | Invention |
| 810 | SP-II-3 | MC-4 | 1.1 | 1.4 | Present |
| | | | | | Invention |
| 811 | SP-II-5 | MC-4 | 1.1 | 1.3 | Present |
| | | | | | Invention |
| 812 | GS-1/SP-II-2 | MC-4 | 0.8 | 1.1 | Present |
| | | | | | Invention |
| 813 | GS-1/SP-II-3 | MC-4 | 0.9 | 1.2 | Present |
| | | | | | Invention |
| 814 | GS-1/SP-II-5 | MC-4 | 1.0 | 1.1 | Present |
| | | | | | Invention |

*In Sample Nos. 805 and 812, a mixture of GS-1/SP-II-2 at a ratio of 1:1 was employed. In Sample Nos. 806 and 813, a mixture of GS-1/SP-II-3 at a ratio of 1:2 was employed. In Sample Nos. 807 and 814, a mixture of GS-1/SP-II-5 at a ratio of 1:3 was employed.

As can clearly be seen from Table 14, compared to Sample Nos. 801 through 807 employing M-1 as the magenta coupler, Sample Nos. 808 through 814 in which said M-1 was replaced with magenta coupler MC-4 according to the present invention, resulted in less color difference between the aged samples which had been subjected to the standard photographic processing and the running processed photographic processing. Further, Sample Nos. 801 through 808 employing GS-1 as the sensitizing dye resulted in larger color difference and more insufficient consistency of formed images. Accordingly, it was verified that in order to minimize the variation of color between before and after aging, and before and after running processing, a combination of the specified coupler and the specified sensitizing dye, according to the present invention was very useful. All non-aged samples resulted in minimal color difference between the standard photographic processing and the running processed photographic processing. However, it is to be noted that samples according to the present inventing resulted in marked minimal color variation when aged samples are subjected to running processing.

### Example 9

Sample No. 901 was prepared in the same manner as Light-Sensitive Material No. 101 of Example 1, except that AI-3 in the second layer was replaced with AI-5, the coated amount was varied to 0.04 g/m², and AI-4 in the first layer was removed.

(Preparation of Blue Sensitive Silver Halide Emulsions Em-B901 and Em-B902)

Silver Halide Emulsion EMP-101 of Example 1 was prepared. After heating and melting EMP-1, while keeping at 60° C., added to the resulting EMP-1 were sodium thiosulfate in an amount of 0.8 mg per mole of AgX, and chloroauric acid in an amount of 0.5 mg per mole of AgX. Subsequently, the resulting mixture underwent chemical sensitization, and after two minutes, added were Sensitizing Dye (SP-V-1) in an amount of 4×10⁻⁴ mole/mole of AgX and Sensitizing Dye (SP-V-3) in an amount of 1×10⁻⁴ mole/mole of Agx, and the resulting mixture underwent chemical ripening for 180 minutes. Immediately after said chemical ripening, stabilizer (STAB-1) in an amount of 3×10⁻⁴ mole/mole of AgX, stabilizer (STAB-2) in an amount of 3×10⁻⁴ mole/mole of AgX, and stabilizer (STAB-3) in an amount of 3×10⁻⁴ mole/mole of AgX were added. Chemical sensitization was terminated by lowering the temperature, whereby Blue Sensitive Silver Halide Emulsion Em-B901 was prepared. Subsequently, Silver Halide Emulsion EMP-102 of Example 1 was prepared, and Blue Sensitive Silver Halide Emulsion Em-B902 was prepared in the same manner as above. Em-B901 and Em-B902 were mixed at a ratio of 1:1, and employed as the blue sensitive emulsion.

(Preparation of Green Sensitive Silver Halide Emulsions Em-G901 and Em-G902)

Silver Halide Emulsion EMP-103 of Example 1 was prepared. After heating and melting EMP-103, while keeping at 55° C., added to the resulting EMP-103 were sodium thiosulfate in an amount of 1.5 mg per mole of AgX, and chloroauric acid in an amount of 1.0 mg per mole of AgX. Subsequently, the resulting mixture underwent chemical sensitization, and after two minutes, added was Sensitizing Dye (GS-1) in an amount of 4×10⁻⁴ mole/mole of AgX, and the resulting mixture underwent chemical ripening for 180 minutes. Immediately after said chemical ripening, Stabilizer (STAB-1) in an amount of 3×10⁻⁴ mole/mole of AgX, Stabilizer (STAB-2) in an amount of 3×10⁻⁴ mole/mole of AgX, and Stabilizer (STAB-3) in an amount of 3×10⁻⁴ mole/mole of AgX were added. Chemical sensitization was then terminated by lowering the temperature, whereby Green Sensitive Silver Halide Emulsion Em-G901 was prepared. Subsequently, Silver Halide Emulsion EMP-10-4 of Example 1 was prepared, and Green Sensitive Silver Halide Emulsion Em-G902 was prepared in the same manner as above. Em-G901 and Em-G902 were mixed at a ratio of 1:1, and employed as the green sensitive emulsion.

(Preparation of Red Sensitive Silver Halide Emulsions Em-R901 and Em-R902)

After heating and melting EMP-104, while keeping at 60° C., added to the resulting EMP-104 were sodium thiosulfate in an amount of 1.8 mg per mole of AgX, and chloroauric acid in an amount of 2.0 mg per mole of AgX. Subsequently, the resulting mixture underwent chemical sensitization, and after two minutes, added were Sensitizing Dye (SP-III-1) in an amount of 1×10⁻⁴ mole/mole of AgX and Sensitizing Dye (SP-III-4) in an amount of 1×10⁻⁴ mole/mole of AgX, and the resulting mixture underwent chemical ripening for 180 minutes. Immediately after said chemical ripening, Stabilizer (STAB-1) in an amount of 3×10⁻⁴ mole/mole of AgX, Stabilizer (STAB-2) in an amount of 3 mole/mole of AgX, and Stabilizer (STAB-3) in an amount of 3×10⁻⁴ mole/mole of AgX were added. Chemical sensitization was then terminated by lowering the temperature, whereby Red Sensitive Silver Halide Emulsion Em-R901 was prepared. Subsequently, Silver Halide Emulsion EMP-105 of Example 1 was prepared, and Red Sensitive Silver Halide Emulsion Em-R902 was prepared in the same manner as above. Em-R901 and Em-R902 were mixed at a ratio of 1:1, and employed as the red sensitive emulsion.

(Preparation of Sample Nos. 902 through 909)

Sample Nos. 902 through 909 were prepared employing the methods described below.

Sample No. 902 was prepared in the same manner as said Sample No. 901, except that the red sensitive silver halide emulsion employed in the red sensitive layer of the third layer was varied to the emulsion described below. Each red sensitive silver halide emulsion was prepared in the same manner as said Red Sensitive Silver Halide Emulsion EM-R901 and Em-R902, except that Sensitizing Dye SP-III-1 employed in each emulsion was removed, and Exemplified Dye SP-III-4 was individually employed.

Sample No.903 was prepared in the same manner as said Sample No. 901, except that Sensitizing Dye SP-III-1 was replaced with Exemplified Dye SP-III-2.

Sample No. 904 was prepared in the same manner as said Sample No. 901, except that the red sensitive silver halide emulsion employed in the red sensitive layer of the third layer was replaced with the emulsion described below. Each red sensitive silver halide emulsion was prepared in the same manner as said Red Sensitive Silver Halide Emulsion EM-R901 and Em-R902, except that sensitizing dye SP-III-1 employed in each emulsion was replaced with Exemplified Dye SP-IV-1 in an amount of the same mole.

Sample Nos. 905 through 909 comprised of the combinations, described in Table 15, were prepared in the same manner.

(Exposure to Individual Samples, Photographic Processing, and Evaluation of Uneven Density)

Each of Samples Nos. 901 through 909, prepared as above, was cut into four 600×900 mm sheets. Each sheet was subjected to exposure employing the method described below and was subsequently subjected to photographic processing. Said photographic processing was carried out in the same manner as Example 1, except that in the composition of the color developer shown in Example 1, N-ethyl-N-(β-hydroxyethyl)-4-aminoanline sulfate was replaced with N-ethyl-N-(β-methanesulfonamidoethyl-3-methyl-4-aminoaniline 1.5 sulfate monohydrate; the concentration in the tank solution was adjusted to 2.9 g/liter and the concentration in the replenisher was adjusted to 4.8 g/liter, while ethylhydroxylamine was replaced with N,N-disulfoethylhydroxylamine; the concentration in the tank solution was adjusted to 30.4 g and the concentration in the replenisher was adjusted to 18.0 g.

(Method for Exposing Individual Samples)

As the exposure light source, the LED light sources of B, G, and R, described in Example 6, was prepared. The diameter of each beam was approximately 10 μm, and beams were arranged at this interval. Exposure was carried out while setting the secondary scanning pitch at approximately 100 μm.

Each of said four sheets was subjected to uniform exposure over the entire surface so that each of the density of yellow (Y), magenta (M), cyan (C), and black (K) was approximately 1.0.

(Evaluation of Image Characteristics)

Of uniform density samples of yellow (Y), magenta (M), cyan (C), and black (K) images, prepared as above, the magenta density (density of 1.0) was employed. Forty points were selected at a uniform interval, and the density of each point was determined employing a 508 type densitometer, manufactured by X-Rite Inc. Subsequently, the standard deviation (σDM) of density variation of 40 points was determined and employed as the index of uneven density.

Table 15 shows the results obtained as above.

TABLE 15

| | Sensitizing Dye of | Density | |
|---|---|---|---|
| No. | Third Layer | Unevenness | Remarks |
| 901 | SP-III-1/SP-III-4 | 0.082 | Comparative |
| | | | Example |
| 902 | SP-III-4 | 0.088 | Comparative |
| | | | Example |
| 903 | SP-III-2/SP-III-4 | 0.087 | Comparative |
| | | | Example |
| 904 | SP-III-4/SP-IV-1 | 0.024 | Present |
| | | | Invention |
| 905 | SP-III-4/SP-IV-2 | 0.026 | Present |
| | | | Invention |
| 906 | SP-III-5/SP-IV-1 | 0.028 | Present |
| | | | Invention |
| 907 | SP-III-5/SP-IV-2 | 0.031 | Present |
| | | | Invention |
| 908 | SP-III-6/SP-IV-1 | 0.032 | Present |
| | | | Invention |
| 909 | SP-III-6/SP-IV-2 | 0.033 | Present |
| | | | Invention |

As can clearly be seen from Table 15, samples employing the red sensitive silver halide emulsion comprised of the combination of sensitizing dyes according to the present invention result in less uneven density and superior density uniformity of formed images, compared to the comparative sample.

A silver halide light-sensitive material was prepared employing the method described below.

<<Preparation of the Reflective Support>>

(Preparation of Base Paper)

Pulp, comprised of sulfate method bleached hardwood pulp (LBKP), in an amount of 50 percent by weight and sulfate method bleached conifer pulp (NBSP) in an amount of 50 percent by weight was beaten so that freeness reached 350 ml. Thereafter, a stock slurry was prepared by adding to 100 weight parts of said pulp 3 weight parts of cationic starch, 0.2 weight part of anionic polyacrylamide, 0.4 weight part of alkylketene dimer emulsion (as the part of ketene diner), 0.4 weight part of polyamidoepichlorohydrin resin and a suitable amount of optical brightening agents, and colorants. Subsequently, said stock slurry was placed on a Fourdrinier paper making machine set at 200 m/minute. While providing a suitable turbulence, a web was formed, and was subjected to three-stage wet pressing in which the linear pressure was controlled in the range of from 150 to 1,000 N/cm at the wet part. Thereafter, the resulting web was processed utilizing smoothing rolls, and subsequently was subjected to a two-stage bulk density press in which the linear pressure was controlled in the range of from 300 to 700 N/cm at the drying part. Thereafter, the resulting web was dried. During drying, the web was subjected to sizing press, at an applied weight of 25 g/m², employing a sizing press composition comprised of 4 weight parts of carboxy-modified polyvinyl alcohol, 0.05 weight part of optical brightening agents, 0.002 weight part of coloring dyes, 4 weight parts of sodium chloride, and 92 weight parts of water. The web was dried so that the moisture content of the absolutely dried and finished base paper reached 8 percent by weight, and subsequently was subjected to a machine calendering finish under the condition of a linear pressure of 500 N/cm, whereby a 100 μm thick white base paper at a weight of 90 g/m2 was prepared.

<Preparation of Reflective support A-I>

Polyethylene was melt-extruded at 300° C. onto said white base paper as a back surface resinous layer, whereby said white base paper was covered with a 15 μMm thick back laminate layer.

Subsequently, after kneading polyethylene and anatase type titanium dioxide, the resulting mixture was melt-extruded at 300° C. onto the front surface of the laminated base paper so as to be cover it with a 15 μm thick water resistant resinous layer comprised of titanium dioxide of 2.0 g/m2 whereby Reflective Support A-1, which had resinous laminate layers on both sides, was prepared. Incidentally, the opacity of Reflective support A-1, which was determined in accordance with the method specified by JIS P 8138, was 82 percent.

<Preparation of Reflective Supports A-2 through A-7>

Reflective Supports A-2 through A-7 were prepared in the same manner as said Reflective Support A-1, except that the added amount of anatase type titanium dioxide in the surface resinous layer was varied to the value described in Table 1. Table 1 also shows the opacity of each reflective support.

>Preparation of Reflective Supports B-1 through B-7>

Each of Reflective Support B-1 through B-7, in which the added amount of anatase type titanium dioxide in the surface resinous layer described in Table 16 was varied, was prepared in the same manner as each of said Reflective Support A-1 through A-7, except that during the production of the white base paper, optical brightening agents and colorants were removed.

TABLE 16

| | Addition of | | |
|---|---|---|---|
| | Optical | | Opacity of |
| | Brightening | Content of | Reflective |
| Reflective | Agent and | Titanium | Support |
| Support No. | Colorant | Dioxide | Support |
| A-1 | added | 2.0 | 82 |
| A-2 | added | 2.5 | 84 |
| A-3 | added | 3.5 | 86 |
| A-4 | added | 4.0 | 87 |
| A-5 | added | 4.5 | 90 |
| A-6 | added | 5.5 | 91 |
| A-7 | added | — | 79 |
| B-1 | no | 2.0 | 82 |
| B-2 | no | 2.5 | 84 |
| B-3 | no | 3.5 | 86 |
| B-4 | no | 4.0 | 87 |
| B-5 | no | 4.5 | 90 |
| B-6 | no | 5.5 | 91 |
| B-7 | no | — | 79 |

<Measurement of Spectral Reflection Density of Each Support>

A spectral reflection density from 450 to 700 nm of the resinous surface of each support prepared as above was measured employing a U-3210 type autorecording spectrophotometer, manufactured by Hitachi, Ltd.

Measurement results were as follows. Though each opacity was different, A-1 through A-7 were white reflective supports having a reflection density in the wavelength region of from 450 to 700 nm of at least 0.06, and reflection density difference ΔD (maximum density−minimum density) in the wavelength region of from 450 to 600 nm of at least 0.01. On the other hand, though each opacity was different, B-1 through B-7 were white reflective supports having a reflection density in the wavelength region of from 450 to 700 nm of no more than 0.06, and reflection density difference ΔD (maximum density−minimum density) in the wavelength region of from 450 to 600 nm of no more than 0.01. Table 17 shows the spectral density of A-3 and B-3, as the representative samples.

TABLE 17

| Reflective Support | | | | | | | Opacity of |
|---|---|---|---|---|---|---|---|
| No. | Reflection Density of Reflective Support | | | | | | Reflective support |
| A-3 | 0.0042 | 0.0063 | 0.0081 | 0.0081 | 0.0067 | 0.0052 | 86 |
| B-3 | 0.0054 | 0.0055 | 0.0055 | 0.0053 | 0.0050 | 0.0042 | 86 |

Sample No. 1001 was prepared as follows: in the preparation of Light-Sensitive Material No. 801 of Example 8, the support was varied to white Reflective Support A-1 prepared as above; the green sensitive emulsion described in Example 6 was employed as the green sensitive emulsion; and the red sensitive emulsion, prepared in the same manner as Example 6, was employed except that EMP-104 and EMP-105 described in Example 1 were employed.

Sample Nos. 1002 through 1014 were prepared in the same manner as above, except that the support was suitably varied, and the added amount of titanium dioxide employed in the first layer was varied to those described in Table 18.

<<Evaluation of Silver Halide Light-sensitive Material Samples>>

Sample Nos. 1001 through 1014, prepared as above, were subjected to exposure under the conditions described below and to photographic processing described in Example 1.

(Exposure Conditions)

As the exposure light source, the LED light source of B, G, and R described in Example 6 was prepared. Each sample was subjected to exposure utilizing the G LED. Exposure amount was determined so that after photographic processing, G density, which was measured under Status T, employing a densitometer, manufactured by Macbeth Corp., was 1.6.

Further, as the image to be exposed, a standard image was prepared which was comprised of a section in which patches of each color of Y, M, C, and K were successively arranged at an interval of halftone dot of 10 percent from 10 to 100 percent, and a section in which red, green, blue, yellow, magenta, cyan, foliage green, sky blue, and flesh color patches were arranged.

Exposed samples were subjected to the same photographic processing as Example 1.

<<Evaluation of Characteristics of Each Sample>>

Each image, prepared as above, was evaluated employing the methods described below.

(Evaluation of Color)

Each of said prepared samples was subjected to visual color evaluation based on the criteria described below.

A: no color difference from the standard image was noted, and the finished product was in no way inferior to the sample printed with printing ink

B: the color of the standard image was almost reproduced and the finished product was nearly identical to the sample printed with printing ink

C: slight color difference was noted in some colors, but was in the commercially viable range

D: color difference was noted in most colors and was commercially unviable

E: color difference was noted in all colors and was totally commercially unviable.

(Evaluation of Gradation)

Each of said prepared samples was subjected to visual gradation evaluation, based on the criteria described below.

A: excellent gradation

B: good gradation

C: slightly poor gradation but in the commercially viable range

D: slightly high gradation or slightly low gradation

E: excessively high gradation resulting in no reproduction of middle tones, or excessively low gradation resulting in flat tones.

(Evaluation of Color Reproduction under Fluorescent Light)

As the light source for observation, each of said prepared samples was observed under a daylight three-wavelength region emitting type fluorescent lamp and the difference in color reproduction of the image observed under a standard white light source was subjected to visual sensory evaluation based on the criteria described below.

A: color reproduction similar to standard images observed under the standard white light source

B: color reproduction nearly similar to standard images observed under the standard white light source

C: slightly different color reproduction from standard images observed under the standard white light source, but at the commercially viable level

D: color reproduction differing from standard images observed under the standard white light source

E: color reproduction clearly different from standard images observed under the standard white light source, and commercially unviable.

(Evaluation of Blackness)

Solid black image sections of each prepared sample were placed on a white stand. The blackness was then observed and refereed to as the standard. Subsequently, each sample was moved 30 cm from said white stand and the solid black image was observed in the same manner as above. The blackness difference from the standard blackness was visually evaluated based on the criteria described below.

A: no difference from the standard blackness was noted

B: almost no difference from the standard blackness was noted

C: a slight difference from the standard blackness was noted, but still being in the commercially viable range

D: a distinct difference from the standard blackness was noted

E: a clear difference from the standard blackness was noted, and at an unviable commercial level.

Table 18 shows the results obtained by the above evaluation.

TABLE 18

| | | | | Total | TiO₂ | |
|---|---|---|---|---|---|---|
| | | | TiO₂ of | TiO₂ | Ratio of | |
| | | Opacity | First | Amount | First | Opacity |
| Sample | | of | Layer | (in | Layer | after |
| No. | Support | Support | (in g/m²) | g/m²) | (in %) | Processing |
| 1001 | A-1 | 82 | 0.5 | 2.5 | 20.0 | 88 |
| 1002 | A-2 | 84 | 0.5 | 3.0 | 16.7 | 90 |
| 1003 | A-3 | 86 | 1.0 | 4.5 | 22.2 | 91 |
| 1004 | A-4 | 87 | 0.5 | 4.5 | 11.1 | 91 |
| 1005 | A-5 | 90 | 1.5 | 6.0 | 25.0 | 93 |
| 1006 | A-6 | 91 | 1.5 | 7.0 | 21.4 | 95 |
| 1007 | A-7 | 79 | 1.5 | 1.5 | 100 | 84 |
| 1008 | B-1 | 82 | 0.5 | 2.5 | 20.0 | 88 |
| 1009 | B-2 | 84 | 0.5 | 3.0 | 16.7 | 90 |
| 1010 | B-3 | 86 | 1.0 | 4.5 | 22.2 | 91 |
| 1011 | B-4 | 87 | 0.5 | 4.5 | 11.1 | 91 |
| 1012 | B-5 | 90 | 1.5 | 6.0 | 25.0 | 93 |
| 1013 | B-6 | 91 | 1.5 | 7.0 | 21.4 | 95 |
| 1014 | B-7 | 79 | 1.5 | 1.5 | 100 | 84 |

| | | | Adaptability | | |
|---|---|---|---|---|---|
| | Color | Gradation | under | | |
| Sample | Evaluation | Evaluation | fluorescent | | |
| No. | Rank | Rank | Lamp | Blackness | Remarks |
| 1001 | C | C | C | B | Comp. |
| 1002 | C | B | C | A | Comp. |
| 1003 | C | B | C | A | Comp. |
| 1004 | C | B | C | A | Comp. |
| 1005 | C | B | C | A | Comp. |
| 1006 | C | B | C | A | Comp. |
| 1007 | D | C | D | D | Comp. |
| 1008 | C | B | C | B | Comp. |
| 1009 | B | A | B | A | Inv. |
| 1010 | A | A | A | A | Inv. |
| 1011 | A-B | A | A-B | A | Inv. |
| 1012 | A | A | A | A | Inv. |
| 1013 | B | A | B | A | Inv. |
| 1014 | C | C | C | D | Comp. |

Inv.: Present Invention, Comp.: Comparative Example

As can clearly be seen from Table 18, samples, which were prepared by employing the white reflective support, having the spectral reflection characteristics according to the preset invention, exhibit excellent color, gradation, color reproduction under fluorescent light, and blackness, compared to comparative samples. Further, it is noted that Sample Nos. 1010 and 1012 are markedly excellent in which the total amount of titanium dioxide is in the range of from 3.0 to 6.0 g/m² and at least 20 percent of said titanium dioxide is incorporated into the photographic constituting layers.

### Example 11

Sample No. 1101 was prepared in the same manner as Light-Sensitive Material No. 101 of Example 1, except that as the support, base paper of 80 g/m² was employed, AI-3 of the second layer was replaced with the same amount of AI-5 at 0.04 g/m², AI-4 of the first layer was removed, and the silver halide emulsion was replaced with the emulsion of Example 10.

Sample Nos. 1102 through 1105 were prepared in the same manner as said Sample No. 1101, except that each compound described in Table 19 was incorporated into the third layer (the red sensitive layer), the fifth layer (the green sensitive layer), and the seventh layer (the blue sensitive layer).

(Correction of Temperature Dependence in the Exposure Atmosphere)

Each sample was subjected to exposure while varying the temperature from 15 to 45° C., utilizing the method described below. The temperature dependence of the sensitivity was then approximated utilizing a linear equation. Subsequently, based on the obtained equation, the exposure amount was corrected to compensate for said temperature dependence, and exposure conditions for each sample were set.

(Exposure Device and Exposure Method)

As the light source, the exposure device employed in Example 9 was used. Image data, used for exposure, were prepared which were comprised of combinations of 20-stepped density tablet of yellow (Y), magenta (M), cyan (C) and black (K), and uniform Y, M, and C images which had been exposed resulted in a solid density of 0.75.

Further, in said exposure device, a temperature control fan and a thermal detector (being a platinum resistance thermometer) were mounted, and a circuit capable of controlling the LED exposure amount, based on the obtained temperature information, was provided.

Each sample, adjusted to 25° C., was wound onto an exposure drum in said exposure device, immediately was subjected to exposure employing said method at four temperatures of 15, 25, 35, and 45° C., and subsequently photographic processing described in Example 9.

Subsequently, each of 20-stepped density tablets of yellow (Y), magenta (M), and cyan (C) was subjected to measurement of the Status T density, employing a 508 type densitometer, manufactured by X-Rite Inc., and characteristic curves were drawn in which the abscissa represented the exposure amount (Log H) and the ordinate represented the density (D). In said characteristic curves, sensitivity was defined as the common logarithm (−Log H) of the inverse of the exposure amount (H) necessary to obtain 0.75 as each density of Y, M, and C, and each sensitivity of Y, M, and C of each sample at each exposure atmosphere temperature was determined.

(Forced Aging of Each Sample)

Two of each of Sample Nos. 1101 through 1105 were prepared. One was used as the standard, and the other was subjected to forced aging at 55° C. for 6 days.

(Evaluation of Each Sample)

Each of the standard samples and also the aged samples prepared as above was wound onto an exposure drum, was sufficiently exposed to four ambient temperatures ranging from 15 to 45° C., was subjected to exposure under the conditions in which the predetermined exposure amount was corrected, and was subjected to photographic processing. Thereafter, any fluctuation in density among the ambient exposure temperatures was determined. Table 19 shows the obtained results.

TABLE 19

| | Additive in | | | | | | | | |
|---|---|---|---|---|---|---|---|---|---|
| | Sensitive Layer | | Density Fluctuation between ambient | | | | | | |
| | | Added Amount | Temperature during Exposure | | | | | | |
| | | (mg/mole | Standard Sample | | | Aged Sample | | | |
| No. | Additive | of Agx) | Y | M | C | Y | M | C | Remarks |
| 1101 | — | — | 0.06 | 0.05 | 0.06 | 0.10 | 0.12 | 0.11 | Comp. |
| 1102 | I-2 | 6 | 0.02 | 0.01 | 0.02 | 0.02 | 0.02 | 0.02 | Inv. |
| 1103 | I-2 | 30 | 0.01 | 0.01 | 0.01 | 0.01 | 0.01 | 0.01 | Inv. |
| 1104 | II-1 | 15 | 0.02 | 0.01 | 0.02 | 0.02 | 0.02 | 0.02 | Inv. |
| 1105 | II-1 | 300 | 0.01 | 0.01 | 0.01 | 0.01 | 0.01 | 0.01 | Inv. |

Inv.: Present Invention, Comp.: Comparative Example

As can clearly be seen from Table 19, Sample No. 1101 was subjected to variation of exposure temperature dependence due to forced aging, and density variation became larger. On the other hand, after said forced aging, samples according to the present invention were subjected to minimal range of variation due to changes of the temperature on the light-sensitive materials during exposure. This implies that the exposure temperature dependence set in the standard sample is preferably maintained after forced aging.

### Example 12

Sample No. 1201 was prepared in the same manner as Light-Sensitive Material No. 101 of Example 1, except that Yellow Coupler YC-2 as the yellow coupler of the seventh layer was replaced with Y-4 at 0.55 g/m², Y-2 was removed, high-oiling point organic solvents SO-1 and SO-3 of the third layer was replaced with SO-4 at 0.77 g/m²₁ AI-3 of the second layer was replaced with AI-5 at the added amount of 0.77/m², AI-4 of the first layer was removed, the silver halide emulsion was replaced with the emulsion of Example 10.

Sample Nos. 1202 through 1206 were prepared in the same manner as said Sample No. 1201, except that the types and added amount of the yellow couple of the seventh layer were varied as described in Table 20.

TABLE 20

| | Seventh Layer: | | | ΔE from | Color Reproduc- | | | |
|---|---|---|---|---|---|---|---|---|
| | Blue Sensitive | | | Locus | tion Evaluation | | | |
| | Layer | | | nearest | | | Black | |
| | Y | Added | | Standard | | | Half- | |
| | Cou- | amount | Y | Co- | | | tone | Re- |
| No. | pler | in g/m2 | Dmax | ordinates | Y | Red | Dot | marks |
| 1201 | Y-4 | 0.55 | 1.28 | 10.8 | 1 | 4 | 1 | Comp. |
| 1202 | Y-4 | 0.80 | 1.51 | 10.7 | 1 | 4 | 3 | Comp. |
| 1203 | YC-2 | 0.48 | 1.38 | 4.8 | 4 | 4 | 1 | Comp. |
| 1204 | YC-2 | 0.71 | 1.57 | 4.9 | 4 | 4 | 5 | Inv. |
| 1205 | YC-5 | 0.51 | 1.33 | 4.4 | 5 | 4 | 1 | Comp. |
| 1206 | YC-5 | 0.73 | 1.56 | 4.6 | 4 | 4 | 4 | Inv. |

Inv.: Present Invention, Comp.: Comparative Example

<<Evaluation of Silver Halide Light-Sensitive Material Samples>>

Sample Nos. 1201 through 1206 prepared as above were subjected to exposure, employing the method described below.

Employed as the light source was the exposure device used in Example 9. The image data employed for exposure were the combination of 20-stepped density tablet of yellow (Y), magenta (M), cyan (M), and black (K), red having a dot percentage of 50 percent, black halftone dots and a portrait image (area graduation image). The employed photographic processing was the same as said Example 9.

(Measurement of Maximum Formed Yellow Density)

The formed density of the yellow (Y) dye image prepared as above was varied over 20 steps, which were measured under Status T (B filter) employing a 508 type densitometer, manufactured by X-Rite Inc. and maximum formed yellow density (Dmax) was obtained.

(Measurement of Yellow Absorption Locus in CIE LAB Space)

The spectral absorption of each of the densities of said 20-stepped density tablet, which was prepared by varying the formed yellow density, employing each of said samples which had been subjected to photographic processing, was determined under light-receiving geometrical condition c, employing illumination described in JIS Z 8722-1982 “Measurement Method of Object Color”. Tristimulus values X, Y, and X were obtained based on the obtained results, employing the method described in JIS Z 8722-1982. Subsequently, L*, a*, and b* were determined employing the method described in JIS Z 8729-1980 “Method for Expressing Body Color by L*a*b* Color Specification System and L*u*v* Color Specification System”. Measured points were smoothly connected, and when the connected line most closely approached the standard coordinates of L* 85, a*=−5, and b*=85, L*, a*, and b* were determined. Then color difference (ΔE) between said coordinates and the standard coordinates was thus obtained.

(Evaluation of Color Reproduction: Standard Color, Gold Red, and Black Halftone Dots)

Each standard color of yellow (Y), magenta (Y), and cyan (C), 50 percent gold red, black halftone dots, and a portrait image (being an area modulation image), prepared as above, were subjected to visual evaluation by 20 panelists regarding the faithful reproduction of color and brightness of color compared to the standard samples. Then evaluation was carried out based on the criteria described below.

5: at least 18 panelists evaluated the image as being good

4: 15 to 17 panelists evaluated the image as being good

3: 11 to 14 panelists evaluated the image as being good

2: 7 to 10 panelists evaluated the image as being good

1: no more than 6 panelists evaluated the image as being good.

In the above evaluation ranks, it was judged that a rank of 3 or higher was in the commercially viable range. Table 20 shows all of the obtained evaluation results.

(Table 20)

As can clearly be seen from Table 20, Sample Nos. 1201 and 1202 resulted in yellow comprised of excessive red, and accordingly resulted in a lower evaluation. However, samples, in which Exemplified Compounds YC-2 and YC-5 were employed, resulted in no such problems and showed excellent reproduction of yellow. When Dmax density was low, in the reproduction of the black halftone dot, low evaluation was only due to excessive yellow. On the other hand, it was noted that the samples of the present invention, which resulted in Dmax of at least 1.5 and in which the locus of yellow absorption in the CIE LAB color space obtained by varying the density passed through the interior of a sphere at a diameter of 10 having the center at L*=85, a*=−5, and b*=85, resulted in excellent Y, single color, gold red, and color reproduction of a black halftone dot, compared to comparative samples.

### Example 13

Sample No. 1301 was prepared in the same manner as Light-Sensitive Material No. 101 of Example 1, except that AI-3 of the second layer was replaced with AI-5 at an added amount of 0.04 g/m², AI-4 in the first layer was removed, and the silver halide emulsion was replaced with the emulsion of Example 10.

Sample No. 1302 was prepared in the same manner as Sample 1301, except that in the preparation of the blue sensitive silver halide emulsion of the seventh layer, Exemplified Compound SP-V-3 was replaced with Exemplified Compound SP-VI-1 (in an amount of 1×10⁻⁴ mole/mole of AgX).

Sample No. 1303 was prepared in the same manner as Sample No. 1302, except that Exemplified Compound SP-VI-1 was replaced with Exemplified Compound SP-VI-2.

Sample No. 1304 was prepared in the same manner as Sample No. 1303, except that Exemplified Compound SP-V-1 was replaced with Exemplified Compound SP-V-3.

<<Evaluation of Silver Halide Light-sensitive Material Samples>>

(Forced Aging of Each Sample)

Two of each of Sample Nos. 1301 through 1304 were prepared. One was used as the standard, and the other was stored at 50° C. for 5 days as the method replacing aging, and the resulting sample was designated as the aged sample. Both samples were subjected to exposure under the conditions described below.

(Method for Exposing Each Sample)

Employed as the light source was the exposure device used in Example 9. Prepared as the image data employed for exposure was a combination of 20-stepped density tablet of yellow (Y), magenta (M), cyan (M), and black (K), Y, M, C, and K patches having a halftone dot percentage of 50 percent, and a portrait image (area graduation image).

Further, in said exposure device, a temperature control fan and a thermal detector (being a platinum resistance thermometer) were mounted, and a circuit capable of controlling the exposure amount of LED, based on the obtained temperature information, was provided.

(Setting of Exposure Conditions of Each Sample)

While employing said exposure device, each sample was subjected to exposure under three conditions in which the ambient temperature in said device was set at 10° C., 25° C., and 40° C., and subsequently each sample was subjected to the same photographic processing as said Example 9. Sensitivity was determined utilizing the obtained image. Based on the sensitivity information at each temperature obtained as above, the exposure amount at 10° C. as well as at 40° C. was suitably adjusted so as to match the optimal conditions at an exposure temperature of 25° C. Thus, each of exposure correction conditions, which resulted in no temperature dependence (sensitivity variation) was set. Subsequently, in accordance with said exposure correction condition set as above, said aged samples were subjected to exposure under three conditions of 15° C., 25° C. and 40° C.

(Evaluation of Image Characteristics)

Each of 20-stepped density tablets of yellow (Y), magenta (M), and cyan (C) of the image obtained as above was subjected to measurement of the Status T density, employing a 508 type densitometer, manufactured by X-Rite Inc., and a characteristic curve was drawn in which the abscissa represented the exposure amount (Log E) and the ordinate represented the density (D). In said characteristic curve, the inverse of the exposure amount (Log E) necessary to obtain the density of minimum density (Dmin)+0.75 was defined as sensitivity. Then, Y sensitivity of each sample was determined. The sensitivity, as described herein, refers to the relative value when the sensitivity under conditions, in which each standard sample was subjected to the correction of the exposure amount, was 100. Table 21 shows each relative sensitivity of aged samples at exposure temperatures of 10° C., 25° C., and 40° C.

TABLE 21

| | Seventh Layer: Blue | | | | | |
|---|---|---|---|---|---|---|
| | Sensitive Layer | | | | | |
| | Sensitizing | Sensitizing | Relative Sensitivity | | | |
| | Dye | Dye | of Aged Sample | | | Re- |
| No. | SP-V | SP-VI | 15° C. | 25° C. | 40° C. | marks |
| 1302 | SP-V-1/ | — | 102 | 98 | 89 | Comp. |
| | SP-V-3 | | | | | |
| 1302 | SP-V-1 | SP-VI-1 | 99 | 102 | 97 | Inv. |
| 1303 | SP-V-1 | SP-VI-2 | 97 | 101 | 103 | Inv. |
| 1304 | SP-V-3 | SP-VI-1 | 98 | 98 | 101 | Inv. |

Inv.: Present Invention, Comp.: Comparative Example

As can clearly be seen from Table 21, aged samples comprising combinations of sensitizing dyes of the blue sensitive silver halide emulsion, according to the present invention, resulted in a sensitivity variation ratio with respect to the temperature during exposure, which was nearly equal to that of non-aged samples. Namely, the sensitivity correction conditions for temperature variation, which had been set for the standard sample, were maintained so as to result in nearly the same characteristics after the forced aging. Accordingly, this result means that light-sensitive materials, which have been subjected to various storage periods, are capable of constantly providing images with consistently high quality.

### Example 14

Sample No. 1401 was prepared in the same manner as Light-Sensitive Material No. 101, except that AI-3 of the second layer was replaced with AI-5 at a coated amount of 0.04 g/m², and the silver halide emulsion was replaced with that of Example 10 (however, during preparation of the red sensitive emulsion, EMP-103 and EMP-104 were employed instead of EMP-104 and EMP-105).

Subsequently, after all coating compositions of each layer were set aside at 40° C. for 5 hours, coating was carried out in the same manner as above, and Sample No. 1402 was then prepared.

Subsequently, during the preparation of Sample 1401, optimal chemical sensitization was carried out in the same manner, except that chloroauric acid employed to prepare silver halide emulsions of each Light-Sensitive layer was removed, and sodium thiosulfate was added to the blue sensitive silver halide emulsion in an amount of 25 mg/mole of AgX, and was added to the green sensitive and red sensitive silver halide emulsions in an amount of 35 mg/mole of AgX, respectively. Coating compositions were prepared in the same manner, except that each of said silver halide emulsions was employed. Sample No. 1404 was prepared by coating said coating compositions immediately after their preparation, Sample No. 1405 was prepared by coating said coating compositions after 5 hours of being setting aside, and Sample No. 1406 was prepared by coating said coating compositions after 10 hours of being setting aside.

Sample Nos. 1407 through 1409, Sample Nos. 1410 through 1412, and Sample Nos. 1413 through 1415 were prepared in the same manner as said Sample Nos. 1401 through 1403, except that the surface active agent (SU-3) employed in the first layer was replaced with Exemplified Compounds III-1, IV-2, and V-2.

<<Evaluation of Each Sample>>

(Exposure)

Employed as the light source was the exposure device used in Example 9. Prepared as the image data employed for exposure was a combination of 20-stepped density tablets of yellow (Y), magenta (M), cyan (M), and black (K), Y, M, C, and K patches having a halftone dot percentage of 50 percent, and a portrait image (area graduation image).

Photographic processing, which was the same as Example 1, was then carried out.

(Evaluation of Formed Images)

(Density Measurement and γ Calculation)

Each of 20-stepped density tablets of yellow (Y), magenta (M), and cyan (C) of the color images, obtained as above, was subjected to measurement of the Status T density, employing a 508 type densitometer, manufactured by X-Rite Inc., and a characteristic curve was drawn in which the abscissa represented the exposure amount (Log E) and the ordinate represented the density (D). In said characteristic curve drawn as above, the absolute value of the inclination (tanθ of the tangential line at a density of 0.75 of each of Y, M, and C on said characteristic curve was defined as γ. Then, γ of Y, M, and C of each sample was determined.

Subsequently, γ of each color of samples Nos. 1401, 1404, 1407, 1410, and 1413, which were prepared by applying coating compositions immediately after being prepared, was designated as the standard, and γ difference (Δγ), which was the difference between the standard, and γ of the samples, which were coated after 5 and 10 hours after the preparation of said coating compositions, was obtained. Table 22 shows the obtained results.

TABLE 22

| | Standing | Gold | First | | | | |
|---|---|---|---|---|---|---|---|
| | Time of | Sensitizer | Layer: | | | | |
| Sam- | Each | of Light- | Surface | γ Variation Range | | | |
| ple | Coating | Sensitive | Active | (Δγ) | | | Re- |
| No. | Composition | Layer | Agent | Y | M | C | marks |
| 1401 | — | HAuCl₄ | SU-3 | — | — | — | |
| 1402 | 5 hours | HAuCl₄ | SU-3 | −0.13 | −0.24 | −0.32 | Comp. |
| 1403 | 10 hours | HAuCl₄ | SU-3 | −0.25 | −0.43 | −0.67 | |
| 1404 | — | — | SU-3 | — | — | — | |
| 1405 | 5 hours | — | SU-3 | −0.04 | −0.10 | −0.11 | Comp. |
| 1406 | 10 hours | — | SU-3 | −0.11 | −0.19 | −0.24 | |
| 1407 | — | HAuCl₄ | (III-1) | — | — | — | |
| 1408 | 5 hours | HAuCl₄ | (III-1) | −0.04 | −0.08 | −0.09 | Inv. |
| 1409 | 10 hours | HAuCl₄ | (III-1) | −0.08 | −0.14 | −0.16 | |
| 1410 | — | HAuCl₄ | (IV-2) | — | — | — | |
| 1411 | 5 hours | HAuCl₄ | (IV-2) | −0.03 | −0.05 | −0.07 | Inv. |
| 1412 | 10 hours | HAuCl₄ | (IV-2) | −0.07 | −0.09 | −0.13 | |
| 1413 | — | HAuCl₄ | (V-2) | — | — | — | |
| 1414 | 5 hours | HAuCl₄ | (V-2) | −0.04 | −0.06 | −0.08 | Inv. |
| 1415 | 10 hours | HAuCl₄ | (V-2) | −0.08 | −0.10 | −0.09 | |

Inv.: Present Invention, Comp.: Comparative Example

As can clearly be seen from Table 22, Sample Nos. 1401 h 1403, which comprised the comparative surface active (SU-3) and underwent chemical sensitization, employing auric acid, resulted in a markedly large decrease in st (being an increase in Δγ). On the other hand, Nos. 1404 through 1406, which employed silver halide ons subjected to chemical sensitization utilizing thiosulfate alone, resulted in improvement of the se in contrast due to the standing of the coating ition, compared to Sample Nos. 1401 through 1403. r, Samples Nos. 1404 through 1406 resulted in very low sensitivity due to chemical sensitization without use of chloroauric acid, and were not commercially viable.

On the other hand, samples, which employed each surface active agent according to the present invention, even employing the silver halide emulsion utilizing chloroauric acid, resulted in minimal γ variation for the variation of standing period, and also resulted in higher sensitivity. Of these, samples particularly comprised of Exemplified Compounds (IV-2) and (V-2) resulted in large desired effects and the preferred results were obtained.

Further, halftone dots of patches having a halftone dot percentage of 50 percent were observed employing a magnifying lens. It was possible to confirm that Sample No. 403 resulted in blurred edges of the halftone dots. However, in other samples, it was almost impossible to detect the difference.

Accordingly, in order to clarify the effects of the present invention, during the preparation of Sample Nos. 1401 and 1407, only the standing time of the coating composition of the red sensitive layer as the third layer was varied, and all other coating compositions were coated immediately after preparation, whereby Sample Nos. 1421 through 1423 and Nos. 1424 through 1426 were prepared. Obtained samples were evaluated in the same manner as above. Table 23 shows the obtained results.

TABLE 23

| | Standing | | | | | | |
|---|---|---|---|---|---|---|---|
| | Time of | | | | | | |
| | Third Layer | Gold | Surface | | | | |
| Sample | Coating | Com- | Active | Δγ | | | Re- |
| No. | Composition | pound | Agent | Y | M | C | marks |
| 1421 | — | HAuCl₄ | (SU-3) | — | — | — | Comp. |
| 1422 | 5 hours | HAuCl₄ | (SU-3) | −0.02 | −0.12 | −0.02 | |
| 1423 | 10 hours | HAuCl₄ | (SU-3) | −0.04 | −0.26 | −0.05 | |
| 1424 | — | HAuCl₄ | (III-1) | — | — | — | Inv. |
| 1425 | 5 hours | HAuCl₄ | (III-1) | −0.02 | −0.06 | −0.02 | |
| 1426 | 10 hours | HAuCl₄ | (III-1) | −0.03 | −0.08 | −0.03 | |

Inv.: Present Invention, Comp.: Comparative Example

As can clearly be seen from Table 23, even though by individually standing the Light-Sensitive coating composition, a trend of a decrease in contrast was noted, and the degree of said decrease in contrast became smaller, compared to the results in Table 2. It is assumed that by simultaneously allowing also the coating composition comprising surface active agents to stand, the effects are markedly exhibited and other layers are affected to result in the decrease in contrast. In such simulated experiments, the effects of surface active agents according to the present invention was noted.

### Example 15

Applied onto the surface of the titanium oxide containing layer of a 115 g/m² weight reflective support (having a Taper stiffness of 3.5, and a PY value of 2.7 μm), comprised of polyethylene laminated paper, prepared by laminating one side with high density polyethylene and the other side with melt polyethylene, comprising dispersed anatase type titanium oxide in an amount of 15 percent by weight, was each layer of the layer configuration shown in Table 24, described below. Further, the back surface of said support was coated with 6.00 g/m² of gelatin and 0.65 g/m² of a silica matting agent. Thus, Multilayer Silver Halide Light-Sensitive Material Sample No. 1501 was prepared. Incidentally, the added amount of the silver halide and the colloidal silver in Table 34 was expressed utilizing the amount which was converted to silver.

TABLE 24

| | | Added |
|---|---|---|
| | | Amount |
| Layer | Constitution | (in g/m²) |
| Third Layer | gelatin | 1.20 |
| (Protective | silica matting agent | 0.01 |
| Layer) | | |
| Second | gelatin | 1.60 |
| Layer | green sensitive silver halide | 0.40 |
| (Green | emulsion (Em-G151) | |
| Sensitive | magewnta coupler (M-1) | 0.35 |
| Layer) | yellow coupler (V-3) | 0.09 |
| | antistaining agent (HQ-1) | 0.05 |
| | high-boiling point orgasnic | 0.13 |
| | solvent (SO-1) | |
| First Layer | gelatin | 0.70 |
| (Colored | black colloidal silver | 0.05 |
| Layer) | antirradiation dye (AI-2) | 0.03 |
| | titanium dioxide (average primary | 0.5 |
| | particle diameter of 0.25 μm) | |
| | styrene/n-butyl methacrylate/ | |
| | sodium 2-sulfoethyl methacrylate | 0.35 |

| | |
|---|---|
| Support | polyethylene laminated paper |
| | containing a minute amount of colorants) |

•The added amount of the silver halide emulsion was shown upon being converted to the weight of silver.

A green sensitive silver halide emulsion (Em-G151) was prepared employing the method described below.

(Preparation of Green Sensitive Silver Halide Emulsion Em-G151)

Added to 1 liter of 2 percent aqueous gelatin solution heated at 40° C. (Solution A1) and (Solution B1) employing a double-jet method, while controlling pAg at 7.3 and pH at 3.0, and further (Solution C1) and (Solution D1) employing a double-jet method while controlling pAg at 8.0 and pH at 5.5. During that time, pAg was controlled employing the method described in Japanese Patent Publication Open to Public Inspection No. 59-45437, and pH was suitably controlled by adding sulfuric acid or an aqueous sodium hydroxide solution.

| (Solution A1) | | |
|---|---|---|
| Sodium chloride | 3.42 | g |
| Potassium bromide | 0.03 | g |
| Water to make | 200 | ml |
| (Solution B1) | | |
| Silver nitrate | 10 | g |
| Water to make | 200 | ml |
| (Solution C1) | | |
| Sodium chloride | 102.7 | g |
| Potassium hexachloroiridate(IV) | 4 × 10⁻⁸ | mole |
| Potassium hexacyanoferrate(II) | 2 × 10⁻⁵ | mole |
| Potassium bromide | 1.0 | g |
| Water to make | 600 | ml |
| (Solution D1) | | |
| Silver nitrate | 300 | g |
| Water to make | 600 | ml |

After the completion of the addition, the resulting mixture was subjected to desalting employing a 5 percent aqueous solution of Demol N, manufactured by Kao-Atlas Co., and a 20 percent aqueous magnesium sulfate solution. Thereafter, the desalted composition was mixed with an aqueous gelatin solution, whereby monodispersed cubic grain emulsion EMP-151 having an equivalent circle diameter (ECD) of 0.45 μm, a variation coefficient of 0.08, and a silver chloride content ratio of 99.5 mole percent.

Said EMP-151 underwent optimal chemical sensitization at 55° C., employing compounds described below so that the relationship between the sensitivity and fog became optimal, whereby Green Sensitive Silver Halide Emulsion (EM-G151) was obtained.

| | | |
|---|---|---|
| Sodium thiosulfate | 1.5 | mg/mole of AgX |
| Chloroauric acid | 1.0 | mg/mole of AgX |
| Stabilizer: STAB-1 | 3 × 10⁻⁴ | mol/mole of AgX |
| Stabilizer: STAB-2 | 3 × 10⁻⁴ | mol/mole of AgX |
| Stabilizer: STAB-3 | 3 × 10⁻⁴ | mol/mole of AgX |
| Sensitizing Dye: GS-1 | 4 × 10⁻⁴ | mol/mole of AgX |

Further, each of the oil-soluble couplers and antistaining agents employed to prepare said Sample No. 1501 were dissolved in high-boiling point solvents, described in Table 24 and ethyl acetate as the low-boiling point solvent upon being heated, were subsequently added to an aqueous gelatin solution. The resulting mixture was subjected to dispersion employing an ultrasonic homogenizer, and the resulting dispersion was employed. During said emulsification dispersion, SU-1 was employed as the surface active agent. Further, H-1 and H-2 were added as the hardeners. Added as coating aids were SU-2 and SU-3, and the surface tension of each layer was suitably adjusted. Further, F-1 was added to each layer so that the total amount reached 0.04 g/m².

(Preparation of Silver Halide Light-sensitive Material Sample No. 1502)

Sample No. 1502 was prepared in the same manner as said Sample No. 1501, except that Green Sensitive Silver Halide Emulsion Em-G151, employed in the second layer was replaced with Em-G152 which was prepared employing the method described below.

(Preparation of Green Sensitive Silver Halide Emulsion Em-G152)

Added to 1,000 ml of 2 percent aqueous gelatin solution heated at 40° C. were (Solution A2) and (Solution B2) described below over 30 minutes, employing a double-jet method, while controlling pAg at 6.5 and pH at 3.0, and further added were (Solution C2) and (Solution D2) described below over 180 minutes, employing a double-jet method while controlling pAg at 7.3 and pH at 5.5. During that time, pAg was controlled employing the method described in Japanese Patent Publication Open to Public Inspection No. 59-45437, and pH was suitably controlled by adding sulfuric acid or an aqueous sodium hydroxide solution. Subsequently, (Solution E2) and (Solution F2) were added over 2 minutes.

| (Solution A2) | | |
|---|---|---|
| Sodium chloride | 3.44 | g |
| Water to make | 200 | ml |
| (Solution B2) | | |
| Silver nitrate | 10.0 | g |
| Water to make | 200 | ml |
| (Solution C2) | | |
| Sodium chloride | 102.5 | g |
| Solution G *1) | 50 | ml |
| Water to make | 600 | ml |
| (Solution D2) | | |
| Silver nitrate | 297.8 | g |
| Water to make | 600 | ml |
| (Solution E2) | | |
| Potassium bromide | 1.52 | g |
| Water to make | 15 | ml |
| (Solution F2) | | |
| Silver nitrate | 2.2 | g |
| Water to make | 15 | ml |

(*1) Solution G: 1 Percent Methanol Solution of 1-phenyl-5-mercaptotetrazole

After the completion of the addition, the resulting mixture was subjected to desalting employing a 5 percent aqueous solution of Demol N, manufactured by Kao-Atlas Co., and a 20 percent aqueous magnesium sulfate solution. Thereafter, the desalted composition was mixed with an aqueous gelatin solution, and the resulting mixture was re-dispersed. As described above, monodispersed cubic grain emulsion EMP-152 was obtained which had an ECD of 0.45 μm, a variation coefficient (S/R) of 0.08, and a silver chloride content ratio of 99.3 mole percent. An analysis, employing X-rays showed that the maximum silver bromide content in the region, which comprised the high concentration of silver bromide, was 61 mole percent.

Green Sensitive Silver Halide Emulsion Em-G152 was prepared in the same manner as said Em-G151, except that EMP-151 was replaced with EMP-152, prepared as above.

(Evaluation of Silver Halide Light-sensitive Material Samples)

A part of each of Sample Nos. 1501 and 1502 was stored at 55° C. and 40 percent relative humidity for 7 days representing as the forced aging storage conditions. Each of aged samples and non-aged samples was subjected to exposure and photographic processing under the conditions described below.

(Exposure Conditions)

Employed as the light source was the exposure device used in Example 6. Prepared as the image data were each solid image patch of Y, M, and C, and black comprised of said three colors, and a chart capable of obtaining a patch having a halftone dot percentage of 50 percent.

Photographic processing was carried out in the same manner as Example.

(Evaluation of Characteristics)

An exposure amount was set so that each of aged and non-aged Sample Nos. 1501 and 1502 resulted in the formation of density (determined under the condition of Status T, employing a 508 type densitometer, manufactured by X-Rite Inc.) of 1.50 of the solid M (magenta) patch. Subsequently, each sample was subjected to exposure under the conditions determined as above and was subsequently subjected to photographic processing. Continuously, 30 charts were outputted, and the density of each halftone dot of 50 percent was determined, and the standard deviation of the measured densities was obtained. Incidentally, each of Sample Nos. 1501 and 1502 was a sample comprised of a single color. Accordingly, continuous processing was carried out employing samples similar to Sample No. 101, and during said processing, Sample Nos. 1501 and 1502 were evaluated. By so doing, attention was paid so as to minimize the level variation of the developer in the evaluation. Table 25 shows the results obtained above.

TABLE 25

| | | No | |
|---|---|---|---|
| Sample | Accelerated | Accelerated | |
| No. | Aging | Aging | Remarks |
| 1501 | 0.045 | 0.020 | Comparative Example |
| 1502 | 0.023 | 0.022 | Present Invention |
| | | | (Emulsion comprised of the |
| | | | portion of a high |
| | | | concentration of AgBr) |

As can clearly be seen from Table 25, Sample No. 1502, employing the emulsion comprising portion contain silver bromide at higher concentration, resulted in minimized density variation during continuous processing, compared to Comparative Sample No. 1501. Further, in the case of Comparative Sample No. 1501, when not stored under the forced aging conditions, the range of the density variation was the same as the sample of the present invention. Thus, it was found that said density variation was not due to simple processing variation but was a phenomena due to the degradation of the product quality of the light-sensitive material itself under the severe storage conditions.

### Example 16

Sample No. 1601 was prepared in such a manner that in the preparation of Light-Sensitive Material No. 801 of Example 8, the green sensitive emulsion described in Example 6 was employed as the green sensitive emulsion, and the red sensitive emulsion, which was prepared in the same manner as Example 6, except that EMP-104 and EMP-105 described in Example 1 was used, was employed, and further the cyan coupler was replaced with a mixture of (C-1) and (C-2).

<<Evaluation of Silver Halide Light-sensitive Material Sample>>

(Exposure Conditions)

Employed as the light source was the exposure device used in Example 6. An exposure amount was set so that after photographic processing described below, C density, which was determined under the Status T, employing a 508 type densitometer manufactured by X-Rite Inc., was 1.0.

Each of the untreated samples and the aged samples, prepared as above, was subjected to scanning exposure, employing an exposure pattern in which 10 patches of a solid section, at 2,400 dpi, and 50 percent halftone dot were alternately arranged, and subsequently, each of the exposed sample was subjected to Photographic Processing-1 through Photographic Processing-3. Incidentally, dpi, as described in the present invention, refers to the number of dots per inch (2.54 cm).

(Photographic Processing)

(Automatic Processor)

Digital Consensus Type 570, an automatic processor, manufactured by Konica Corp., was employed which comprised a developer tank: 20 liter (a solution temperature at 37° C.), a bleach-fixer tank: 8 liters (a solution temperature at 37° C.), a 3-stage cascaded counter-current system stabilizer tank (the first stabilizer tank: 6 liters, the second stabilizer tank: 6 liters, and the third stabilizer tank: 6 liters), and drying section (mantained at 55° C.).

(Photographic Processing Conditions)

<Photographic Processing-1>

In Photographic Processing-1, photographic processing steps and each processing solution, as described below, were employed.

| Processing | Processing | Processing | Replenisher |
|---|---|---|---|
| Step | Temperature | Time | Amount |
| Color Development | 37.0 ± 0.3° C. | 120 seconds | 200 ml/m² |
| Bleach-fix | 37.0 ± 0.3° C. | 60 seconds | 200 ml/m² |
| First Stabilization | | 37 seconds | — |
| Second Stabilization | | 37 seconds | — |
| Third Stabilization | | 37 seconds | 350 ml/m² |
| Drying | 50 to 70° C. | 37 seconds | |

Color Developer Tank Solution and Replenisher

| | Tank solution | | Replenisher | |
|---|---|---|---|---|
| Pure water | 800 | ml | 800 | ml |
| Potassium bromide | 0.1 | g | — | |
| Potassium chloride | 3.5 | g | — | |
| Potassium sulfite | 0.25 | g | 0.5 | g |
| Developing agent: | 2.9 | g | 4.8 | g |
| Exemplified Compound 4-2 | | | | |
| N,N-disulfoethylhydroxylamine | 8.0 | g | 8.0 | g |
| Triethanolamine | 10 | g | 10 | g |
| Sodium | 2.0 | g | 2.0 | g |
| diethylenetriaminepentaacetate | | | | |
| Optical brightening agent (4,4′- | 2.5 | g | 2.5 | g |
| diaminostilbenedisulfonic | | | | |
| acid derivative) | | | | |
| Potassium carbonate | 30 | g | 30 | g |
| Water to make | 1 | liter | 1 | liter |

The pH of Tank Solution was adjusted to 10.0, while the pH of
Replenisher was adjusted to 10.6.
Bleach-fix Tank Solution and Replenisher

| | | |
|---|---|---|
| Ferric ammonium | 65 | g |
| diethylenetriaminepentaacetate | | |
| dihydrate | | |
| Diethylenetriaminetetraacetic acid | 3 | g |
| Ammonium thiosulfate (70 percent aqueous | 100 | ml |
| solution) | | |
| 2-Amino-5-mercapto-1,3,4-thiadiazole | 2.0 | g |
| Ammonium sulfite | 27.5 | ml |
| (aqueous 40 percent solution) | | |
| Water to make | 1 | liter |

The pH was adjusted to 5.0 by employing potassium carbonate
or glacial acetic acid.
Stabilizer Tank Solution and Replenisher

| | | |
|---|---|---|
| o-Phenylphenol | 1.0 | g |
| 5-Chloro-2-methyl-4-isothizoline-3-one | 0.02 | g |
| 2-Methyl-4-isothazoline-3-one | 0.02 | g |
| Diethylene glycol | 1.0 | g |
| Optical brightening agent (Tinopearl SFP) | 2.0 | g |
| 1-Hydroxyethylidene-1,1-disulfonc acid | 1.8 | g |
| Bismuth chloride | 0.65 | g |
| (45 percent aqueous solution) | | |
| Magnesium sulfate heptahydrate | 0.2 | g |
| PVP (polyvinylpyrrolidone) | 1.0 | g |
| Ammonia water | 2.5 | g |
| (25 percent aqueous ammonium | | |
| hydroxide solution) | | |
| Trisodium nitrilotriacetate | 1.5 | g |
| Water to make | 1 | liter |

The pH was adjusted to 7.5 by adding sulfuric acid or ammonia
water.

Each processing solution, prepared as above, was charged into each processing tank of said automatic processor, and the temperature control was initiated at a room temperature of 15° C., and after 15 minutes, an exposed 570×493 mm Sample No. 1601, prepared as above, was subjected to said photographic processing. After outputting images, exposure and photographic processing were continued. After one hour and 8 hours, the same processing was carried out and image outputted samples were prepared.

Further, the solution temperatures of each stabilizer tank at each said processing time were as follows:

| | First | Second | Third |
|---|---|---|---|
| | Stabilizer | Stabilizer | Stabilizer |
| | Tank | Tank | Tank |
| After 15 minutes | 22° C. | 20° C. | 23° C. |
| After 1 hour | 27° C. | 24° C. | 28° C. |
| After 8 hours | 35° C. | 32° C. | 35° C. |

<Photographic Processing-2>

Photographic Processing-2 was carried out in the same manner as said photographic processing, except that the second stabilizer tank was subjected to temperature control at 37° C., and the stabilizer on the third stabilizer tank was replace with water.

Further, the solution temperatures of each stabilizer tank at each said processing time were as follows:

| | First | Second | Third |
|---|---|---|---|
| | Stabilizer | Stabilizer | Stabilizer |
| | Tank | Tank | Tank |
| After 15 minutes | 25° C. | 37° C. | 26° C. |
| After 1 hour | 30° C. | 37° C. | 31° C. |
| After 8 hours | 35° C. | 37° C. | 35° C. |

(Measurement of Variation of Color Difference)

The color difference of processed samples 15 minutes, 1 hour, and 8 hours after the initiation of Photographic Processing-1 and -2 was measured employing the method described below.

The color of 50 percent halftone dot area of each cyan image obtained as the representative of color difference measurement was measured under geometrical condition d-0 of illumination and light reception, employing a spectral calorimeter CM-2022, manufactured by Minolta Co. Ltd., while utilizing a xenon pulsed light source, and 10 L*a*b* values were measured utilizing a 2-degree visual field supplementary standard light D50. The average was then obtained. Subsequently, color difference ΔE1 between the samples 15 minutes and 1 hour after initiation of processing, and color difference ΔE2 between samples 15 minutes and 8 hour after initiation of processing were obtained based on the formula described below:

ΔE=(ΔL*2+Δa*2+Δb*2)½

wherein ΔL*, Δa*, and Δb* each represent a difference between both conditions.

Table 26 shows the obtained results as described above.

TABLE 26

| Photographic | Color Difference AE | | |
|---|---|---|---|
| Processing No. | ΔE1 | ΔE2 | Remarks |
| 1 | 2.5 | 2.9 | Comparative |
| | | | Example |
| 2 | 1.0 | 1.5 | Present |
| | | | Invention |

As can clearly be seen from Table 26, with respect to comparative Photographic Processing-1, Photographic Processing-2 of the present invention resulted in less variation of color difference and was capable of consistently outputting halftone images in the midscale density section.

### Example 17

<<Evaluation of Silver Halide Light-sensitive Material Samples>>

Two of each of Sample No. 1601 Example 16 were prepared. One was designated as the non-aged sample. The other was stored at 50° C. for 5 days and the resulting sample was designated as the aged sample. Both samples were subjected to exposure and photographic processing under the conditions described below.

(Exposure Conditions)

Employed as the light source was the exposure device used in Example 9. An exposure amount was set so that after photographic processing described below, C density, M density, and Y density, which were determined under the Status T, employing a 508 type densitometer manufactured by X-Rite Co., were 1.6, 1.6 and 1.2, respectively.

Each of non-aged samples and aged samples was subjected to scanning exposure and were subsequently subjected to Photographic Processing-1 through Photographic Processing-4 described below.

(Photographic Processing)

(Photographic Processing-1)

In Photographic Processing-1, the photographic processing steps and each processing solution described below were employed.

| Processing | Processing | | Replenisher |
|---|---|---|---|
| Step | Temperature | Time | Amount |
| Color Development | 33.0 ± 0.3° C. | 120 seconds | 80 ml |
| Bleach-fix | 33.0 ± 0.5° C. | 90 seconds | 120 ml |
| Stabilization | 30 to 34° C. | 60 seconds | 150 ml |
| Drying | 60 to 80° C. | 30 seconds | |

| | | |
|---|---|---|
| Color Developer Replenisher | | |
| Pure water | 800 | ml |
| Triethylenediamine | 3 | g |
| Diethylene glycol | 10 | g |
| Potassium sulfite | 0.5 | g |
| Color developer: Exemplified Compound | 4.8 | g |
| (VII-2) | | |
| N,N-diethylhydroxylamine | 6.0 | g |
| Triethanolamine | 10.0 | g |
| Sodium | 2.0 | g |
| diethylenetriaminepentaacetate | | |
| Optical brightening agent (4,4′- | 2.5 | g |
| diaminostilbenedisulfonic | | |
| acid derivative) | | |
| Potassium carbonate | 30 | g |
| Water to make | 1 | liter |
| The pH was adjusted to 10.6. | | |
| <Color Developer Tank Solution | | |
| Pure water | 800 | ml |
| Triethylenediamine | 2 | g |
| Diethylene glycol | 10 | g |
| Potassium bromide | 0.01 | g |
| Potassium chloride | 3.5 | g |
| Potassium sulfite | 0.25 | g |
| Developing agent: Exemplified Compound | 2.9 | g |
| (VII-2) | | |
| N,N-diethylhydroxylamine | 6.8 | g |
| Triethanolamine | 10.0 | g |
| Sodium | 2.0 | g |
| diethylenetriaminepentaacetate | | |
| Optical brightening agent (4,4′- | 2.0 | g |
| diaminostilbenedisulfinonic | | |
| acid derivative) | | |
| Potassium carbonate | 30 | g |
| Water to make | 1 | liter |
| The pH was adjusted to 10.0 | | |
| <Beach-fix Tank Solution and Replenisher> | | |
| Ferric ammonium | 65 | g |
| diethylenetriaminepentaacetate | | |
| dihydrate | | |
| Diethylenetriaminetetraacetic acid | 3 | g |
| Ammonium thiosulfate | 100 | ml |
| (70 percent aqueous | | |
| solution) | | |
| 2-Amino-5-mercapto-1,3,4-thiadiazole | 2.0 | g |
| Ammonium sulfite (aqueous 40 percent | 27.5 | ml |
| solution) | | |
| Water to make | 1 | liter |
| The pH was adjusted to 5.0 by employing | | |
| potassium carbonate or glacial acetic acid. | | |
| Stabilizer Tank Solution and Replenisher | | |
| o-Pneylphemol | 1.0 | g |
| 5-Chloro-2--methyl-4-isothizoline-3-one | 0.02 | g |
| 2-Methyl-4-isothazoline-3-one | 0.02 | g |
| Diethylene glycol | 1.0 | g |
| Optical brightening agent (Tinopeari SFP) | 2.0 | g |
| 1-Hydroxyethylidene-1,1-disulfonic acid | 1.8 | g |
| Bismuth chloride (45 percent aqueous | 0.65 | g |
| solution) | | |
| Magnesium sulfate heptahydrate | 0.2 | g |
| PVP (polyvinylpyrrolidone) | 1.0 | g |
| Ammonia water (25 percent aqueous | 2.5 | g |
| ammonium hydroxide solution) | | |
| Trisodium nitrilotriacetate | 1.5 | g |
| Water to make | 1 | liter |
| The pH was adjusted to 7.5 by adding sulfuric | | |
| acid or ammonia water. | | |

(Photographic Processing-2)

Photographic processing-2 was conducted in the same manner as Photographic Processing-1, except that said STB-1 was added to Color Developer Starter Solution so as to result in a concentration of 1 g per liter of the Developer Tank Solution.

(Photographic Processing-3)

Photographic Processing-3 was conducted in the same manner as said Photographic Processing-2, except that Exemplified Compound 1-2, as the developing agent in the Developer Replenisher was replaced with 4-amino-3-methyl-N-ethyl-N-β-methasnesulfonamidoethylaniline 1.5 sulfate monohydrate.

(Photographic Processing-4)

Photographic Processing-4 was conducted in the same manner as said Photographic Processing-2, except that instead of STAB-1, said STAB-3 was added to the Developer Starter Solution so as to result in a concentration of 0.001 g/liter of the Developer Tank Solution.

Each of both the untreated samples and aged samples, exposed as above, was subjected to said Photographic Processing-1 through Photographic Processing-4, whereby each of the samples, which had been subjected to the standard photographic processing, was prepared.

Subsequently, Sample No. 1601 was subjected to continuous running processing so that the total amount of the color developer replenisher in the color developer tank of each of said Photographic Processing-1 through -4 reached 1 liter. Thus the color developers, which had been subjected to running processing, were prepared. Thereafter, each of the color developer tank solutions was replaced with each of the resulting color developers, and each of said untreated samples and aged samples were subjected to photographic processing in the same manner. The resulting samples were referred to as running processed samples.

(Measurement of Density Variation)

The density of the formed color image area of each of the standard processed and running processed samples was measured under Status T, employing a 508 type densitometer, manufactured by X-Rite Inc.

In said density measurement, an exposure amount was determined in which said untreated sample resulted in a density of 1.6 upon being processed, utilizing standard photographic processing. Subsequently, the density of the untreated and running-processed untreated sample which had been exposed at the exposure amount obtained above, was determined, and the density difference, ΔD1, between them was obtained. In the same manner, density difference, ΔD2, between the standard-processed aged sample and the running-processed aged sample, was obtained.

Table 27 shows the results obtained as above.

TABLE 27

| | | Color Development | | | | | | | |
|---|---|---|---|---|---|---|---|---|---|
| | | Starter Nitrogen | | | | | | | |
| Photographic | Type of | Containing | Density | | | Density | | | |
| Processing | Developing | Heterocyclic | Difference of | | | Difference of | | | |
| No. | Agent | Compound | Non-Aged Sample ΔD1 | | | Aged Sample ΔD2 | | | Remarks |
| 1 | Inv. | — | 0.06 | 0.04 | 0.06 | 0.13 | 0.10 | 0.12 | Comp. |
| 2 | Inv. | STAB-1 | 0.05 | 0.03 | 0.05 | 0.05 | 0.04 | 0.04 | Inv. |
| 3 | Comp. | STAB-1 | 0.05 | 0.04 | 0.05 | 0.13 | 0.10 | 0.11 | Comp. |
| 4 | Inv. | STAB-2 | 0.05 | 0.03 | 0.05 | 0.05 | 0.04 | 0.03 | Inv. |

Inv.: Present Invention, Comp.: Comparative Example

As can clearly be seen from Table 27, samples, which had been subjected to Photographic Processing-2 as well as Photographic Processing-4 according to the present invention, resulted in a decrease in the density difference between the standard-processed aged sample and the running-processed aged sample, compared to those which had been subjected to Photographic Processing-1 and Photographic Processing-3. Each of the non-aged samples resulted in minimal density difference between the standard photographic processing and the running-processed photographic processing. Specifically however, it was noted that when the aged samples were subjected to the running processing, the density difference was markedly small.

### Example 18

Sample No. 101 of Example 1 was subjected to exposure employing the exposure device employed in Example 9 as the exposure light source, and was subsequently subjected to the photographic processing described in Example 1, whereby the characteristic curve of each layer was drawn. A table was then prepared which specified the relationship between the density and the exposure amount, and was designated as Table Subsequently, by varying conditions during chemical sensitization, an emulsion was prepared which exhibited different sensitivity and gradation, and Sample No. 1801 was prepared utilizing the resulting emulsion. Subsequently, a characteristic curve was drawn in the same manner as Sample No. 101, and exposure amounts were obtained which were necessary to obtain high density (Y: 1.00, M: 1.60, and C: 1.60) and low density (Y: 0.40, M: 0.60, and C: 0.60).

By employing said method, the standard condition table was revised utilizing the resulting data, and the revised table was designated as Table 2.

In an exposure device, 5 levels of the blue exposure amount, 5 levels of the green exposure amount, and 5 levels of the red exposure amount were independently set, so that 10×10 mm patches were subjected to exposure of 125 different exposure amounts, utilizing combinations of said exposure level. The 5 levels of the blue exposure amount were determined so that yellow densities of the minimum density+0.00, 0.215, 0.60, 1.20, and 1.65 were obtained; the 5 levels of the green exposure amount were determined so that magenta densities of the minimum density+0.00, 0.15, 0.60, 1.10, and 1.65 were obtained; and the 5 levels of the red exposure amount were determined so that cyan densities of the minimum density+0.00, 0.15, 0.60, 1.20, and 1.65 were obtained.

By utilizing Table 1, Sample Nos. 101 and 1801 were subjected to exposure and were subsequently subjected to photographic processing, while by utilizing Table 2, Sample No. 1801 was subjected to exposure and was subsequently subjected to photographic processing in the same manner. Then, color difference between the image color of Sample No. 1801 and that of Sample No. 101, as the standard, which had been subjected to exposure, utilizing Table 1.

In the course of the preparation of said table, the above was carried out when data of said exposure amount are expressed utilizing antilogarithm. Table 28 shows the results.

TABLE 28

| | | | Exposure | |
|---|---|---|---|---|
| | | Exposure | Amount in | |
| | | Amount in | Common | |
| Table No. | Sample No. | Antilogarithm | Logarithm | Remarks |
| 1 | 101 | — | — | Standard |
| 1 | 1801 | 5.2 | 56 | Comparative |
| | | | | Example |
| 2 | 1801 | 2.1 | 1.5 | Present |
| | | | | Invention |

As can be seen from Table 28, when Table 1 was utilized, the color difference became large, while when Table 2 was utilized, it became small. When it is considered that Sample No. 101 is a light-sensitive material exhibiting common performance and Sample No. 1801 is a light-sensitive material exhibiting different performance due to batch to batch reproducibility fluctuation, it was noted that the method of the present invention made it possible to obtained the results in which batch to batch fluctuation was sufficiently compensated utilizing simple operation. Further, it is noted that more suitable compensation is obtained utilizing the logarithm of exposure amount. The structures used in the Examples are shown below.

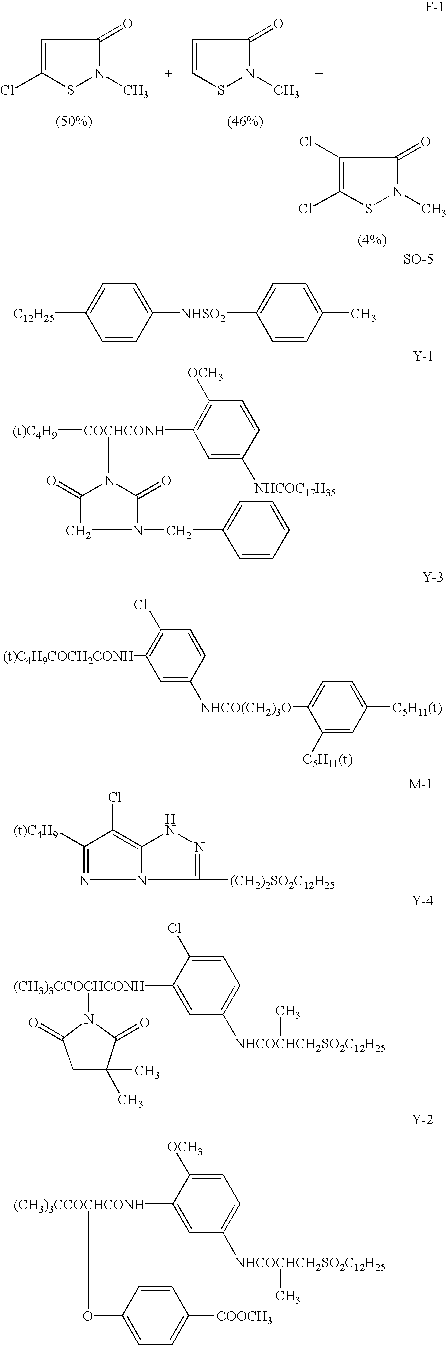

What is claimed is:

1. An area modulation image forming method of a sliver halide light-sensitive material which contains a support having thereon at least one silver halide emulsion layer, comprising the steps of:
(1) exposing the sliver halide light-sensitive material with a light-emitting diode directly modulated based on digital data; and
(2) photographic processing the sliver halide light-sensitive material,
wherein an optical density of dots and a dot gain are independently controlled by exposure in the exposing step.

2. An area modulation image forming method of a sliver halide light-sensitive material which contains a support having thereon at least one silver halide emulsion layer, comprising the steps of:
(1) scanning exposing the sliver halide light-sensitive material according to either a level of an exposure amount of a halftone area or a level of an exposure amount of a minimum density area; and
(2) photographic processing the sliver halide light-sensitive material,
wherein the level of an exposure amount of the minimum density area is to be at least one half the exposure amount which is the threshold of development.

3. An image forming method of a sliver halide light-sensitive material which contains a paper support having thereon at least one silver halide emulsion layer, comprising the steps of:
(1) exposing the sliver halide light-sensitive material wound onto a circumferential surface of a rotating drum; and
(2) photographic processing the sliver halide light-sensitive material,
wherein the light-sensitive material is produced in such a manner that the light-sensitive material is wound in the form of a roll having a diameter of from 80 to 180 mm; a light-shielding flange is provided at both ends of the resulting roll; the light-sensitive material and the flanges are partially packaged employing a light-shielding sheet; and under such a packaged state, the light-sensitive material is subjected to thermal processing under an atmosphere of at least 30° C. for 3 to 10 days.

4. An area modulation image forming method of a silver halide light-sensitive material, comprising the steps of:
(1) exposing the silver halide light-sensitive material with an exposure device having a function of scanning exposing the silver halide light-sensitive material and a function of controlling an exposure amount based on information regarding the silver halide light-sensitive material; and
(2) photographic processing the sliver halide light-sensitive material,
wherein a part of the packaging material of the silver halide light-sensitive material is capable of storing the information regarding the silver halide light-sensitive material and the information is stored in a seal which is capable of re-adhesion.

5. An area modulation image forming method of a silver halide light-sensitive material which contains a support having thereon at least one silver halide emulsion layer, comprising the steps of:
(1) exposing the silver halide light-sensitive material based on digital data; and
(2) photographic processing the sliver halide light-sensitive material with a developer replenisher which is replenished depending on a size of an image area and an amount of the light-sensitive material processed.
wherein the size of the image area is obtained through communication information between an output device and the front side of the output device, and a boundary between the image area and a non-image area is displayed utilizing a line.

6. A silver halide light-sensitive photographic material which comprises a support having thereon at least one silver halide emulsion layer, wherein the silver halide emulsion contains a compound represented by Formula (SP-1), described below, 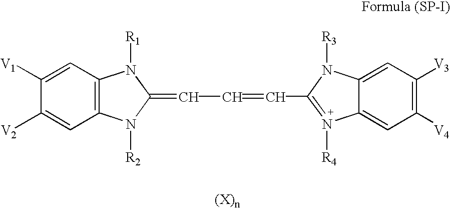
wherein R₁ and R₃ each represent a substituted or unsubstituted alkyl group, R₂ and R₄ each represent a lower alkyl group, either R₂ and R₄ represents an alkyl group of which hydrophilic group is substituted with a hydrophilic group; V₁, V₂, and V₃ each represent a hydrogen atom or a substituent, and at least one of V₂ and V₄ represents a sulfamoyl group; X represents an ion which is necessary to neutralize a charge in a molecule; and n represents the number of ions which are necessary to eliminate charges in a molecule.

7. An area modulation image forming method of a negative-working silver halide light-sensitive material which contains a support having thereon a silver halide emulsion layer, comprising the steps of:
(1) fixing the negative-working silver halide light-sensitive material on a drum;
(2) scanning exposing the negative-working silver halide light-sensitive material based on digital data; and
(3) photographic processing the negative-working silver halide light-sensitive material,
wherein a reflection density of a surface of the drum is from 0.7 to 3.5, and a transmission density of the unexposed part of the developed negative-working silver halide light-sensitive photographic material is from 0.5 to 1.2.

8. A silver halide light-sensitive material which contains a reflective support having thereon a silver halide emulsion layer containing a silver halide emulsion having an average silver chloride content ratio of at least 95 mole percent,
wherein the silver halide emulsion layer comprises a magenta coupler represented by Formula (M) described below and a sensitizing dye represented by Formula (SP-II), also described below, 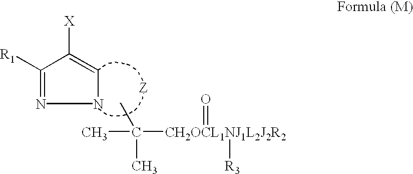
wherein L₁ and L₂ each represent an alkylene group; J₁ represents —(C═O)— or —(O—S═O)—; J₂ represents —(C═O)—, —(C═O)O—, —O—(C═O)—, —O═(C═O)—O—, —(C═O)—NR₄—, —NR₅—(C═O)—, —(O═S═O)—, —(O═S═O)—O—, —O—(O═S═O)—, —O—(O═S═O)—O—, —(O═S═O)—NR₆—, or —NR₇—(O═S═O)—, wherein R₁ through R₇ each represent a hydrogen atom, an alkyl group, a cycloalkyl group, an alkenyl group, an alkynyl group, or an aryl group; X represents a hydrogen atom, a halogen atom, or a releasable group upon reacting with an oxidized product of a color developing agent; and Z represents a non-metallic atom which is necessary for forming a nitrogen-containing heterocyclic ring, 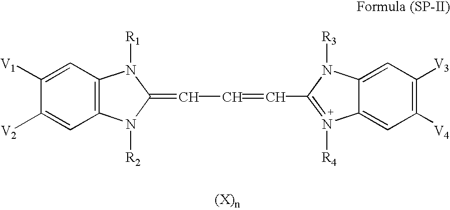
wherein R₁ and R₃ each represent a substituted or unsubstituted alkyl group, at least one of R₁ and R₃ represents a substituent other than an ethyl group; either R₂ or R₄ represents an alkyl group which is substituted with a hydrophilic group; V₁, V₂, V₃, and V₄ each represent a hydrogen atom, a substitutable group that results in a sum of Hammett σp value of no more than 1.7; V₁ through V₄ do not represent a hydrogen atom or a chlorine atom at the same time; X represents an ion which is necessary for neutralizing a charge in a molecule; and n represents the number of ions which are necessary for eliminating a charge in a molecule.

9. An area modulation image forming method of a silver halide light-sensitive material in the form of a rectangular with an at least 400 mm short side, which contains a support having thereon silver halide emulsion layers having an average silver chloride content ratio of at least 95 mole percent, which form yellow, magenta, and cyan images, and a light-insensitive colloidal layer, comprising the steps of:
(1) exposing with an exposure section in which a plurality of modulated light sources which utilizes different signals is arranged in a secondary scanning direction; and
(2) photographic processing the photographic processing the sliver halide light-sensitive material,
wherein at least one of the silver halide emulsion layers comprises a compound represented by Formula (SP-III) and a compound represented by Formula (SP-IV), 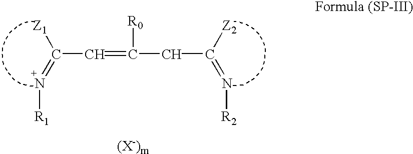
wherein Z₁ and Z₂ each represent a group of atoms which are necessary for forming a thiazole nucleus, a benzothiazole nucleus, or a naphthothiazole nucleus; R₁ and R₂ each represent an alkyl group, an alkenyl group, or an aryl group; R₁ and R₂ each may be substituted; and further the carbon chain may be disconnected through the inclusion of an oxygen atom or a sulfur atom; R⁰ represents a hydrogen atom, an alkyl group, or an aralkyl group; X⁻ represents a negative ion; and m represents 0 or 1, 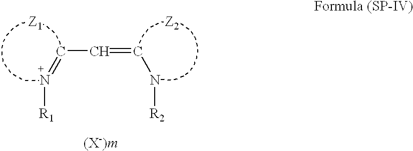
wherein Z₁ and Z₂ each represent a group of atoms which are necessary for forming an oxazole nucleus, a benzoxazole nucleus, or a naphthoxazole nucleus; R₁ and R₂ each represent an alkyl group, an alkenyl group, or an aryl group; X⁻ represents a negative ion; and m represents 0 or 1.

10. A silver halide light-sensitive material containing an 80 to 150 μm thick white support having a spectral reflection density of no more than 0.06 in the wavelength region of from 450 to 700 nm and a spectral reflection density difference ΔD (the maximum density−the minimum density) in the wavelength region of from 450 to 600 nm of no more than 0.01, having thereon a plurality of silver halide light-sensitive color emulsion layers having different spectral sensitivities, and further after photographic processing, having an opacity specified by JIS P 8138 of at least 90 percent.

11. An area modulation image forming method of a silver halide light-sensitive material which contains a support having thereon at least one silver halide emulsion layer, comprising the steps of:
(1) fixing the silver halide light-sensitive material on a drum;
(2) exposing the silver halide light-sensitive material with an exposure device having a function of scanning exposing the silver halide light-sensitive material based on digital data as well as a function of controlling an exposure amount based on a surface temperature information upon direct measurement of the surface temperature of the silver halide light-sensitive material, or upon indirect determination of the surface temperature based on a temperature in a inside part of the exposure section or a surface temperature of the exposure drum; and
(3) photographic processing the silver halide light-sensitive material,
wherein at least one of the silver halide light-sensitive layers comprises a compound represented by Formula (I) or Formula (II), described below,
R₁—(S)ₘ—R₂ Formula (I)
wherein R₁ and R₂ each represent an aliphatic group, an aromatic group, or a heterocyclic group; either R₁ or R₂ represents a group of atoms capable of combining with said S to form a ring; and m represents an integer from 2 to 6,
R—SO₂S—M Formula (II)
wherein R represents an aliphatic group, an aromatic group, or a heterocyclic group, and M represents a hydrogen atom or an univalent cation.

12. An area modulation image forming method of a silver halide light-sensitive material which contains a support having thereon a yellow forming layer, a magenta forming layer, and a cyan forming layer each of which comprises a silver halide having an average silver chloride content ratio of at least 95 mole percent, comprising the steps of:
(1) exposing the silver halide light-sensitive material; and
(2) photographic processing the sliver halide light-sensitive material,
wherein a locus of the resulting absorption of a yellow dye form a yellow forming coupler passes through the interior of a CIELAB color space sphere with a diameter of 10, having a center at L*=85, a*=−5, and b*=85 when a maximum yellow density (Dₘₐₓ) of the yellow forming layer is at least 1.5 and the density is varied, and the yellow forming coupler being a compound represented by Formula (Y) described below; and the yellow forming coupler layer being the farthest color forming layer from the support, 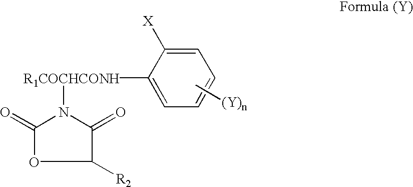
wherein R₁ represents an alkyl group, a cycloalkyl group, an amino group, a heterocylic group, or an aryl group; R₂ represents a straight-chained or branched-chained unsubstituted alkyl group having at least two carbon atoms; X represents a chlorine atom, an alkoxy group, or an aryloxy group; when R₁ represents an alkyl group, a cycloalkyl group, an amino group, or a heterocyclic group, Y represents an acylamino group or a chlorine atom, and when R₁ represents an aryl group, Y represents a sulfonylamino group, a chlorine atom, or an oxycarbonyl group; and n represents an integer of 0 to 4, when n is 2 or more, a plurality of Y may be the same or different.

13. An area modulation image forming method of a silver halide light-sensitive material which contains a support having thereon at least one silver halide emulsion layer, comprising the steps of:
(1) fixing the silver halide light-sensitive material on a drum;
(2) exposing the silver halide light-sensitive material with an exposure device having a function of scanning exposing the silver halide light-sensitive material based on digital data as well as a function of controlling an exposure amount based on a surface temperature information upon direct measurement of the surface temperature of the silver halide light-sensitive material, or upon indirect determination of the surface temperature based on a temperature in the interior of the exposure section or a surface temperature of said exposure drum; and
(3) photographic processing the silver halide light-sensitive material,
wherein at least one of the silver halide light-sensitive layers comprises a silver halide having an average silver chloride content ratio of at least 95 mole percent, a compound represented by Formula (SP-V), and a compound represented by Formula (SP-VI), which are described below, 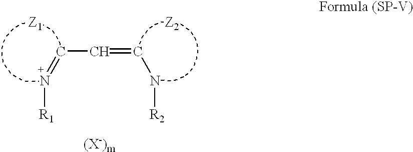
wherein Z₁ and Z₂ each represent a group of atoms which are necessary for forming a thiazole nucleus, a benzothiazole nucleus, or a naphthothiazole nucleus; R₁ and R₂ each represent an alkyl group, an alkenyl group, or an aryl group; X⁻ represents an anion; m represents 0 or 1, 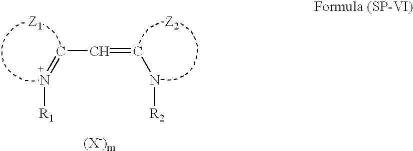
wherein Z₁ represents a group of atoms which are necessary for forming a benzoxazole nucleus or a naphthoxazole nucleus; Z₂ represents a group of atoms which are necessary for forming a thiazole nucleus, a benzothiazole nucleus, or a naphthothiazole nucleus; R₁ and R₂ each represent an alkyl group, an alkenyl group, or an aryl group; and X⁻ represents an anion; m represents 0 or 1.

14. An area modulation image forming method of a silver halide light-sensitive material which contains a support having thereon a silver halide emulsion layer comprising a silver halide emulsion having an average silver chloride content ratio of at least 95 mole percent and a gold compound, comprising the steps of:
(1) exposing the silver halide light-sensitive material; and
(2) photographic processing the silver halide light-sensitive material,
wherein at least one of the silver halide emulsion layer comprises at least one of the compounds represented by Formulas (III), (IV), and (V), described below,
Rf1—(L1)m1—(Y1)n1—X1 Formula (III)
wherein Rf1 represents a perfluoroalkyl group; L1 represent a divalent bonding group; Y1 represents an alkyleneoxide group or an alkylene group, each of which may have a substituent; X1 represents a hydrogen atom, a hydroxyl group, an anionic group, or a cationic group; m1 represents 0 or an integer of from 1 to 5; and n1 represents an integer of 0 to 40,
Rf2—(O—Rf3)n2—L2—(X2)m2 Formula (IV)
wherein Rf2 represents an aliphatic group having at least one fluorine atom; Rf3 represents an alkylene group having at least one fluorine atom; n2 and m2 each represent an integer of 1 or more; L2 represents a bonding atom or a bonding group; and X2 represents a hydroxyl group, an anionic group, or an cationic group,
[(Rf4O)n3—(PFC)—CO—Y3]—L3—(X3)m3 Formula (V)
wherein Rf4 represents a perfluoroalkyl group having from 1 to 4 carbon atoms; PFC represents a perfluorocycloalkylene group; Y3 represents a bonding group comprising an oxygen atom or a nitrogen atom; L3 represents a bonding atom or a bonding group; X3 represents a water solubilizing polar group comprising an anionic group, a cationic group, a nonionic group, or an amphoteric group; n3 represent an integer of 1 to 5; k represents an integer of 1 to 3; and m3 represents an integer of 1 to 5.

15. An area modulation image forming method of a silver halide light-sensitive material which contains a support having thereon at least one silver halide emulsion layer, comprising the steps of:
(1) exposing the silver halide light-sensitive material utilizing a plurality of light elements whose light output power is less than that required for forming an image; and
(2) photographic processing the sliver halide light-sensitive material,
wherein the silver halide emulsion layers contains negative-working silver halide grains having an average silver chloride content ratio of at least 95 mole percent, and a grain surface phase whose silver bromide content is higher than other regions of the grain surface.

16. A photographic processing method of a silver halide light-sensitive material which contains a support having thereon a silver halide emulsion layer having an average silver chloride content ratio of at least 95 mole percent, employing an automatic processor having at least three stabilization processing tanks utilizing a cascaded counter-current system,
wherein (1) at least one tank besides a first processing thank and a final processing tank of the stabilization processing tanks has a heating device, (2) a content ratio of an optical brightening agent and a chelating agent incorporated into a stabilizer of the final process is no more than 50 percent of that of the optical brightening agent of the first processing tank, (3) a stabilizing agent replenisher is replenished only to the final processing tank, and (4) the content of the chelating agent and the optical brightening agent in the stabilizing agent replenisher is two times higher than the initial concentration of the stabilizer in the final processing tank.

17. An area modulation image forming method of a silver halide light-sensitive material which contains a support having thereon a silver halide emulsion having an average silver chloride content ratio of at least 95 mole percent, comprising the steps of:
(1) scanning exposing the silver halide light-sensitive material; and
(2) photographic processing the silver halide light-sensitive material with processing solutions which include
(i) a color developing solution comprises a developing agent represented by Formula (VI) described below in an amount of at least 55 mole percent of total developing agents, and
(ii) a starter comprises at least one type of nitrogen-containing heterocyclic compound,
Formula (VI) 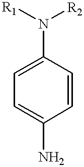
wherein R₁ and R₂ each represent a substituted or an unsubstituted alkyl group, and R₁ and R₂ may combine to form a ring.

18. An area modulation image forming method of a silver halide light-sensitive material containing a support having thereon at least one yellow image forming silver halide emulsion layer, at least one magenta image forming silver halide emulsion layer, and at least one cyan image forming silver halide emulsion layer, is subjected to image exposure based on digital data, comprising the steps of:
(1) exposing the silver halide light-sensitive material based on digital data; and
(2) continuously processing while replenishing a replenisher,
wherein exposure is carried out employing an exposure amount obtained from a relationship between the exposure amount and a color density in which a previously determined relationship has been corrected utilizing the relationship of two optional points of the silver halide light-sensitive material employed.
